(19) United States
(12) Patent Application Publication
(10) Pub. No.: US 2005/0247145 A1
(43) Pub. Date: Nov. 10, 2005

(54) Three-dimension motive machine

(76) Inventor: Yves LeGoff, Laurel, MD (US)

Correspondence Address: HAROLD GELL, P.C., 13720 LOCKDALE RD., SILVER SPRING, MD, 20906-2117, US

(21) Appl. No.: 10/837,925

(22) Filed: May 4, 2004

(51) Int. Cl. F16H 1/00

(52) U.S. Cl. 74/84 S

(57) ABSTRACT

An air/space craft propelled by a cubic three-dimension motive machine capable of generating an outwardly-directed, steerable, variable centrifugal force to propel the craft in three dimensions. The apparatus comprises a ridged cubic housing containing a means to guide a mass in a circular path that is movable within a circular outer rim centered within the housing. The diameter of the circular path is fixed and the diameter of the outer rim is defined by the confines of the housing. The center of the mass revolving along the path is variable in three dimensions within the housing to effect the direction and magnitude of the vector sum of the centrifugal force created by the mass as it is rotated.

### FIELD OF THE INVENTION

The present invention relates to an air and space vehicle and propelling means therefore comprised of a Three-Dimension Motive Machine, hereinafter referred to as the cubic TDMM craft, which converts centrifugal force into unidirectional force.

### BACKGROUND OF THE INVENTION

Heretofore, various mechanical devices have been proposed for converting centrifugal force into unidirectional force for use in pile drivers, earth compactors, . . . etc . . . , and to move various types of water craft or land wheeled-vehicles. However, except for pile drivers and earth compactors, these devices have inefficient mechanisms which do not produce sufficient motive force for practical use in any water, land, air or space craft.

These inventions/devices generally fall into three groups, each utilizing a different technical approach for converting rotational motion into linear motion—namely, those using:
1) various weight types, rotating at the end of radii whose lengths are varied by the use of cams or by other means (such as changing the amount of liquid inside cylinders to move piston and rod assemblies back and forth) in order to convert centrifugal force into a unidirectional force along a selected path,
2) electromagnets of one type or another, to control the continually varying distances of weights from their common axis of rotation (in order to convert centrifugal force into a unidirectional force) and
3) various gyroscopic configurations to do the same as above.

Selected examples of the above-mentioned three basic approaches (one in each of the three groups) are presented in the following section.

### DISCUSSION OF THE RELATED ARTS

U.S. Pat. No. 5,488,877 for “Centrifugal Inertia Drive”, issued Feb. 6, 1996 to Richard L. Lieurance, uses a “centrifugal inertia drive to produce a resultant force vector with amplitude and direction”, with the possibility of a two-dimensional capability. In its basic mechanism, as shown in FIG. 9 of Lieurance, a single cell composed of two phases that are connected by interconnections 7 (with a fixed length D of 12 inches) moves back and forth along two guides 2. The two guides are connected to a fixed, off-center rotational shaft 1 and interact with circular paths through rollers. This causes the radius of each of the two phases to vary their respective lengths from their center of rotation (shaft 1). As a result, two separate and differently varying anti-parallel force vectors are then created which vectorially combine to produce a single resultant force vector in one selected linear direction (in the direction of the greater force vector). However, because the use of that single cell alone causes a pulsing force in the selected direction, the inventor suggests using four cells on the single rotational shaft 1 (see FIG. 5 of Lieurance) in order to obtain “a more uniform resultant force vector”, varying between 5 lbs and 120 lbs, as the rotation varies from 100 to 600 rpm (see graph in FIG. 8 of Lieurance).

Although the two-phase single cell model in FIG. 9 of Lieurance (which the inventor selected to demonstrate and describe his theory behind the Centrifugal Inertia Drive) works well when used alone, the four-cell concept shown in FIG. 5 of Lieurance may not work at all—because, as the four cells rotate about their common axis (shaft 1 of FIG. 9 of Lieurance) and continually move back and forth in different directions (45 degrees apart) along their guides 2, their respective constant-length interconnections 7 (which, as shown in FIGS. 6a to 6d and 9 of Lieurance, are centered in the center of the top and bottom sides of each phase) appear as if they might interfere with one another as they move back and forth in the same physical space.

The Summary and Scope section, column 7, lines 54-57, states that force retainer 4 (which is shown as stationary in FIG. 9 of Lieurance) “may be realigned or movable to redirect the resultant force vector within a 360-degree plane of shaft 1 rotation”. How this is accomplished is not explained. However, if done, this would give the four-cell Centrifugal Inertia Drive a two-dimensional capability (assuming that the above-mentioned possible interconnection 7 interference problem is solved).

U.S. Pat. No. 5,782,134 for “Electromagnetically Actuated Thrust Generator”, issued Jul. 21, 1998 to James D. Booden, discloses an electromagnetically-actuated thrust generator, which converts electricity into unidirectional thrust”. It consists of “a hybrid of electromagnetically-operated elements” which, in conjunction with a number of other mechanical components rotating about a common axis, produces a resultant centrifugal force in a desired direction. The thrust generator is basically composed of an outside 4-inch radius circular housing, an electric motor (for rotating the housing about a common axis) and five equally-spaced assemblies of weights—which are each independently actuated by an electromagnet (controlled by a central microprocessor) from a retracted radius of 4 inches (0.3333 ft) to an extended radius of 5 inches (0.4167 ft) from a common axis of rotation. The inventor calculated a few thrust generator performance values (see table in column 4 of Booden) using the standard force equation F=MA, in which the mass M=(2 lbs)/(32.174 ft/sec²)=0.062162 slugs and the radial component of acceleration A=V²/R, in which the tangential velocity V=2πR(rps), where R is the variable-length radius in feet and rps is the number of revolutions per second. The calculations were done for 600 rpm to 1200 rpm (or 10 rps to 20 rps) in increments of 100 rpm. At 600 rpm, the thrust generator produces a thrust of 102.8 lbs with the 5-inch extended radius (or, F=MA=(0.062162 slugs)(2 π(0.417 ft)10 rps)²)/0.417 ft=102.33 lbs) and a thrust lbs with the 4-inch retracted radius in the opposite direction, which vectorially add to a net thrust (102.8−82.2)=20.6 lbs. Similarly, at 1200 rpm, the generator produces a net thrust of 82.43 lbs.

However, the above two net thrust values are only approximations, which should not have been calculated as if they were opposite (anti-parallel) vectors—because, as shown in FIGS. 1 and 2 of Booden, there are 5 equally-spaced (72 degrees apart) electromagnet/weight assemblies (with none of them being opposite pairs). In order to obtain a more accurate net thrust value, one should instead have first calculated the respective distances (radial lengths) of the 5 weights from their common axis separately (which should vary between 4 and 5 inches) as functions of their angle of rotation, and then use these 5 radial lengths to obtain their five different force vectors (for both the 600 and the 1200 rpm)—which, with the use of the triangle and the polygon methods shown in FIG. 33 herein, could finally be vectorially combined into a single, more accurate and representative net resultant thrust vector value for the thrust generator.

Furthermore, if one assumes a realistic total weight approximation (because the patent does not provide any part/system weight information) for the entire thrust generator, there is a possibility that the total net weight for the entire thrust generator will greater than even its larger inventor-calculated net thrust of 82.43 lbs at 1200 rpm can handle in a vertical ascent against the force of gravity on earth. This is because, since the system includes two counter-rotating units and that each counter-rotating assembly includes 5 weights, 5 electromagnetic actuators, a circular 4-inch radius housing, an electronic controller, an electric motor, some kind of power supply, various structures and an outer frame enclosing the entire thrust generator, the thrust generator's total weight might limit its operation to a two-dimensional, horizontal plane only.

Finally, at the end of the inventor's abstract, the patent suggests that several such thrust generator systems, arranged in counter-rotating co-planar pairs along the three X, Y and Z axes, can be “utilized to produce a smooth unidirectional thrust along any vector” in three dimensions. Based on the teachings of the patent, this is not likely to be feasible. Firstly, the abstract is the only place in the entire document where such a suggested possibility is mentioned. Therefore, since the inventor fails to explain how to put together all his hardware to build a machine capable of three-dimensional operation, one has to assume that the patent is primarily interested in explaining the concept of “converting electricity into unidirectional thrust in two dimensions” on a flat, horizontal surface. In addition, because a single thrust generator system's net thrust of 82.43 lbs at 1200 rpm may not be sufficient to handle its total estimated weight in a vertical ascent from earth (working against the earth's force of gravity), trying to arrange several of them “in counter-rotating coplanar pairs along the X, Y and Z axes” is not likely to produce a three-dimensional operation either—since a larger and heavier frame structure would certainly be required. Secondly, based on several statements within the patent, namely: “The present description set forth is one of a variety of possible configurations . . . ”, at column 2, lines 20 et seq., . . . etc . . . , and others (column 2, lines 62 and seq., column 3, lines 49 and seq., column 3, lines 64 and seq., column 4, lines 10 and seq., . . . etc . . . ), it may not be possible, even for “a person versed in the art”, to easily make and operate the thrust generator (or some of the other suggested possible options thereof, which were not discussed), mostly due to a lack of information on how exactly to do it. In conclusion, this system's two-dimensional plane capability is not by itself a feature that can easily be changed into a three-dimensional plane capability without the proper information on how to do it.

U.S. Pat. No. 5,860,317 for “Propulsion System”, issued Jan. 19, 1999 to Eric Laithwaite et al., “relates to a propulsion and positioning system for a vehicle”, with “particular utility in the propulsion and/or positioning of space vehicles” (which suggests a three-dimensional capability). Basically, the propulsion system relies solely on controlling four sets of spinning gyroscopes (with built-in assemblies of rotating masses) to create the required propulsion along a desired path. However, due to a lack of gyroscopically-generated propulsion force results for propelling the combined weight of the apparatus/vehicle (which was not mentioned), it is impossible to evaluate the capability of such an apparatus. Even though the patent claims that a person “skilled in the art will be able to envisage a number of ways of supplying the required controlling torque power to the apparatus” to make it work properly, it appears to be a complicated way for obtaining a controlled propulsion along a desired direction.

All three inventions discussed above (which were selected for review and evaluation because they are most closely related to the present cubic TDMM craft invention) suggest the possibility of being able to develop a single resultant force along any selected direction in three dimensions, by simply doing or adding one thing or another to them. However, after carefully reviewing the three patents, and although their inventors claim a three dimensional propulsion capability for their inventions, they appear to be limited to a two-dimensional plane capability only—mostly because the inventors do not provide enough information in their patents to help a persons interested in their “art” to:
1) make the necessary changes and/or modifications to their inventions to give them a three-dimensional capability, for use on vehicles or crafts (which they leave to persons “versed in the art” to figure out) and/or
2) calculate, or at least estimate, the total weight of their inventions/devices, in order to determine whether or not their calculated thrust would be sufficient to provide them with vertical lift capability against the force of gravity on earth (which would be an important first requirement for three-dimensional motion in a “near-earth” environment).

Furthermore, the detailed (and sometimes complex) descriptions provided by the inventors in the write-ups and accompanying drawings of the three selected patents often makes it difficult to detect any possible mechanical/electrical operational flaws in their inventions. For example, such a possible design flaw may exist with the interconnection 7 which, as described in the most closely related patent to Lieurance, might create a physical/operational interference problem when several two-phase cells are added to his basic one two-phase cell mechanism.

### Comparison of the Prior Art with the Present Cubic TDMM Craft Invention

By comparison with the above three selected patents (as well as others), the cubic TDMM craft invention uses a built-in steerable, variable resultant centrifugal force motive mechanism to propel itself with unparalleled performance and maneuverability in three dimensions on earth and in outer space—and, unlike present-day aircrafts, doesn't need wings nor tails to be flown in any atmospheric environment.

The full complement of the 600-lb cubic TDMM craft model basically consists of an external 100-inch cubic frame 10, a 96×9×24-inch parallelepiped internal frame 13 (a dashed outline of which is shown in FIG. 1, inside the external cubic frame) and a steerable, variable centrifugal force motive machine mechanism, hereinafter simply referred to as the Machine (which is enclosed in the internal housing frame 13).

As shown in FIG. 2, the internal housing frame 13 is divided into two equal halves, 16A on the left and 16B on the right, separated by the central square plate 15. The internal housing frame 13 (which encloses the Machine) can be horizontally rotated in either direction about a central, vertical axis 14 (shown as a vertical dashed line in FIG. 1) inside the larger external cubic frame 10. The said Machine is itself also divided into two identical mirror-image halves—with each Machine half mounted inside its own internal housing frame half.

The cubic TDMM craft's spectacular performance capability (see FIGS. 41 through 48) is basically and solely due to the innovative, combined use of only three simple mechanical component parts in each Machine mirror-image half, namely:
1) a fixed 4-foot-radius circular outer rim 34 (see FIG. 10),
2) a smaller, movable 3-foot-radius circular inner rim 33 (see FIG. 8) and
3) a telescoping full extension slide 46 (see FIGS. 3, 4 and 5), which is extendable from 2 ft (fully closed) to 4 ft (fully opened).

The telescoping slide 46 in (3) above is used in two different (and very important) applications in each Machine mirror-image half, namely:
1) in a set of 8 rotating variable-length (telescoping) subassemblies 40 (each comprised of one slide 46 and of one 2-wheel device 47—see FIGS. 9, 11 and 12) and
2) in a two-dimension, all-way movable mechanism 49, in which it is used in two pairs of slide assemblies 21L and 21R (to vertically move plate 25 up and down) and 27U and 27D (to horizontally move plate 29 back and forth), as shown in FIGS. 6, 7 and 8.

By combining the variable vertical motion of plate 25 with the variable horizontal motion of plate 29 (which is mounted on plate 25 —see FIGS. 7 and 8), plate 29 can be moved anywhere within the area outlined by the central square plate 15 (see FIG. 6), thereby causing inner rim 33 (which, as shown in FIG. 8, is mounted on the opposite side of plate 29) to also move with plate 29 anywhere within the vertical plane of the fixed, circular outer rim 34.

Each set of 8 variable-length subassemblies 40 in the Machine rotates inside the vertical plane of its own inner rim about a fixed axis (point 0), which is aligned with the common center of both the fixed outer rim 34 and the central square plate 15, in either the “neutral position” (see FIG. 11), in which inner rim 33 is in the center of outer rim 34 (with its center point P superimposed on the fixed point 0 of outer rim 34), or in the “active position” (see FIG. 12), in which inner rim 33 has been moved to make contact with the inside surface of outer rim 34 at 180 degrees—thereby providing the cubic TDMM craft with the maximum vertical motive force. The fixed outer rim 34 (see FIG. 10), which is mounted inside the left 16A side half of the internal housing frame 13 (see FIG. 2), acts as a circular boundary for the movable inner rim 33 which, in turn, acts as a movable circular track for the 2-wheel devices 47 (which, as shown in FIG. 9, are mounted at the ends of the 8 variable-length subassemblies 40).

In the cubic TDMM craft invention, the external cubic frame 10, the internal housing frame 13 and its enclosed Machine are designed to work together as one unit, to generate a single, smooth, steerable and variable motive force capable of propelling the cubic craft with unmatched (unequaled) performance and maneuverability (not presently available in any air and space craft) in any desired direction in three dimensions—thereby giving the cubic craft four major advantages over the three most closely related inventions discussed earlier, namely:
1) the three-dimensional operation and re-direction capabilities of the cubic TDMM craft are already incorporated (built-in) in its design (as indicated and described in the drawings, diagrams and related write-ups and specifications),
2) only one TDMM mechanism is required to propel the said cubic craft in any chosen direction in three dimensions (instead of, for example, having to use “a plurality of Thrust Generator systems, arranged in counter-rotating coplanar pairs along the three X, Y and Z axes of three-dimensional space, in order to produce a smooth, unidirectional thrust along any vector”, as suggested in the abstract of Booden),
3) the cubic TDMM craft's Machine can generate a single, outwardly-directed, maximum resultant centrifugal force (ResF) of 3,978.8 lbs (which is obtained by doubling the 1,989.4 lbs generated by each of the Machine's two sets of 8 variable-length subassemblies 40—see FIGS. 32 and 33) in any selected direction (in which, as shown in FIGS. 12, 13, 14 and 51, the inner rims are making contact with their respective outer rims) and
4) the cubic TDMM craft's maximum propulsion capability is simply obtained by combining the selected direction of the ResF mentioned in (3) above with the chosen horizontal direction (azimuth) of the internal housing frame 13 inside the external cubic frame 10—thereby providing a steerable, powerful maximum motive force, capable of propelling the said cubic craft (or any other air/space craft type) in any desired direction in three dimensions, anywhere on earth and in outer space.

The cubic TDMM craft's maximum ResF mentioned in (3) above is many times greater than is needed to propel the 600-lbs cubic craft (see Table 2) in any selected direction in three dimensions (which is far greater than Booden's net thrust of 82.43 lbs at 1200 rpm). Also, as a result of the features mentioned in (1), (2), (3) and (4) above, the said cubic craft can:
1) quickly make any turn in three-dimensional space (including a 90-degree or a 180-degree turn) while in flight without having to make a long arced turn (like most aircrafts, missiles and rockets presently must do),

2) take off and land anywhere, or remain stationary over any selected point, on earth and in outer space, and,
3) by using only the 50 rad/sec angular velocity in the Machine (to counter-rotate the two sets of 8 subassemblies 40), be able to reach a vertical 250-mile “near-earth” orbit in less than 6 minutes, go to the moon's “far-earth” distance of about 230,000.0 miles from earth and safely land there in about 3.0 hours and even go to the planet Mars (when it is about 35 million miles from earth) and also safely land there in about 33 hours.

The two one-way fight times to the moon and to Mars mentioned in (3) above are based on a constant cubic craft acceleration and deceleration of 53.4 ft/sec² rad/sec (see the 50 rad/sec plots of FIGS. 41 and 45), which are respectively used in each half-way distances to the moon and to Mars—assuming the availability of a sufficient and constant source of electrical power to operate and propel the cubic TDMM craft during those two“far-earth” entire space voyages.

All the above capabilities can simply be accomplished by first moving the Machine's two circular inner rims towards a new selected direction inside the fixed vertical planes of their respective outer rims and then by giving the internal housing frame 13 a new horizontal direction (bearing) inside, and relative to, the external cubic frame 10 (see FIGS. 1, 2 and 53).

### OBJECTIVES OF THE INVENTION

The underlying objective of the invention is to provide a variable centrifugal force steerable in three dimensions.

A primary objective of the invention is to adapt centrifugal force as a variable motive power source for moving any air and space craft type through three dimensional space.

Another objective of the invention is to provide an internal motive power source for a wingless and tailless air/space cubic craft, using centrifugal force as a steerable, variable motive force—to thereby eliminate the need for propellers, fans, jets, rockets or other reaction generating motive means.

A further objective of the invention is to provide a steerable, variable centrifugal force motive machine that is capable of moving any government and/or civilian land-wheeled-vehicle and of propelling any water, air and space craft in any chosen direction in three dimensions with greater performance and maneuverability capabilities than are presently available anywhere.

### SUMMARY OF THE INVENTION

The invention is presented herein as a 600-lb wingless and tailless cubic air/space craft model with a built-in steerable, variable centrifugal force “Three-Dimension Motive Machine” (TDMM), herein simply referred to as the cubic TDMM craft. This example of the invention is exemplary only and intended to provide what is deemed to be the a “best mode” considering the present state of the relevant arts. It is not meant to be limiting and manned and unmanned versions of various sizes are contemplated.

The TDMM mechanism part of the invention gives the cubic craft unparalleled three-dimensional motion and maneuverability capabilities—which can also be implemented for use in any land-wheeled-vehicle, water, air and space craft, and even in missiles and rockets.

The cubic TDMM craft selected as an exemplary embodyment basically consists of an external 100-inch cubic frame 10, a 96×96×24-inch parallelepiped internal housing frame 13 and a steerable, variable centrifugal force two-dimension motive machine (which is enclosed in the internal housing frame 13) and is herein simply referred to as the Machine. As shown in FIGS. 1, 2 and 53, the internal housing frame 13 is rotatable, inside the larger external cubic frame 10 about a central, vertical axis 14 (which runs between the two swivel assemblies 11 and 12, through the middle of the central square plate 15) towards any chosen horizontal direction (azimuth)—thereby causing the enclosed Machine to rotate with it. Therefore, the function of the two swivel assemblies 11 and 12 is to support and rotate the internal housing frame 13 (see FIGS. 51 and 52).

The Machine is divided into two identical mirror-image halves, separated by the central square plate 15—which, as shown in FIGS. 2 and 51, also divides the internal housing frame 13 into two equal halves, 16A on the left and 16B on the right. Each half of the internal housing frame 13 encloses one Machine mirror-image half. However, since both Machine mirror-image halves are identical, only the left half (in the internal housing frame 16A side) is described next.

The left Machine mirror-image half basically consists of:
1) one set of 8 identical, equally-spaced subassemblies 40 (rotating about a fixed axis at point 0—see FIGS. 11 and 12), with each subassembly consisting of a telescoping slide 46 (see FIGS. 3, and 4) and of a two-wheel device 47 mounted at its other end (see FIG. 9),
2) one movable, circular inner rim 33 (see FIGS. 8, 9, 11 and 12), which acts as a circular track for the 2-wheel devices 47, and
3) one fixed circular outer rim 34 (which, as shown in FIG. 10, is vertically-mounted inscribed on the four inside surfaces of the left 16A side half of the internal housing frame 13), and which also acts as a circular boundary for the movable inner rim 33 in (2) above.

When the movable inner rim 33, which is initially in the “neutral position” in the center of the fixed outer rim (see FIG. 11), is moved sideways in any selected direction until it makes contact with the inside surface of outer rim 34 (see FIG. 12), then the 8 telescoping subassemblies 40 are now rotating in the maximum “active position”—in which they continually vary their radial lengths as they rotate counterclockwise (inside the vertical plane of the movable inner rim 33) about their now off-center, fixed point 0 (relative to the inner rim's center point P). As a result, according to the centrifugal force equation (1) in ¶0113, these 8 different variable-length subassemblies 40 also simultaneously generate 8 different centrifugal forces F_{c}—which automatically vectorially combine into a single resultant centrifugal force ResF, which is always pointing in the same selected outward direction in which the inner rim is making contact with the outer rim's inside surface.

Finally, by combining the selected direction of the above-mentioned ResF (which is generated by the two sets of 8 subassemblies 40, counter-rotating in the vertical planes of their respective inner rims) with the chosen horizontal direction (azimuth) of the internal housing frame 13, a powerful motive force is then available for impelling the cubic TDMM craft in any desired direction in three dimensions with unparalleled performance and maneuverability.

### BRIEF DESCRIPTIONS OF THE DRAWINGS

There is a total of 54 figures, representing the various drawings, diagrams and plots of the cubic TDMM craft invention's performance results.

FIG. 1 shows a simple three-dimensional view of an exemplary form of the cubic TDMM craft, which consists of the external cubic frame 10, the parallelepiped internal housing frame 13 (shown as a dashed outline) and the bottom and top swivel-and-sprocket assemblies 11 and 12. Swivel assemblies 11 and 12 are used for supporting the internal housing frame (in which the Machine is enclosed) and for horizontally rotating it about the central vertical axis 14 (shown as a dashed line, running between the centers of both) in either direction inside the external cubic frame 10.

FIG. 2 shows a top view of the cubic TDMM craft, showing the relationship between the external cubic frame 10, the internal housing frame 13 (which encloses the Machine), the top swivel-and-sprocket assembly 12, a top end-view of the square central plate 15 (which divides the internal housing frame 13 into two equal halves, 16A on the left and 16B on the right) and the clearance required to allow the internal housing frame a full 360-degree rotation about its central axis 14 in either direction without interference with the inside surfaces the external cubic frame. A dashed circle, representing the circular external cylindrical frame 60 (which is used later in FIG. 54), is also shown in this figure.

FIGS. 3, 4 and 5 show three diagrams (on the same page) of a commercially available (hardware-store-bought) “telescoping full extension slide”, hereinafter referred to as slide 46. Slide 46 is shown in the closed, opened and closed end-view positions respectively. The telescoping (variable-length) slide 46 is the most important and most rotationally efficient part in the Machine, in which it is used in two separate applications, namely:
1) in the two sets of 8 counter-rotating variable-length subassemblies 40 (with one set in each Machine mirror-image half—see FIGS. 11 and 12 for example) and
2) in slide assemblies 21L, 21R, 22L,22R, 27H, 27D, 28U and 28D (see FIGS. 6, 7, 13 14), in which it is joined in pairs to movably couple the central square plate 15 to the vertically-movable plates 25 and 26 and to movably couple plates 25 and 26 to the horizontally-movable plates 29 and 30.

FIG. 6 shows a front-view diagram of the fixed 96-inch square central plate's left 15A side, upon which a pair of vertically-moving slide assemblies, respectively numbered 21L on the left and 21R on the right, are mounted as shown. Each slide assembly consists of a pair of telescoping slides 46 (one open and one closed—see FIGS. 3 and 4) which are joined in pairs, end to end, so as to allow them to alternately slide back and forth together, such that when one is fully opened, the other one is fully closed and vice versa.

FIG. 7 is a diagram of the 72-inch square plate 25, which is mounted directly onto the four movable sections 43 (see FIG. 4) of the two pairs of vertical slide assemblies 21L and 21R on the square plate's left 15A side (see FIG. 6), thereby enabling vertical movement of plate 25 with respect to the square central plate 15. Two more pairs of slide assemblies, 27U and 27D, are also horizontally-mounted on the opposite side of plate 25 (away from the central plate 15).

FIG. 8 is a diagram of a second 72-inch square plate 29, which is mounted directly onto the four movable sections 43 of the two horizontal pairs of slide assemblies 27U and 27D of FIG. 7, thereby enabling horizontal movement of plate 29 with respect to plate 15. A 72-inch-diameter circular inner rim 33 is also mounted inscribed on the other side of plate 29 as shown.

FIG. 9 shows how each of the 8 rotating subassemblies 40 (shown in the “neutral position” in FIG. 11 and in the “active position” in FIG. 12) consists of one telescoping slide 46 and of one 2-wheel device 47 (attached at the end of its sliding section 43) and how its stationary (non-movable) section 41 (see FIG. 4) is mounted directly as shown onto a 16-inch-radius circular metal disk 31, which is itself secured onto a high-speed hub 44 with 4 bolts (see FIG. 50). The set of 8 subassemblies 40, the metal disk 31 and the hub 44 all rotate together as one unit about the fixed stub axle 45, located at the fixed point 0.

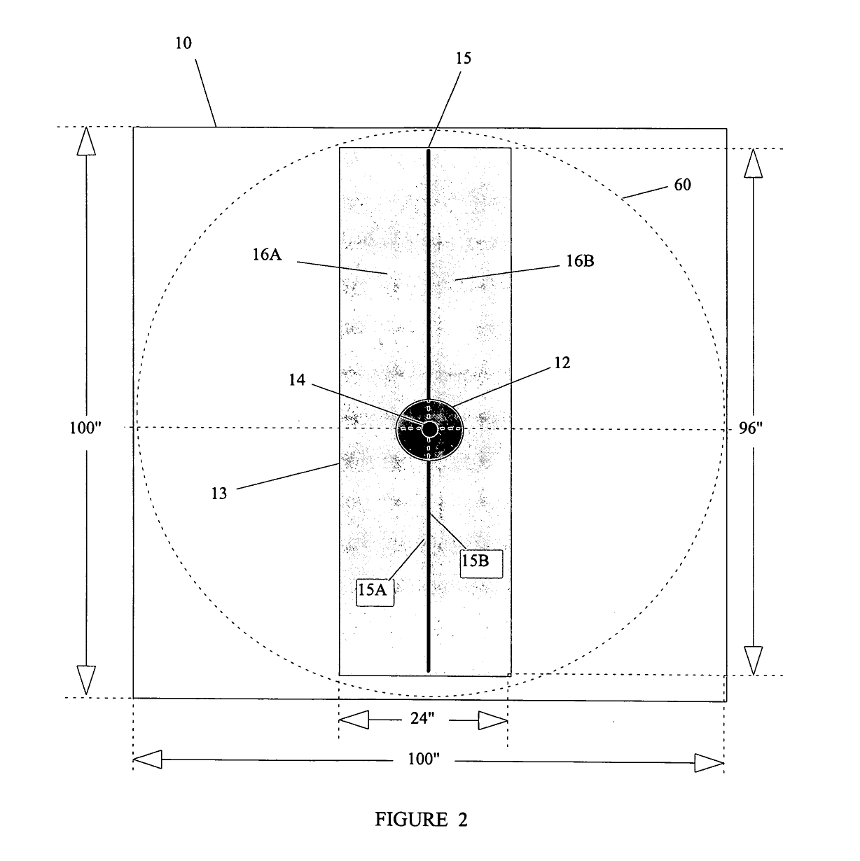

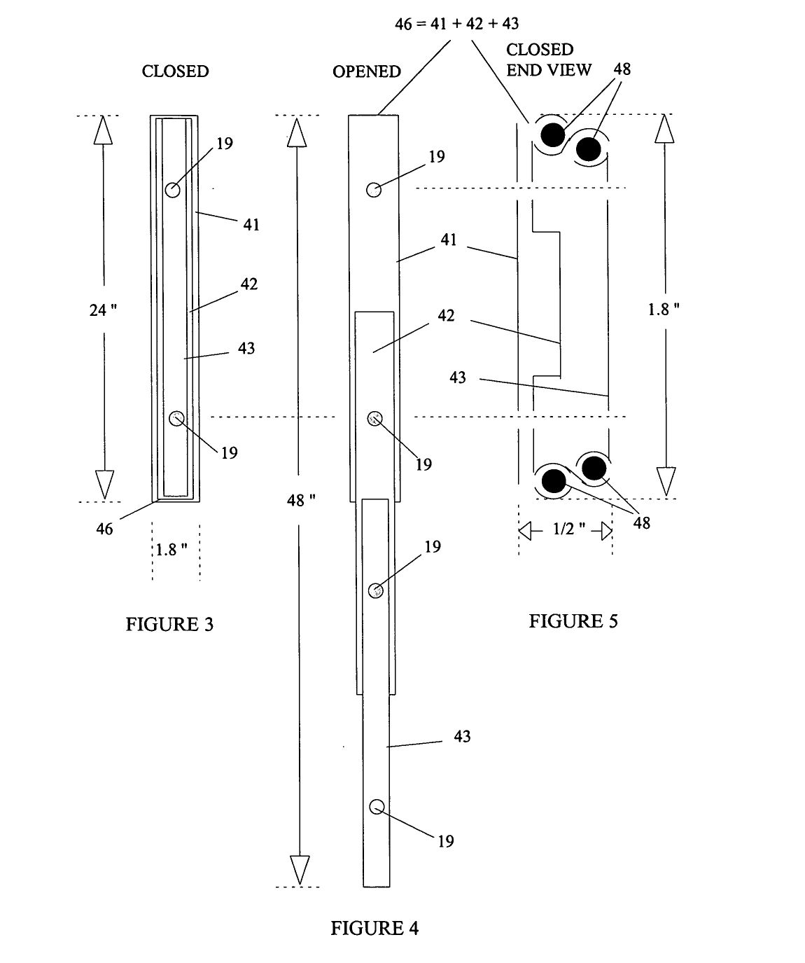

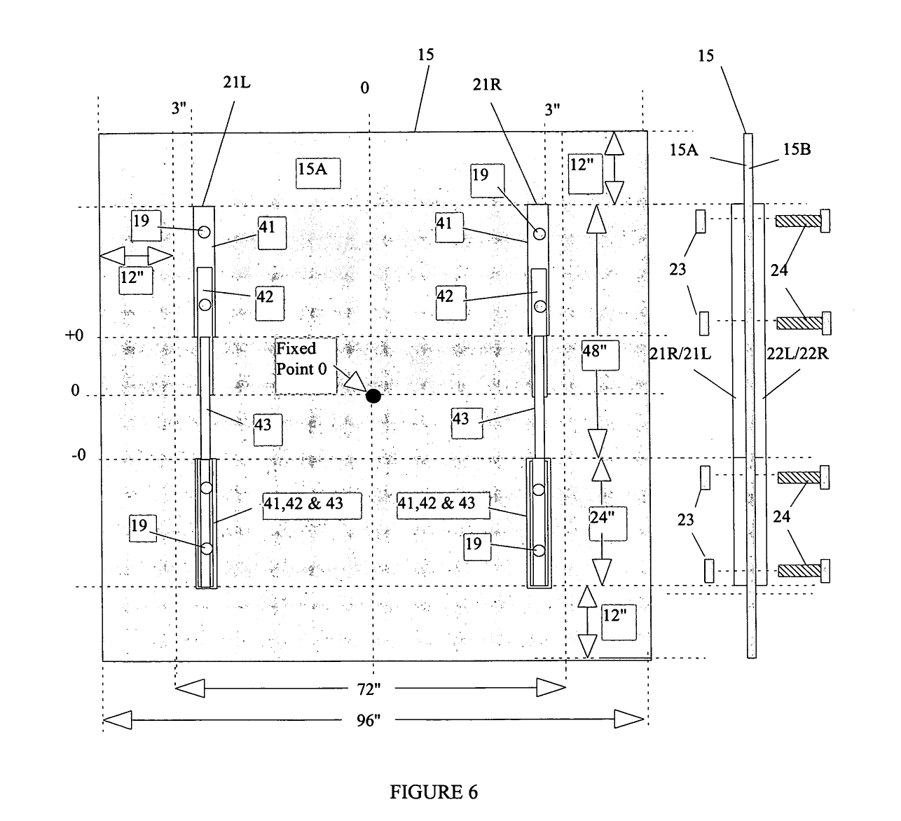

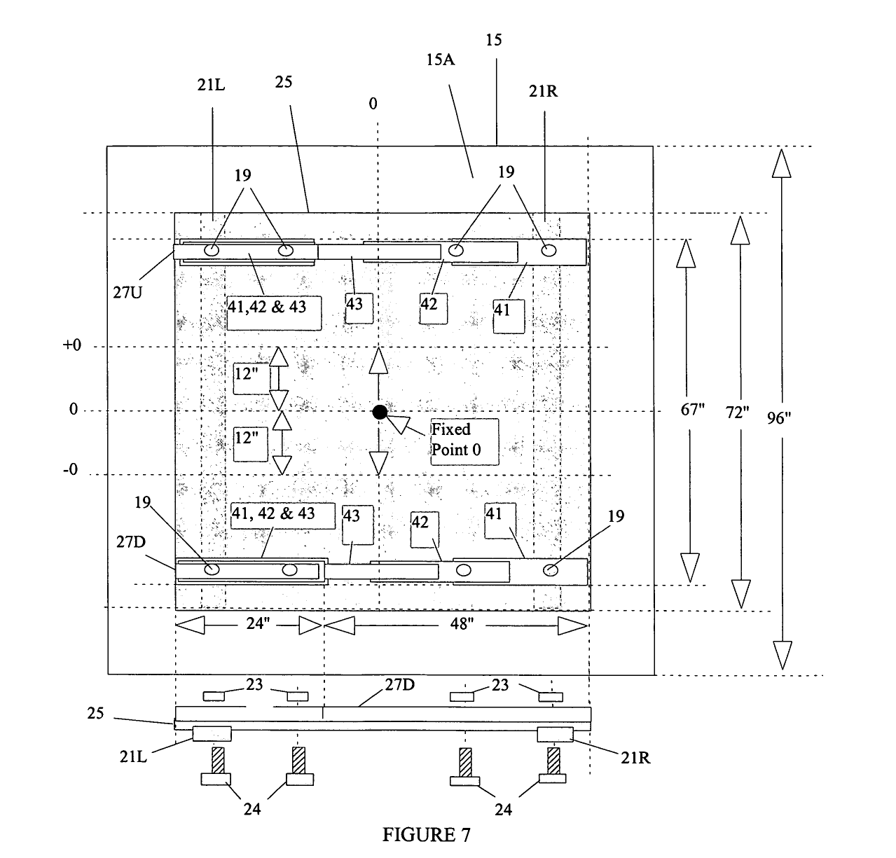

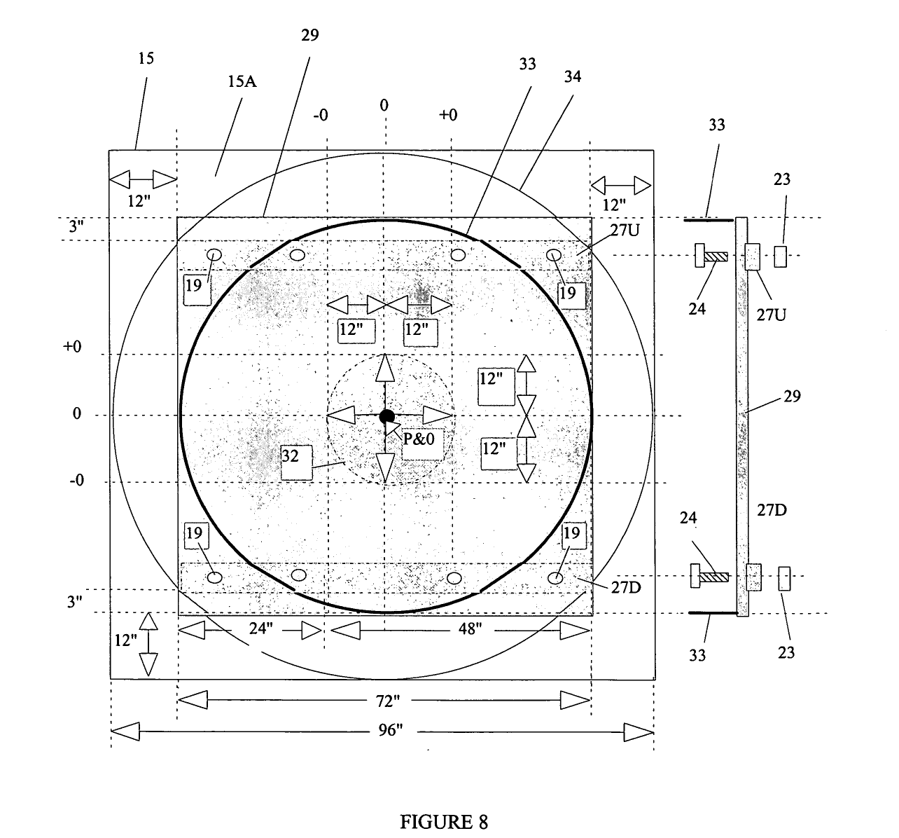

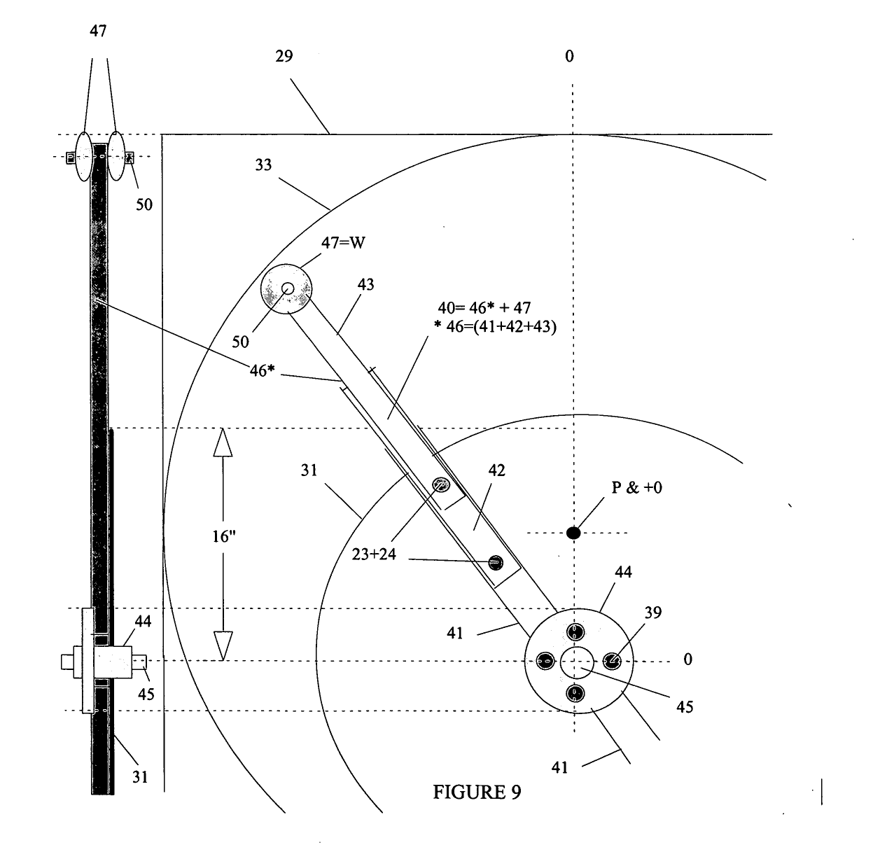

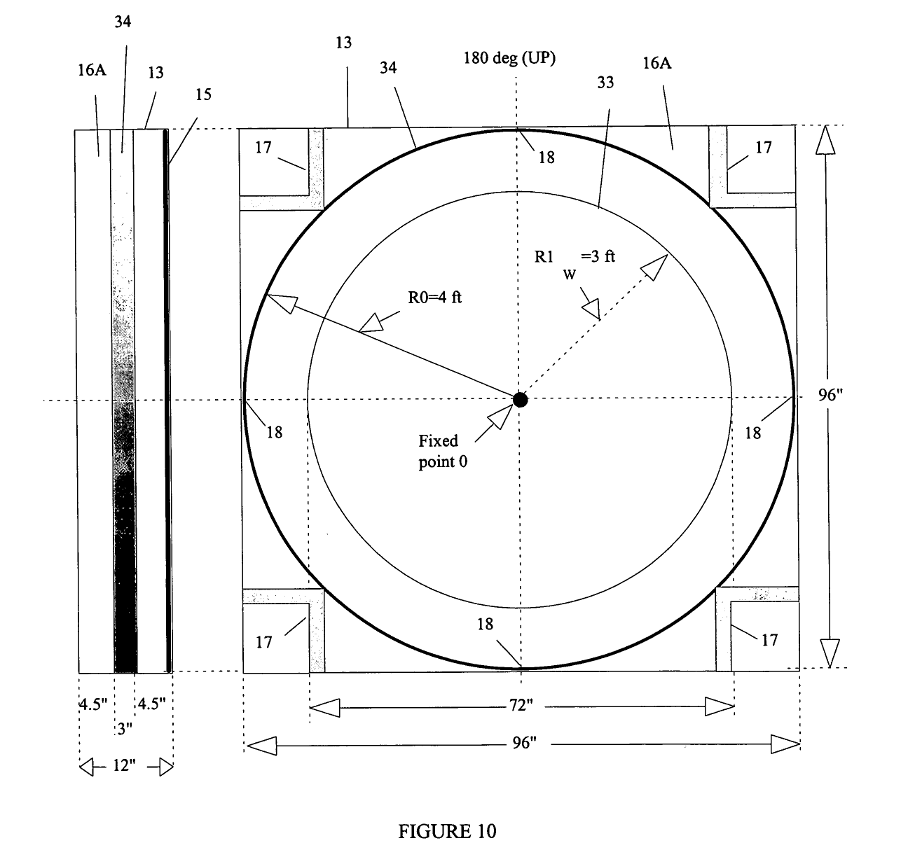

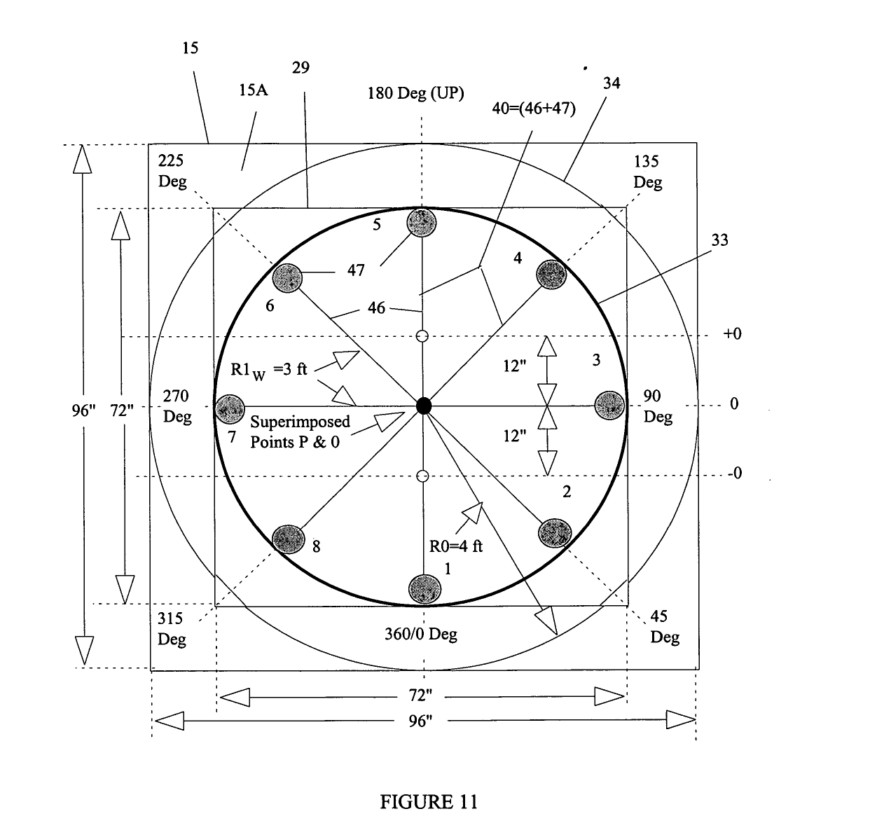

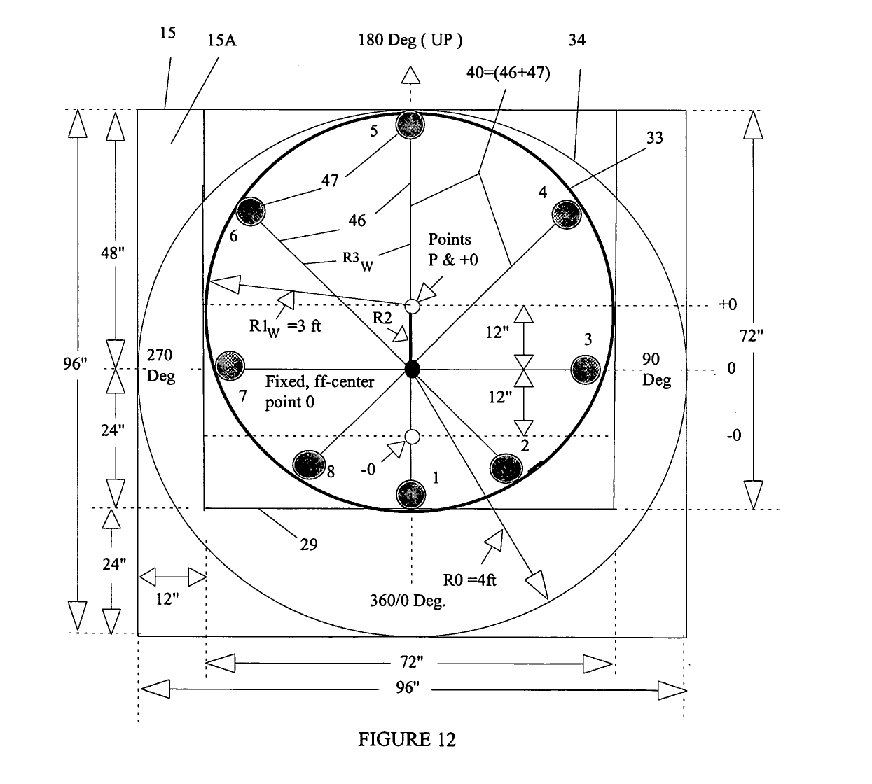

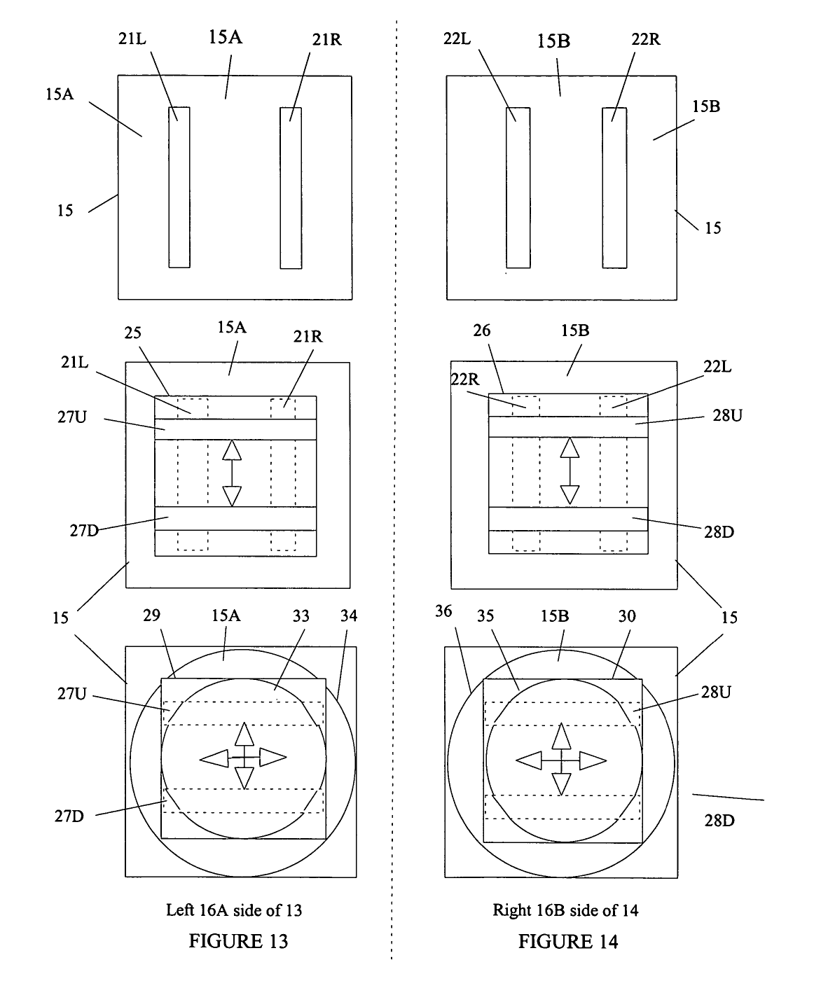

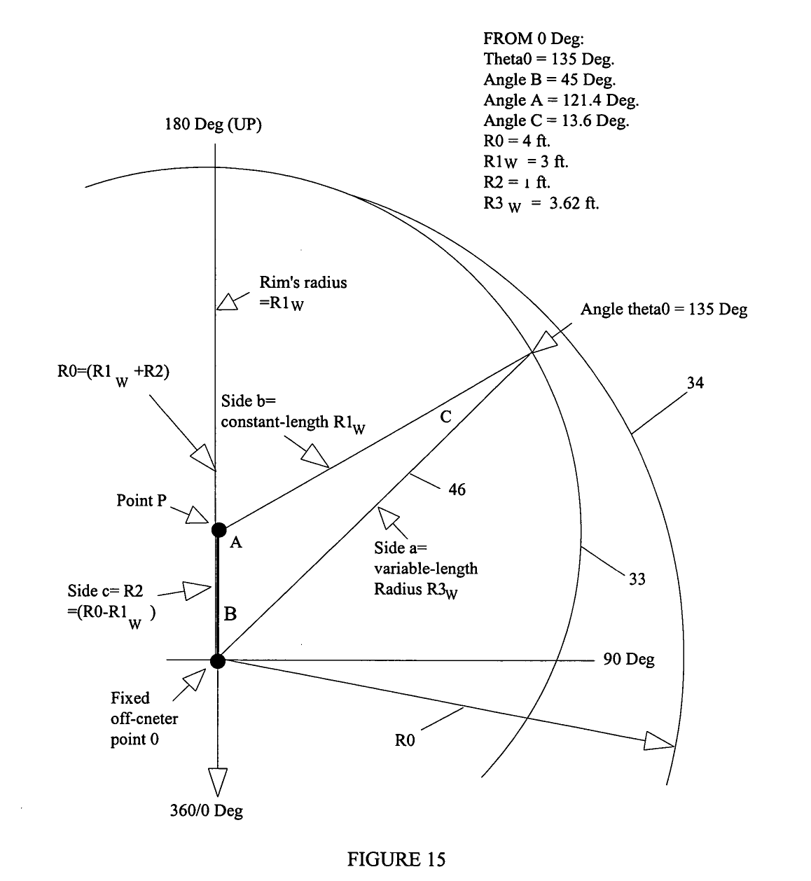

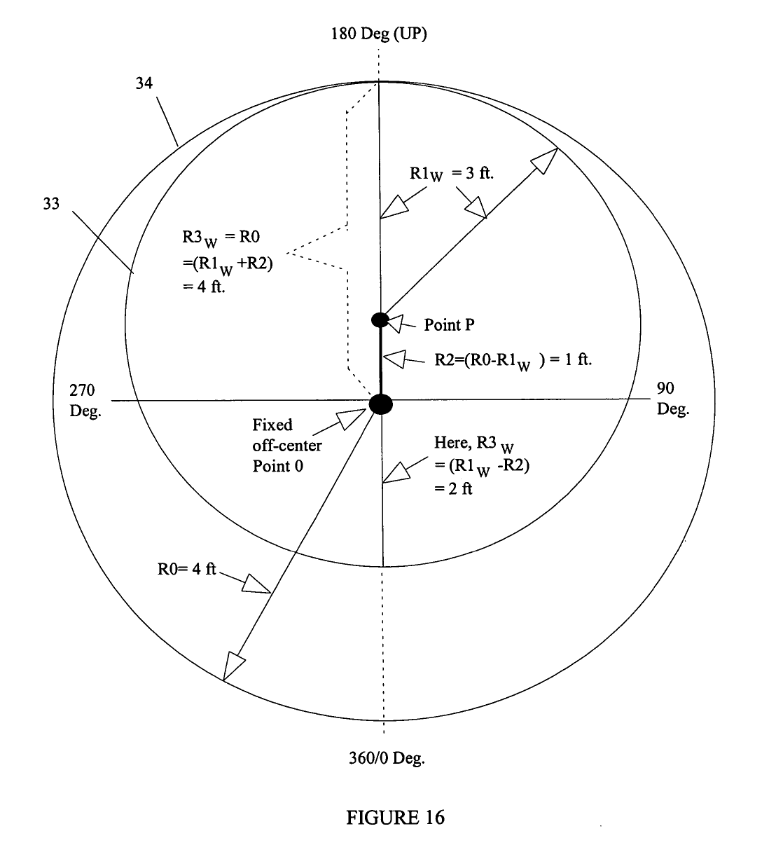

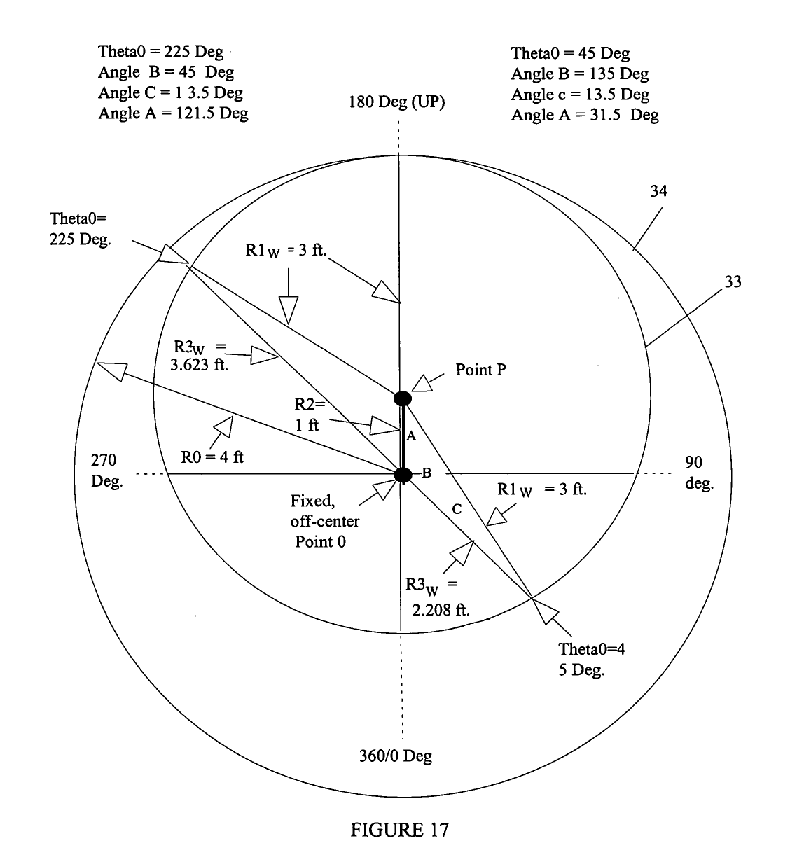

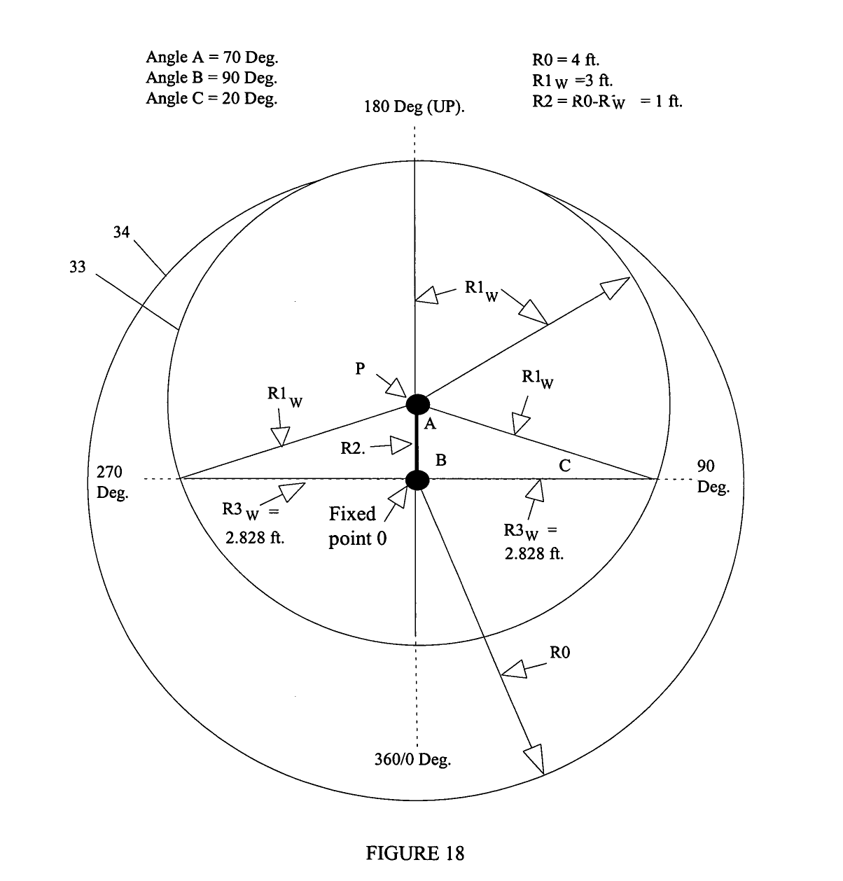

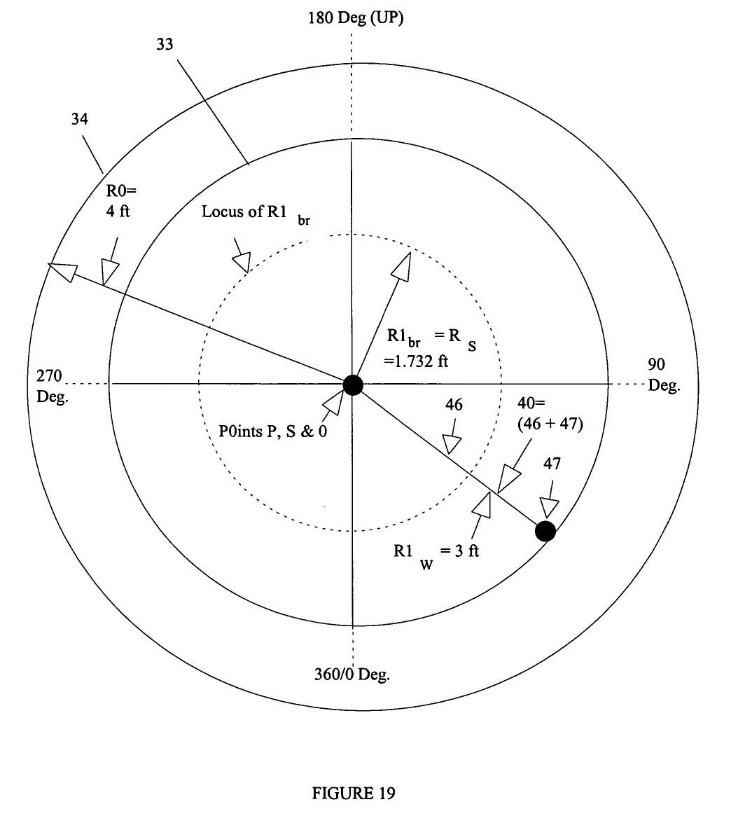

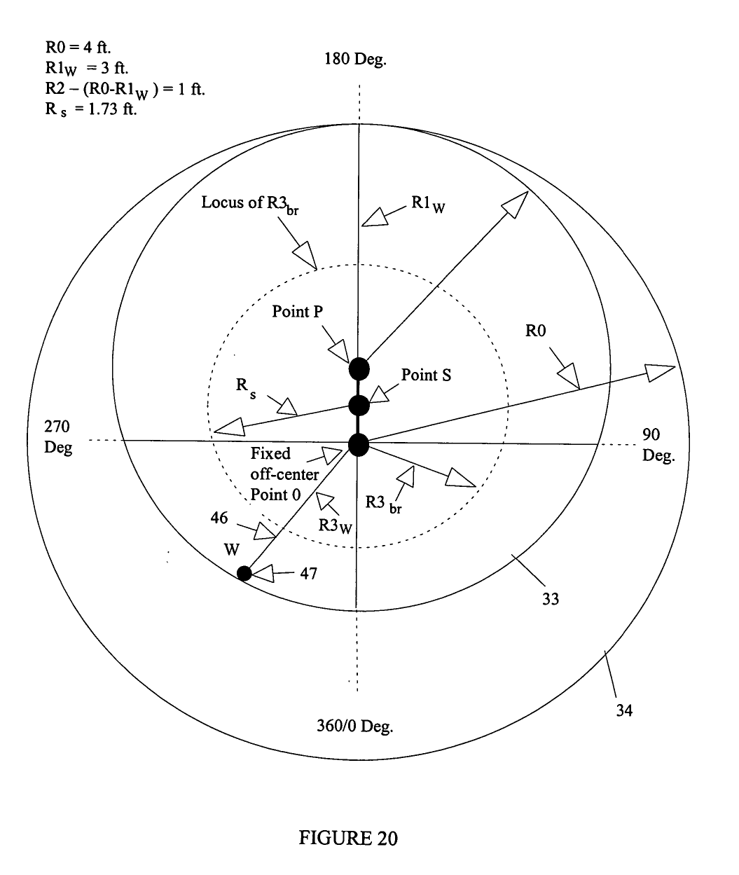

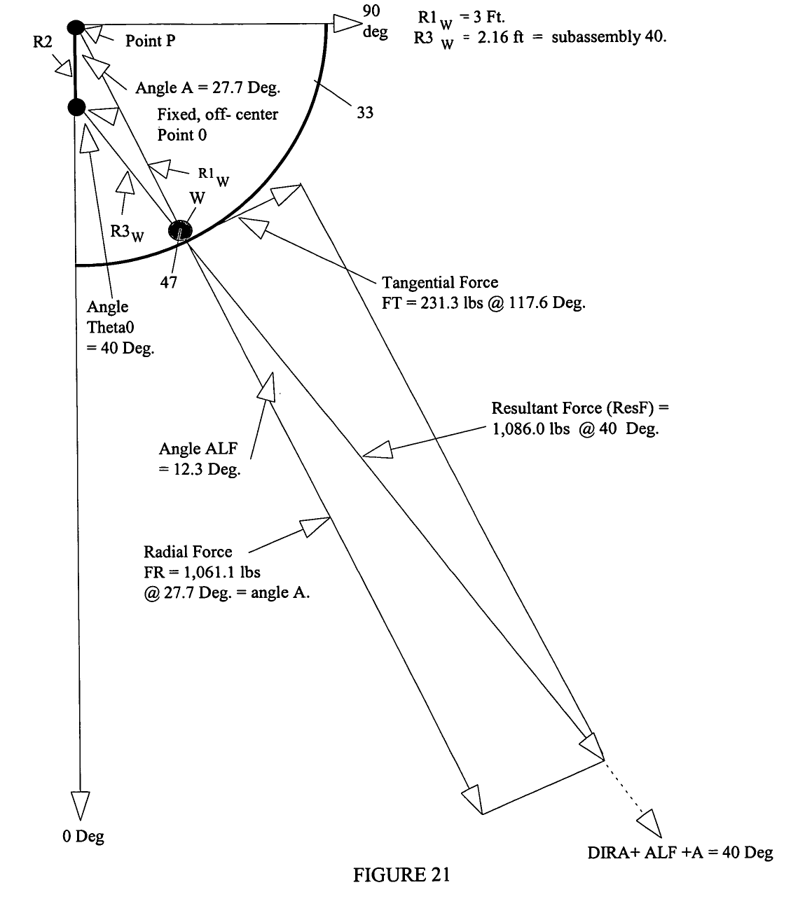

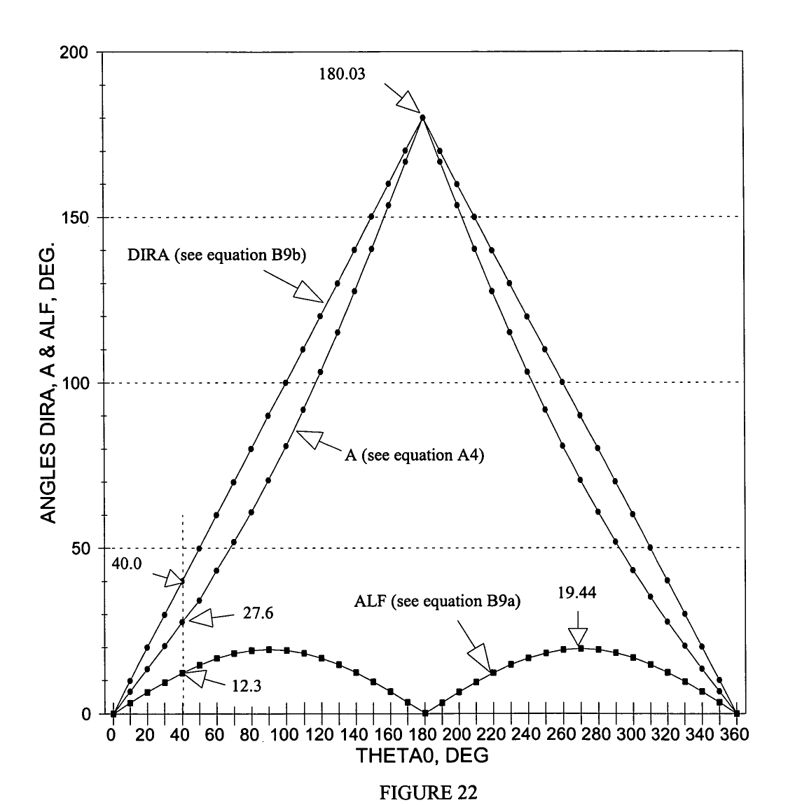

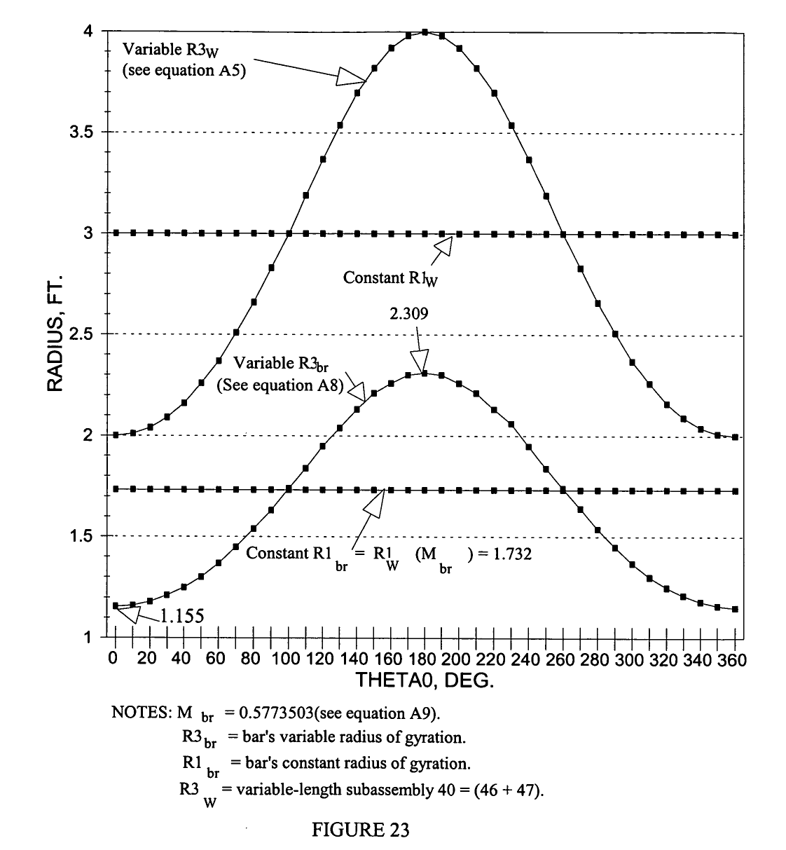

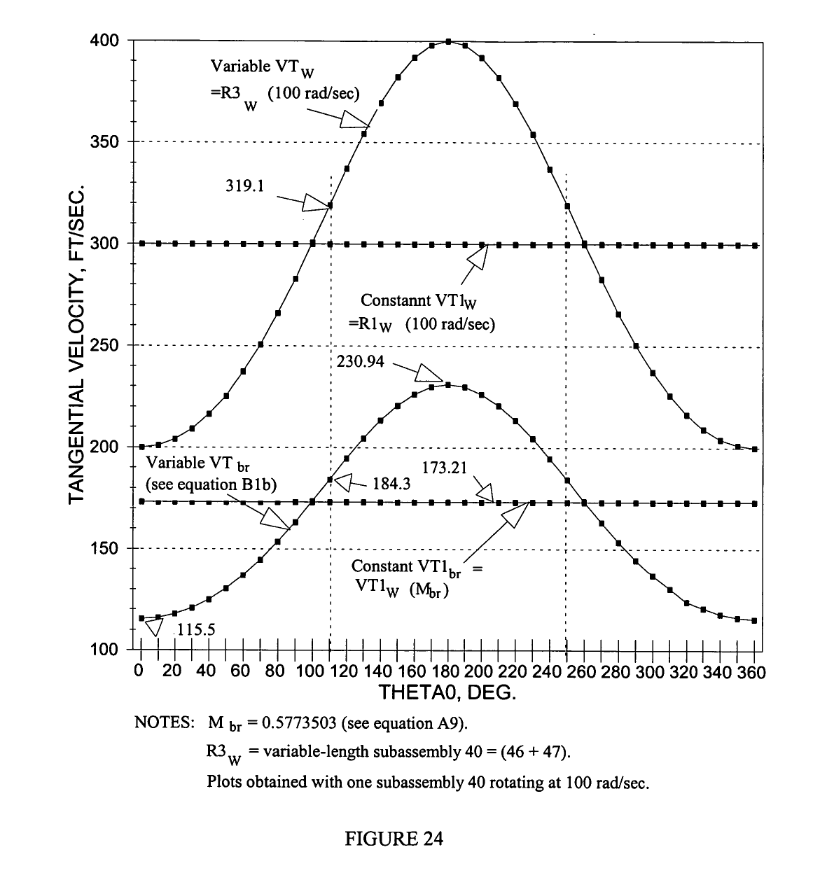

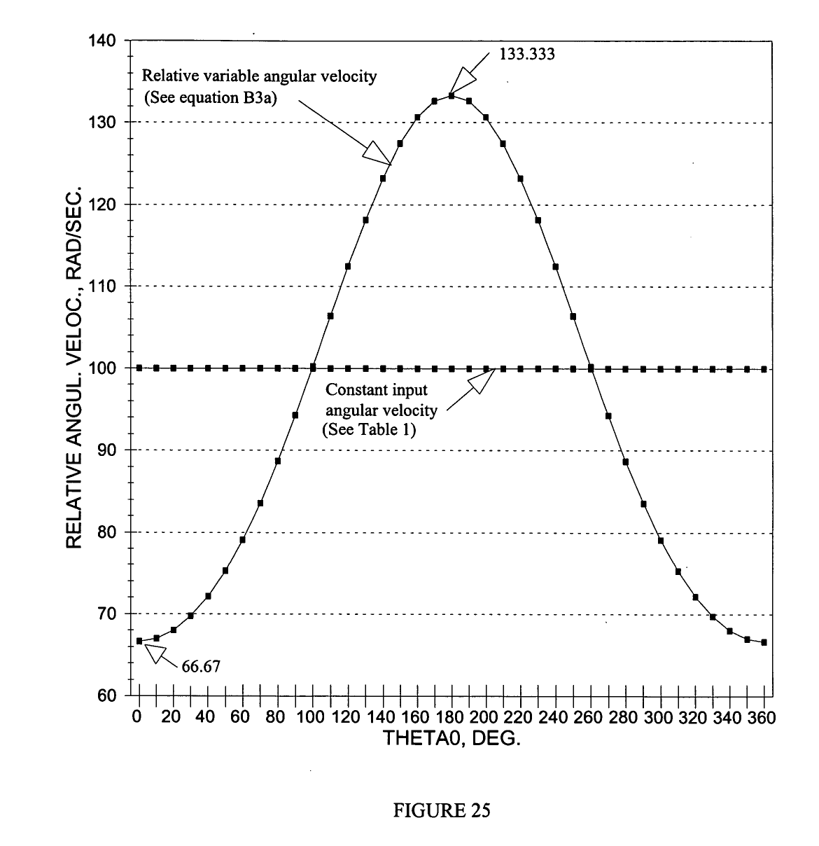

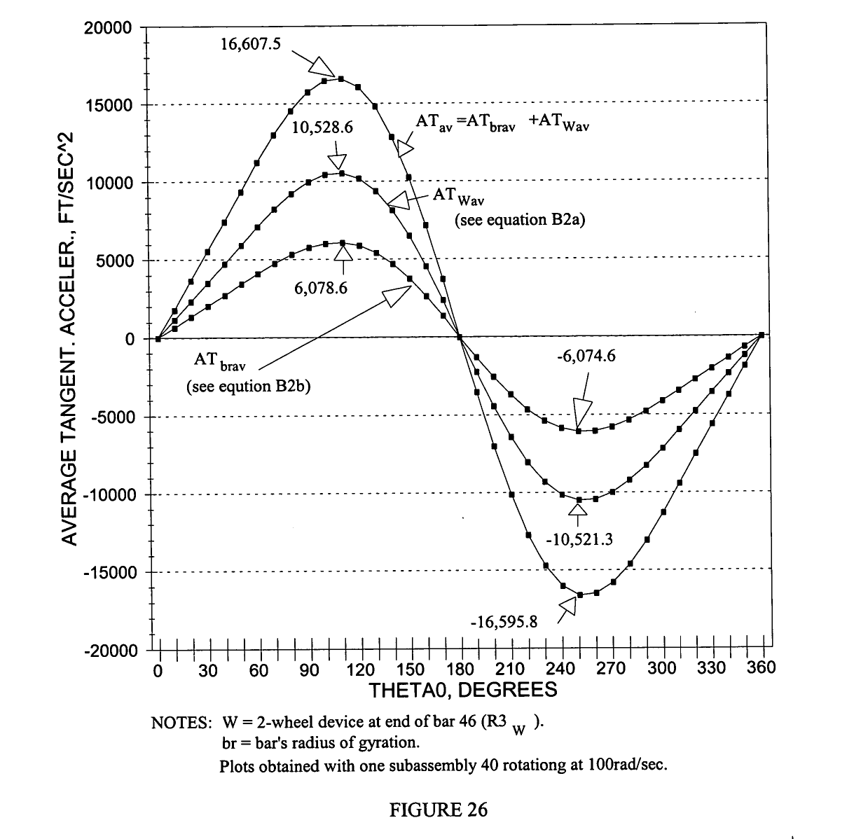

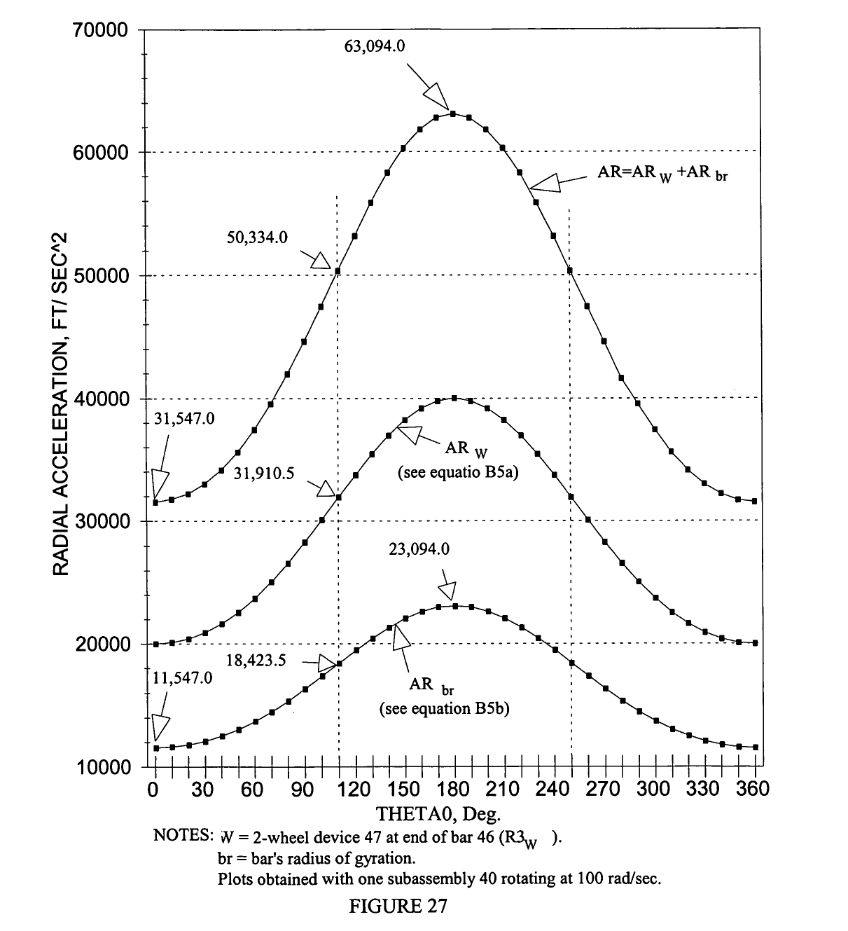

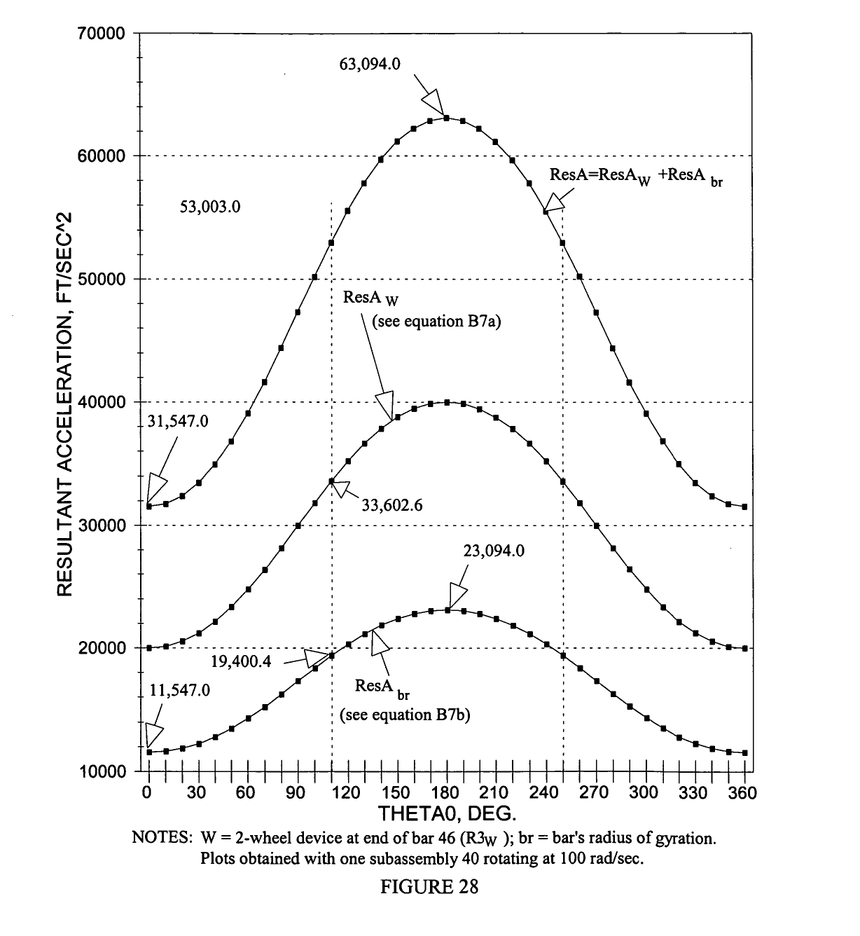

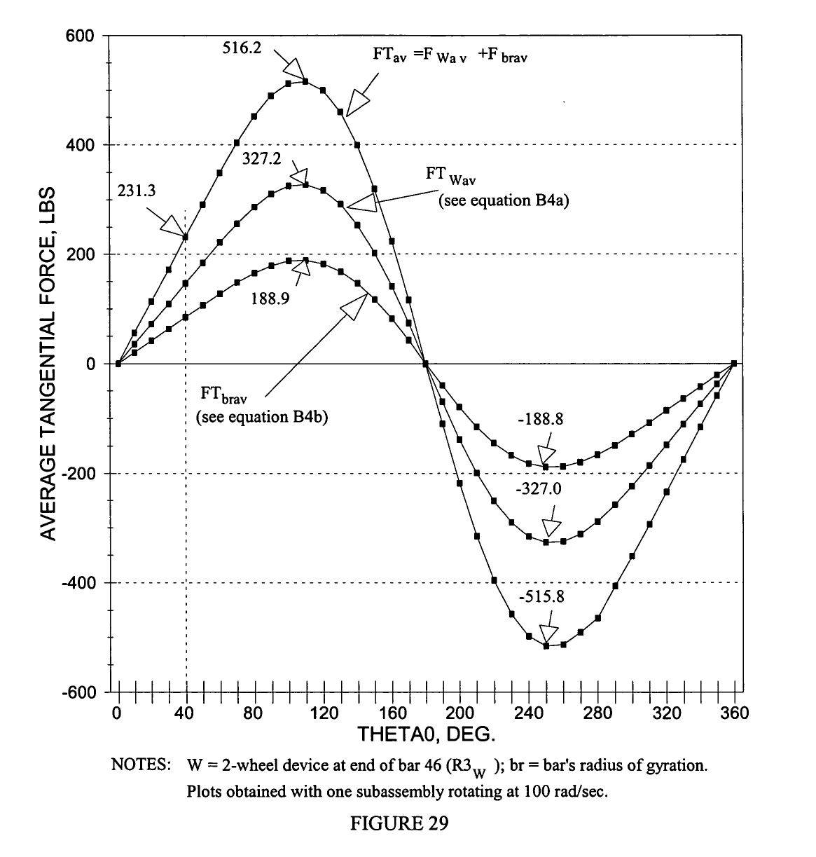

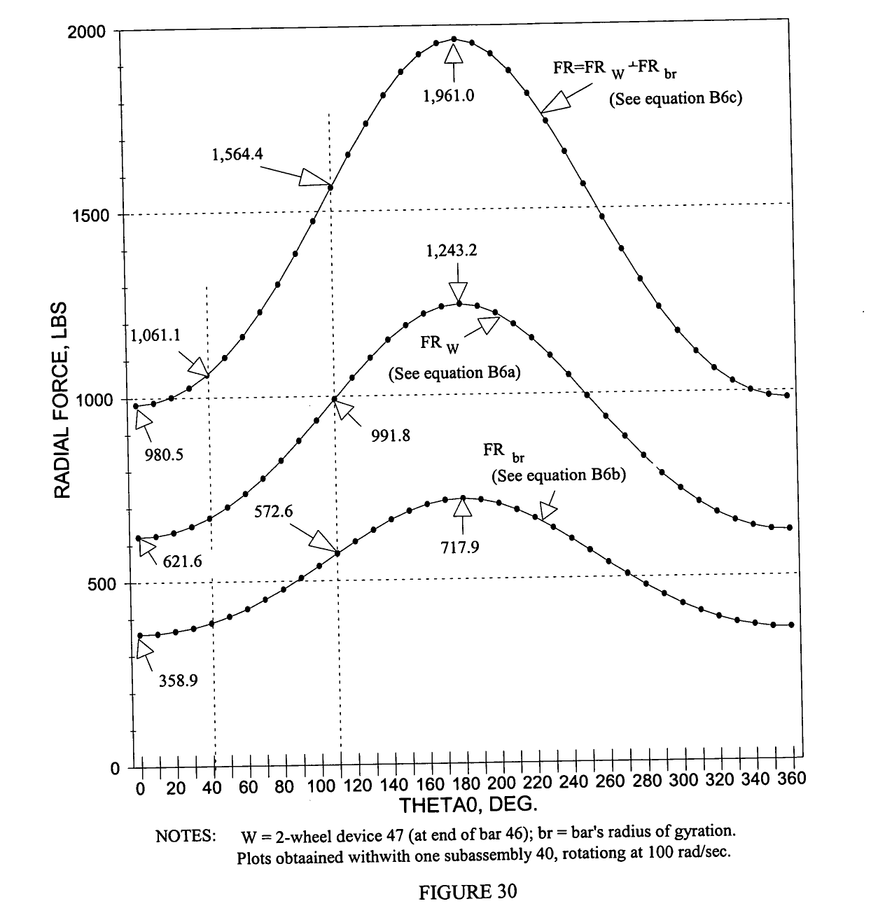

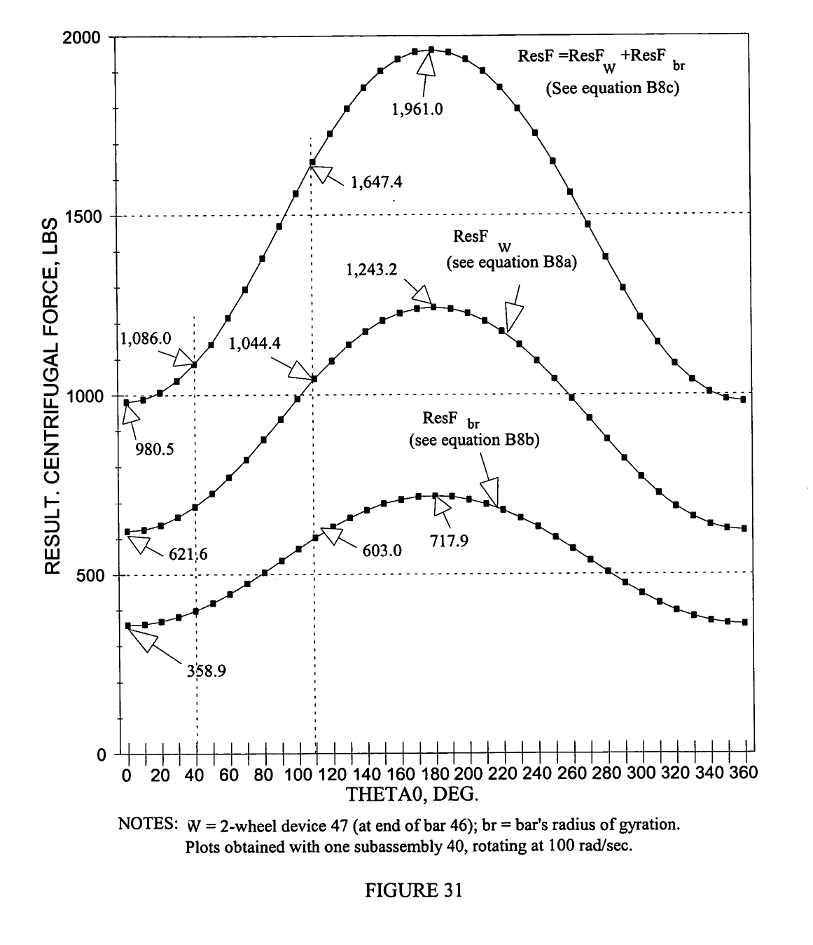

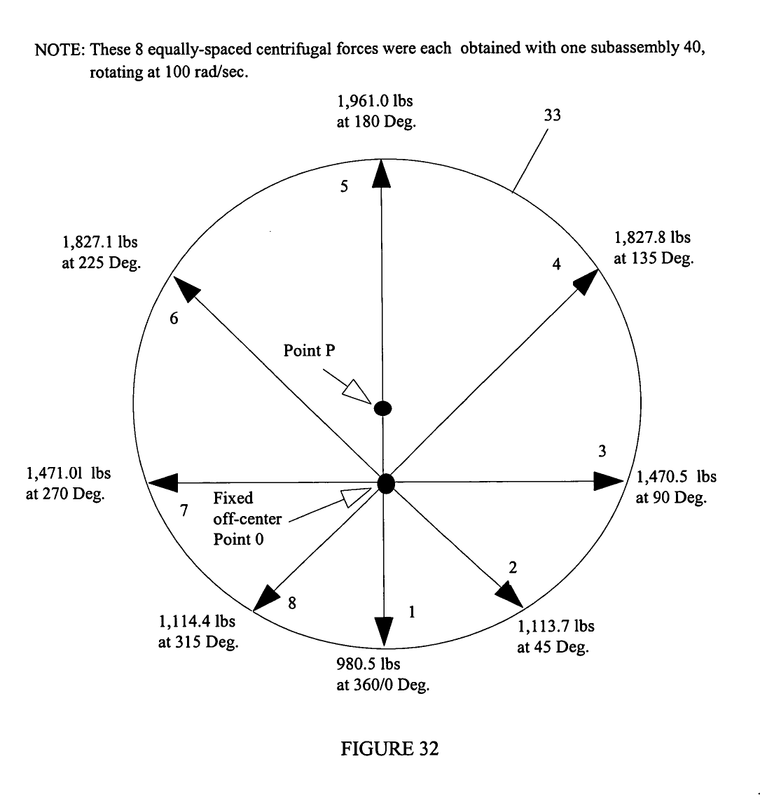

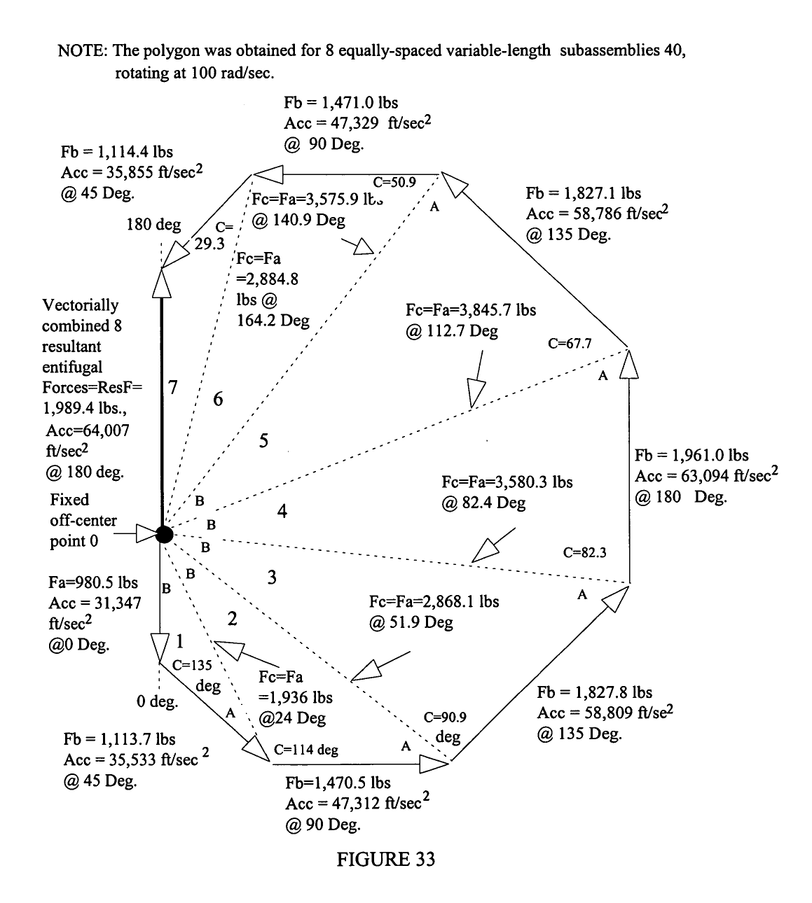

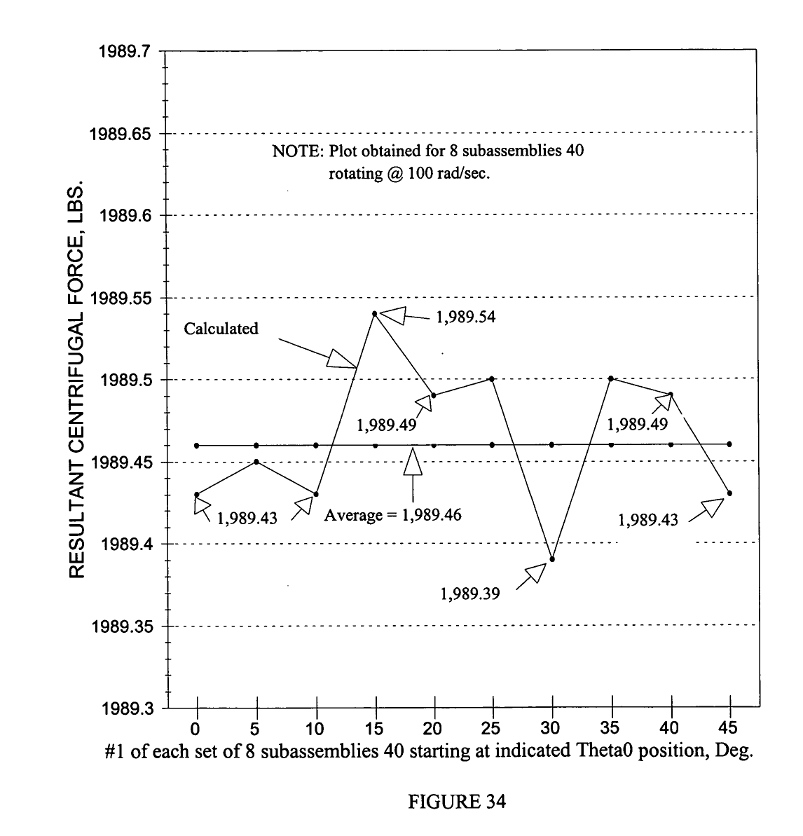

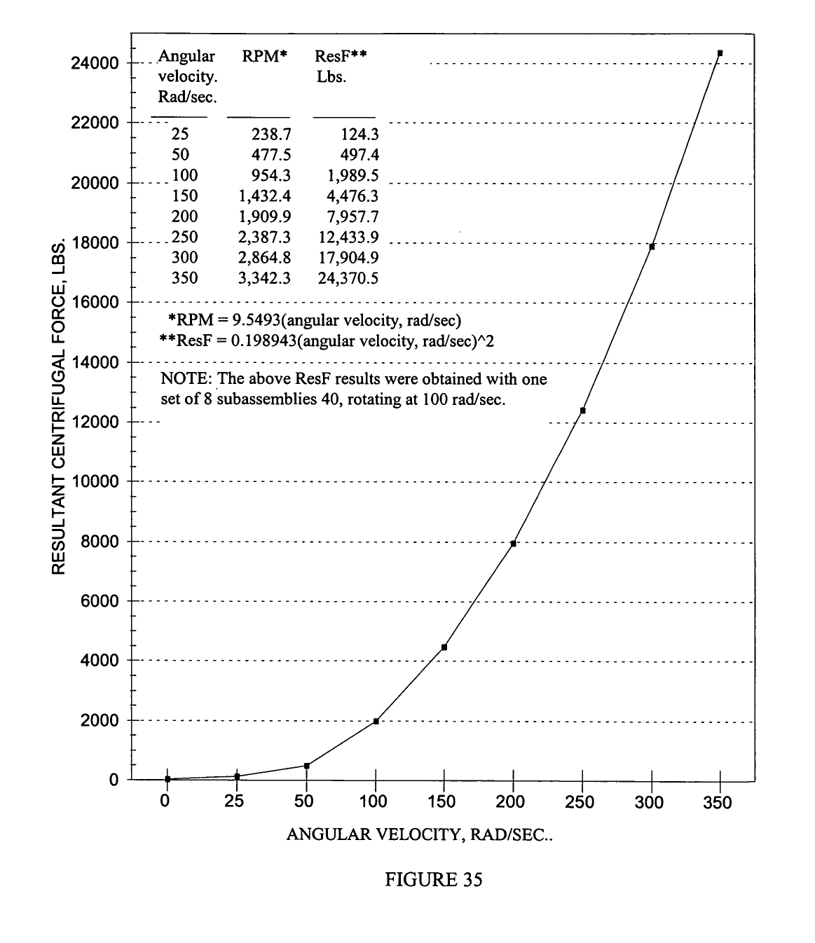

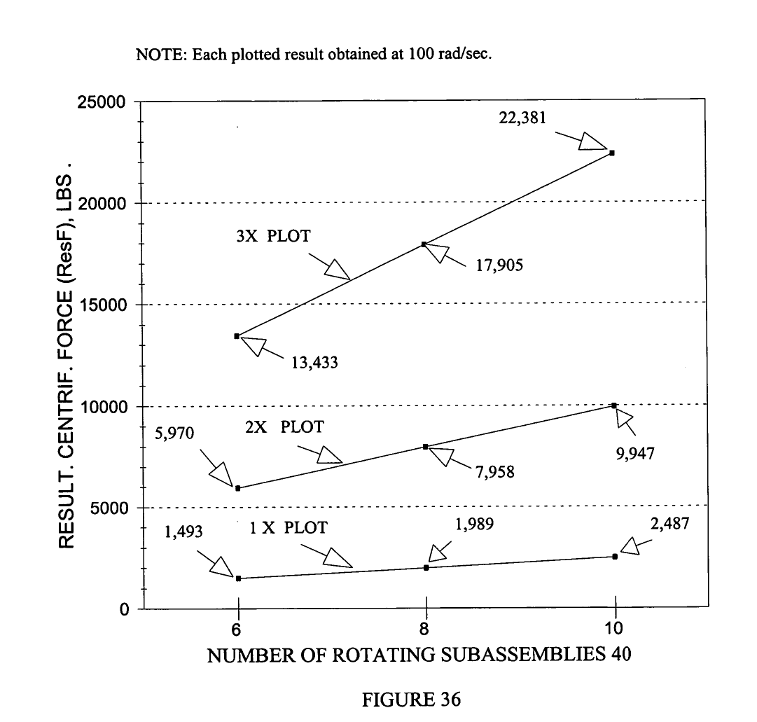

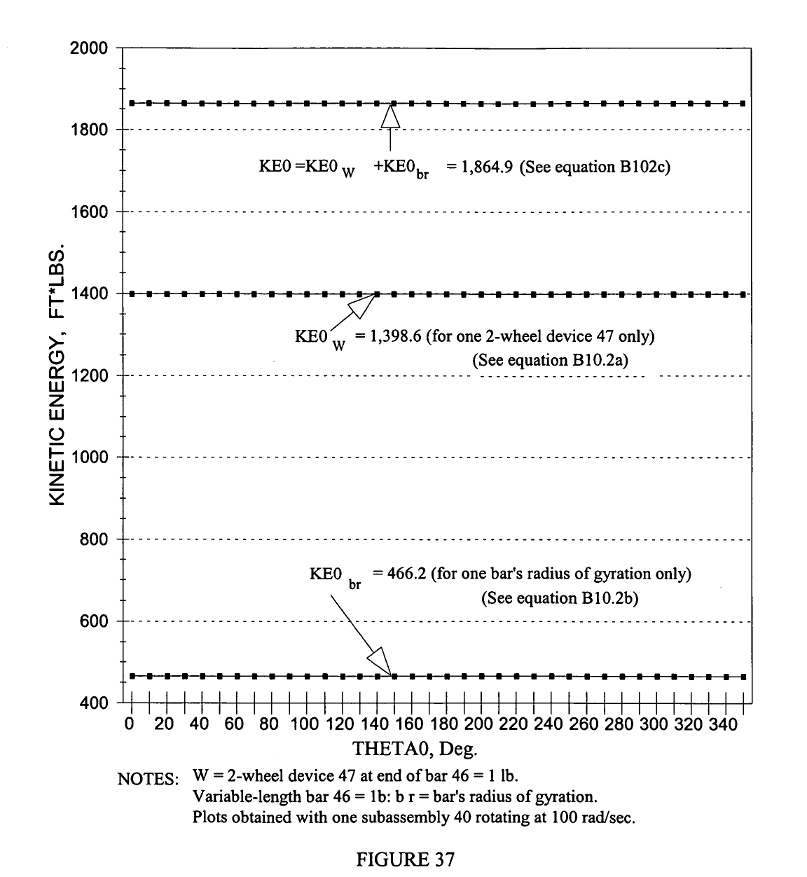

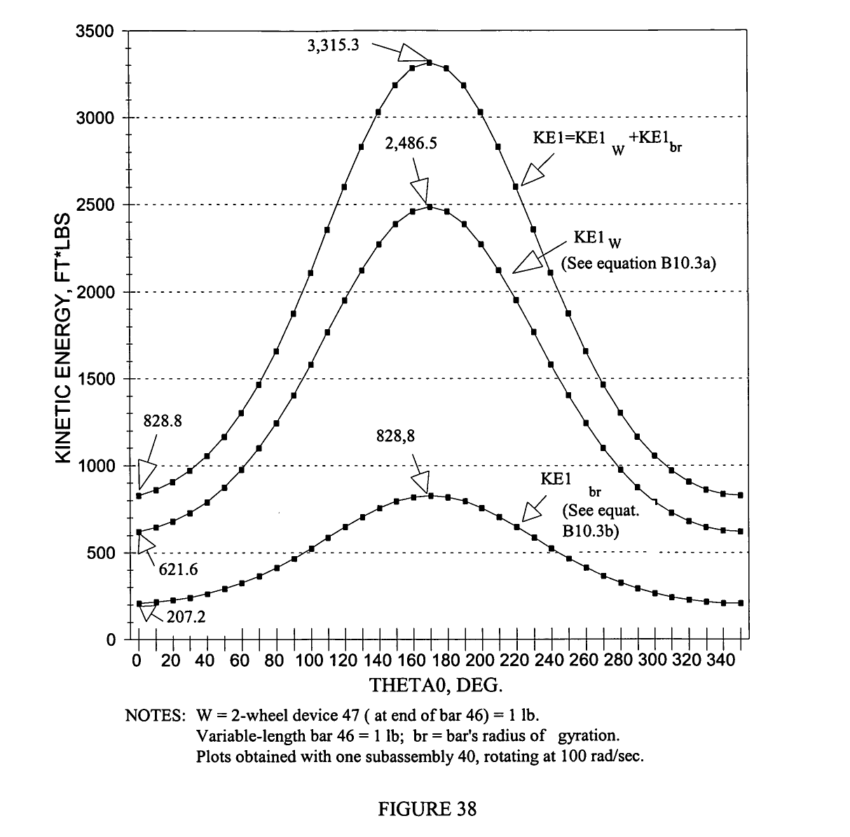

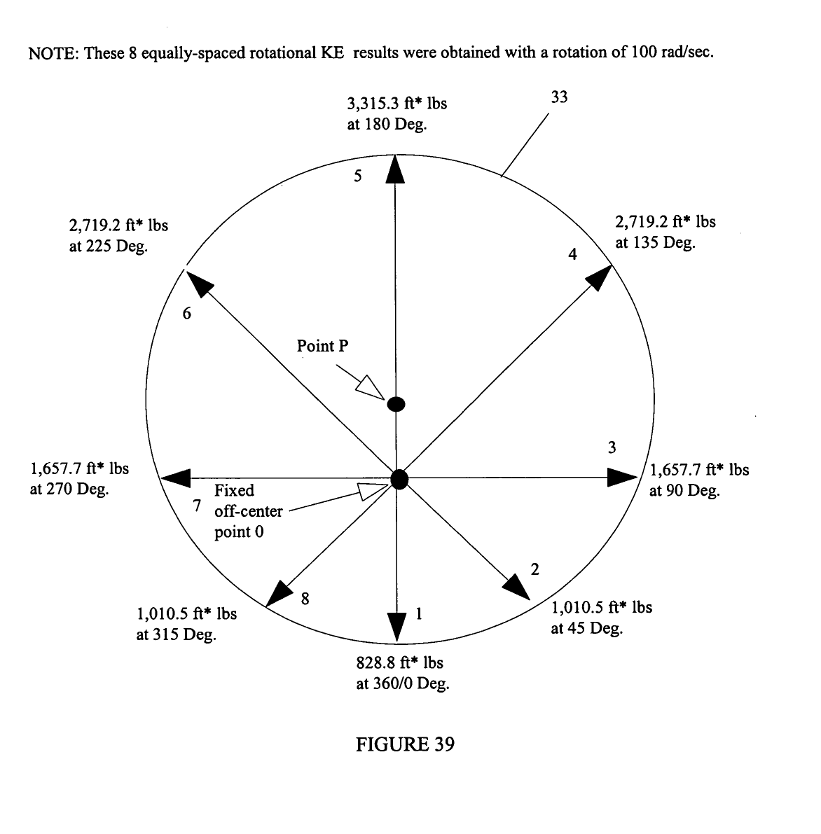

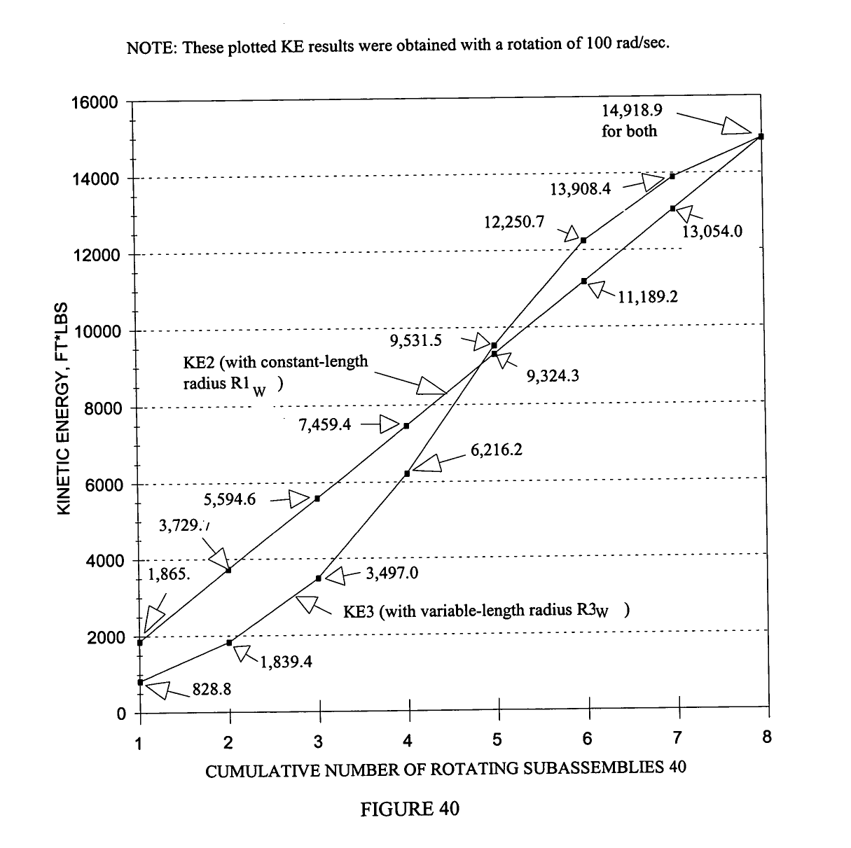

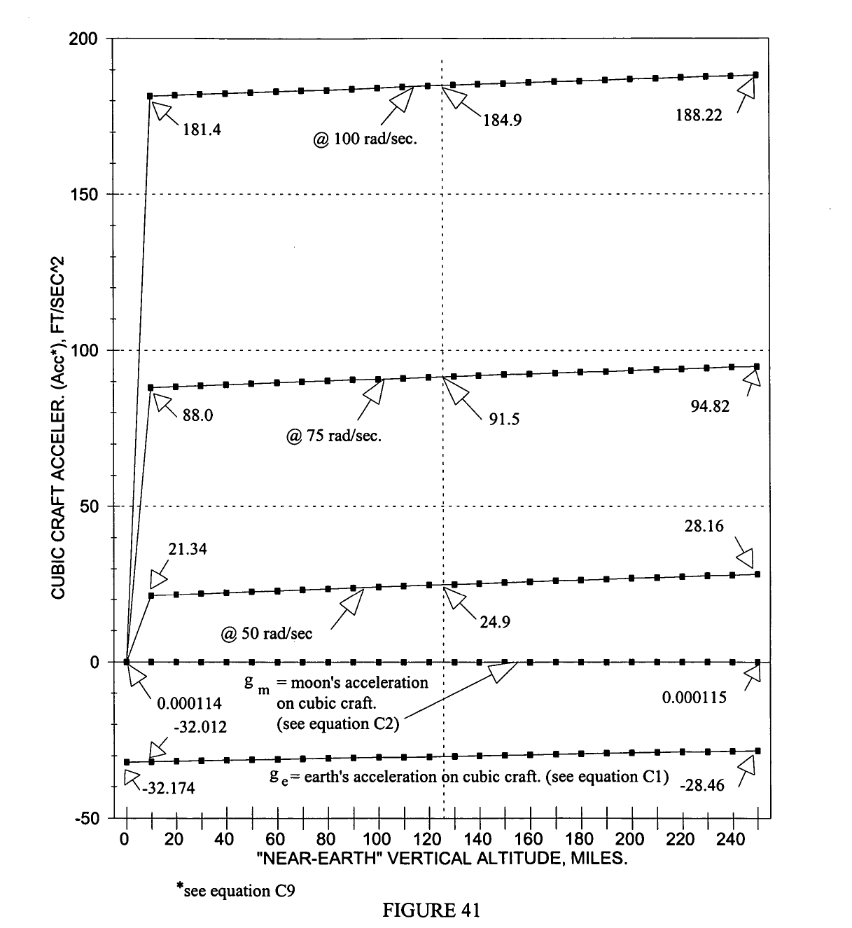

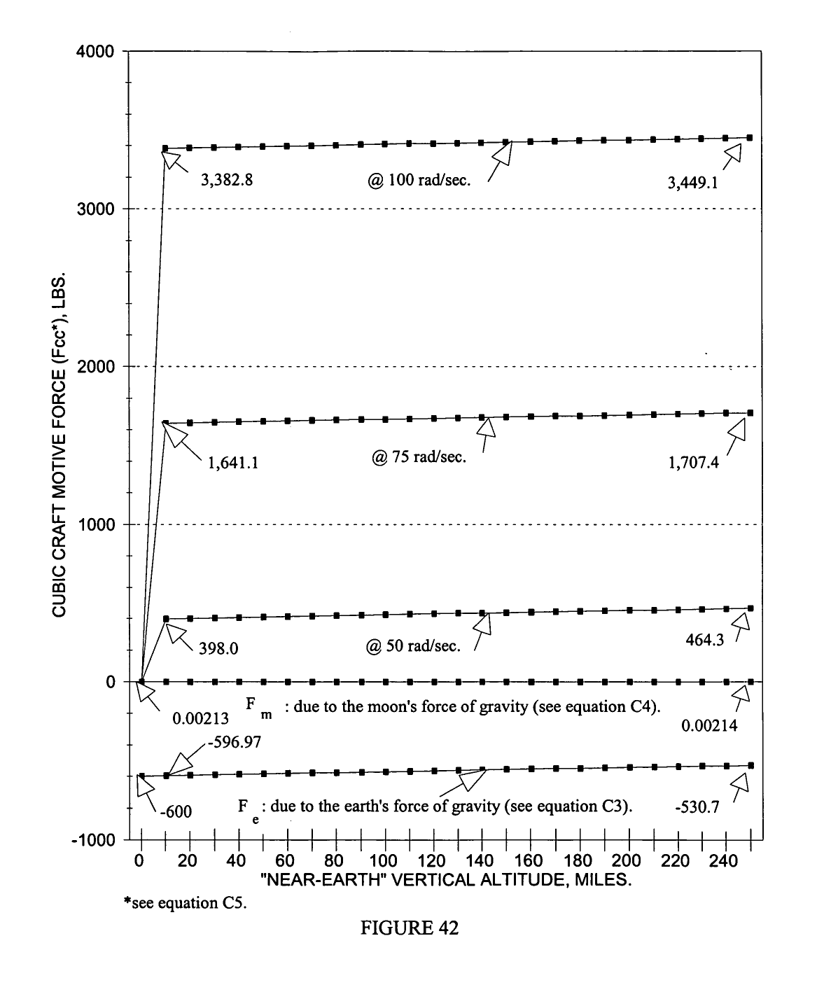

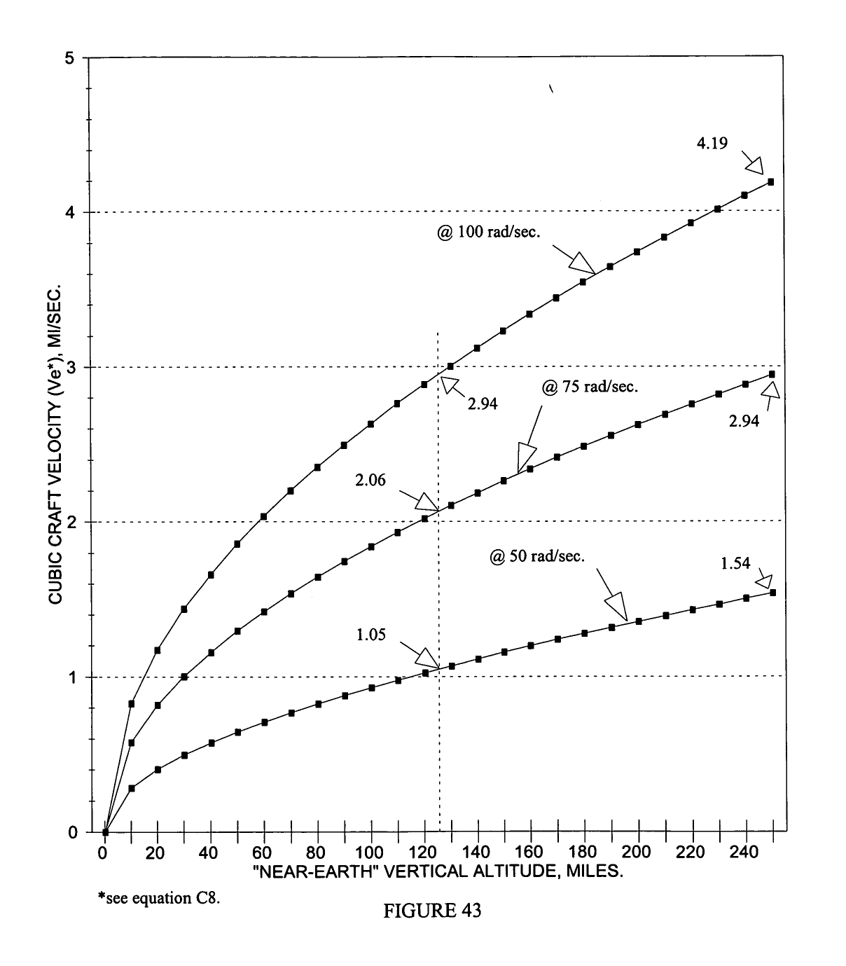

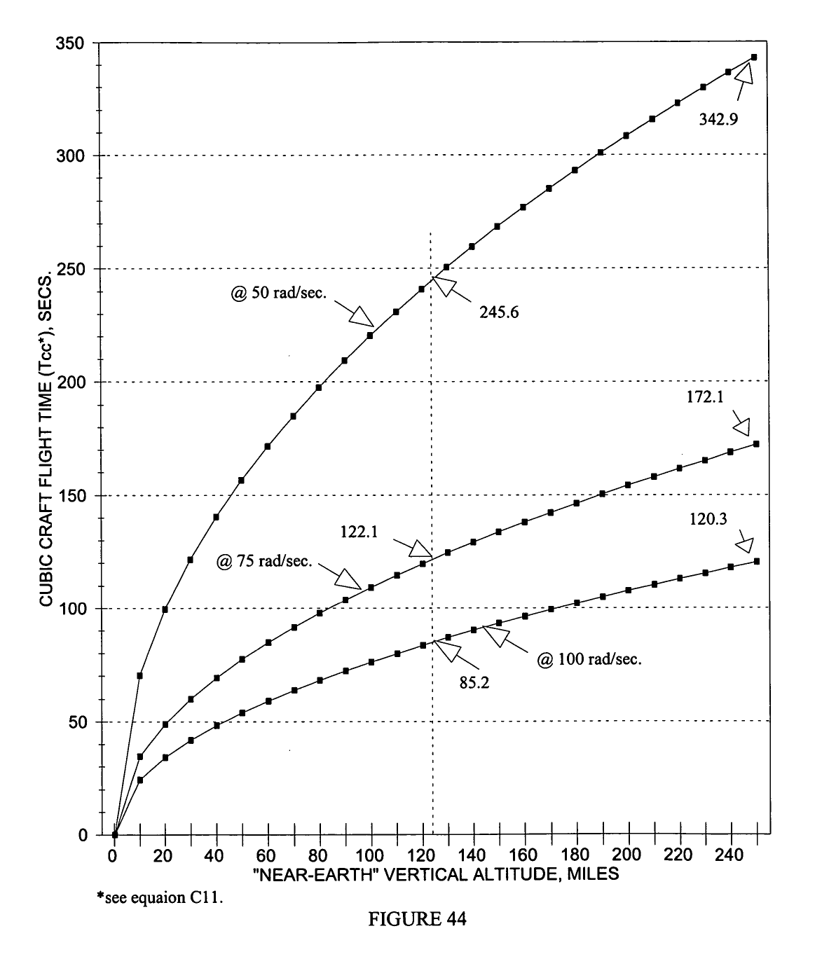

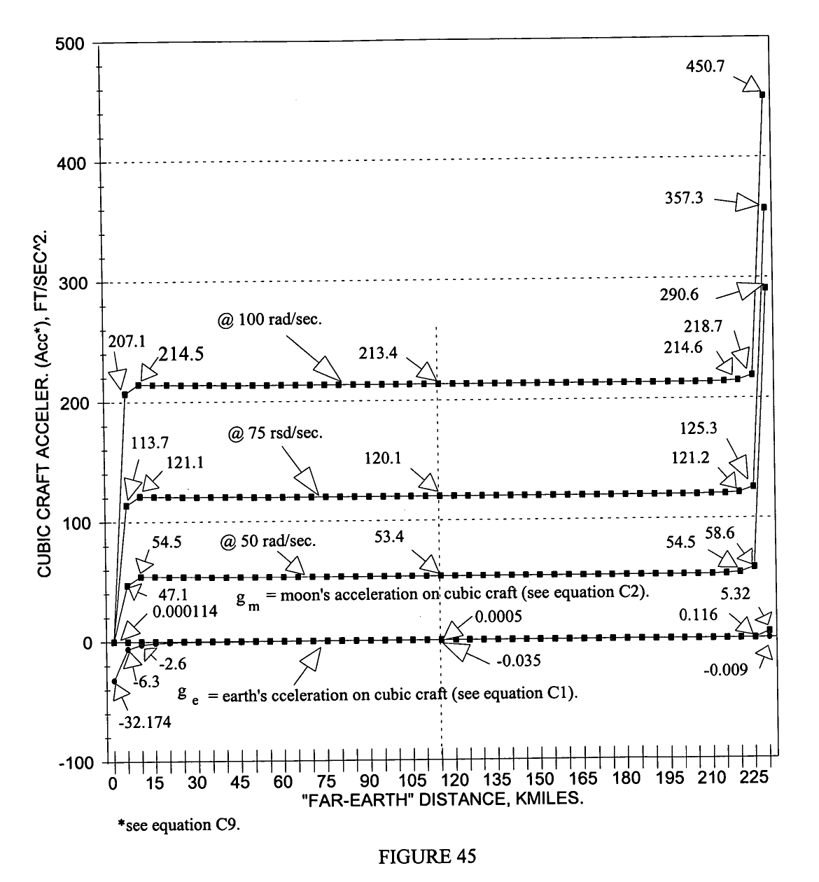

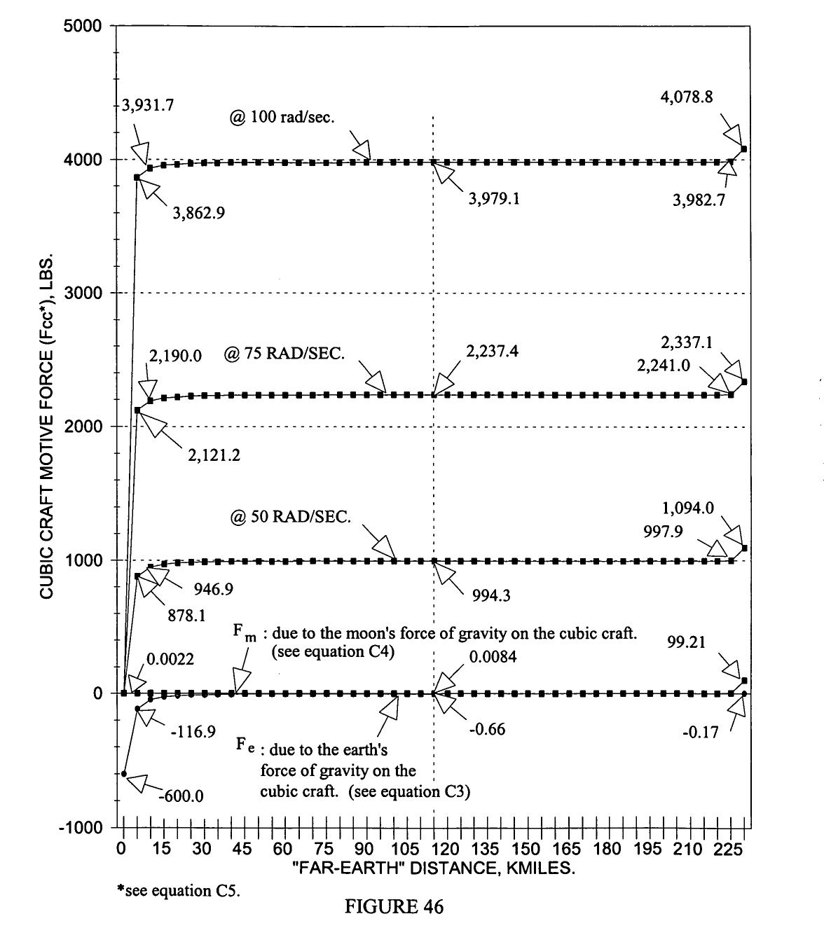

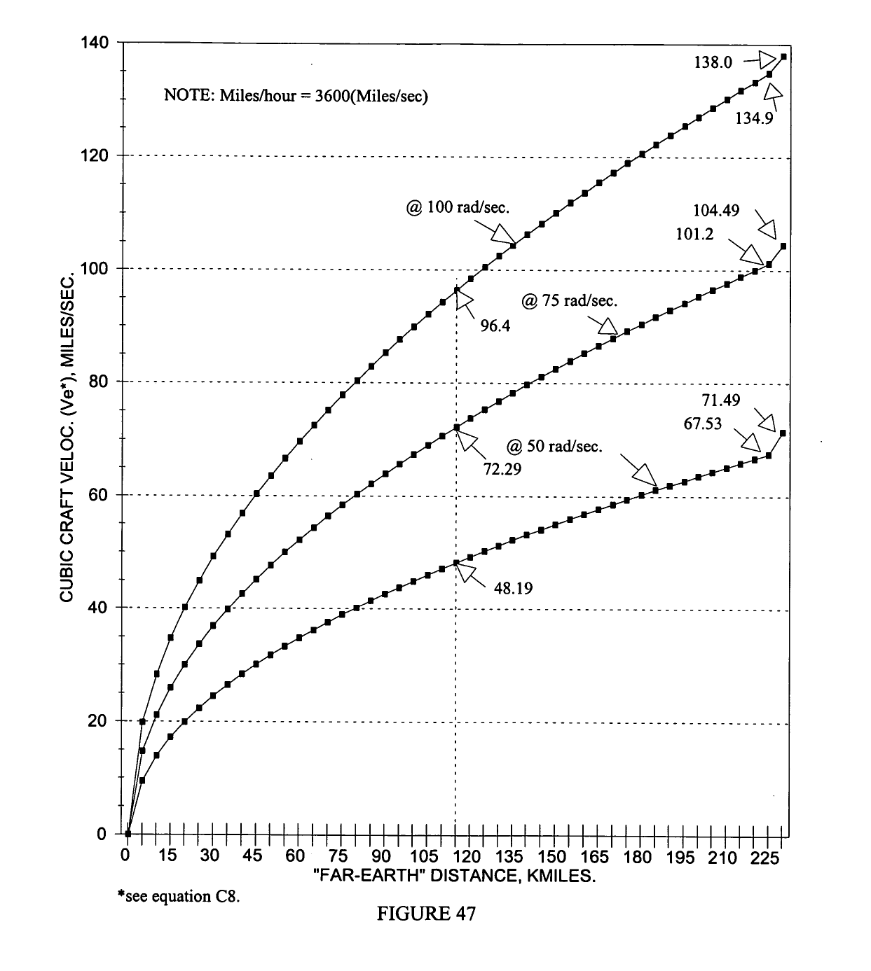

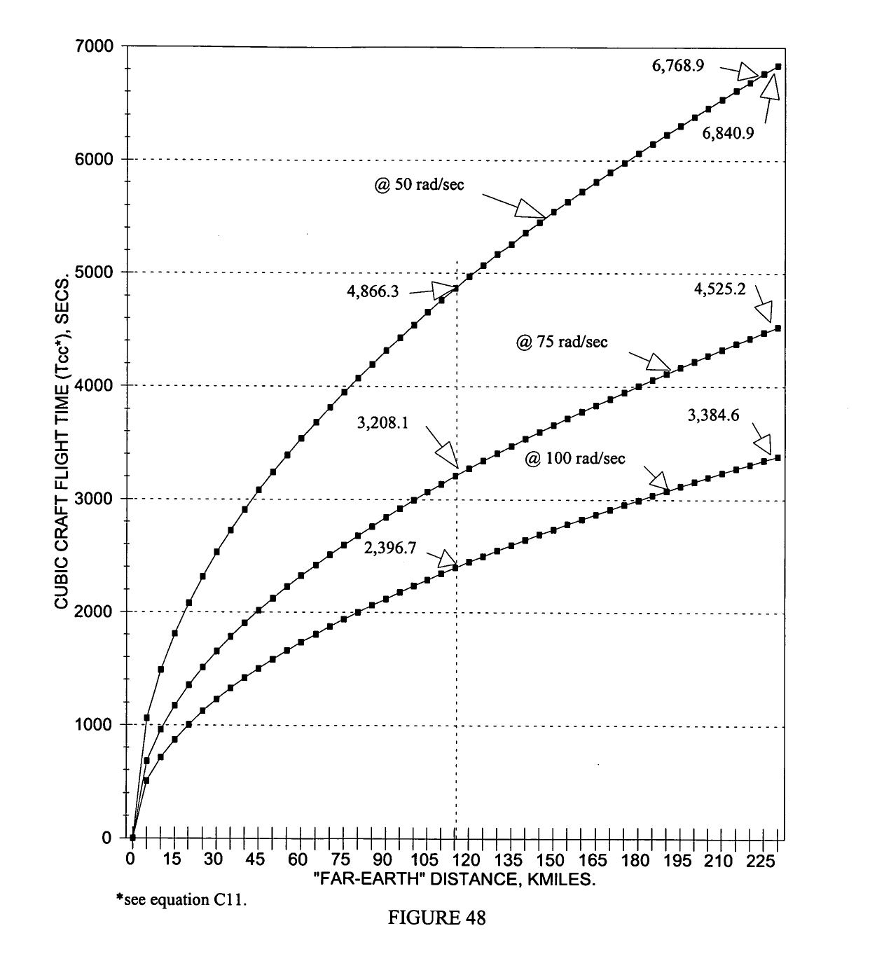

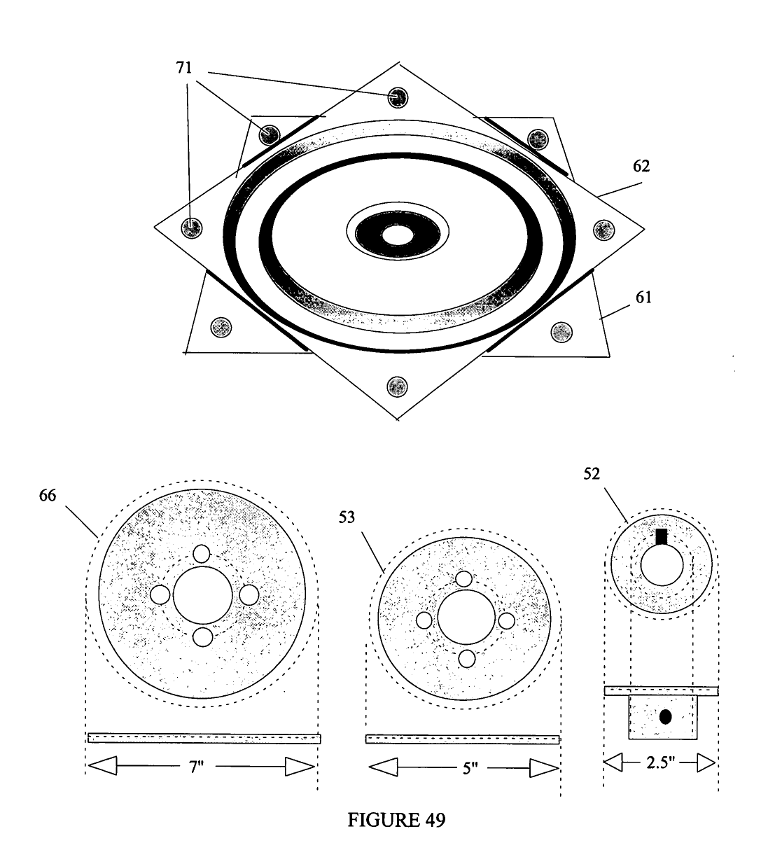

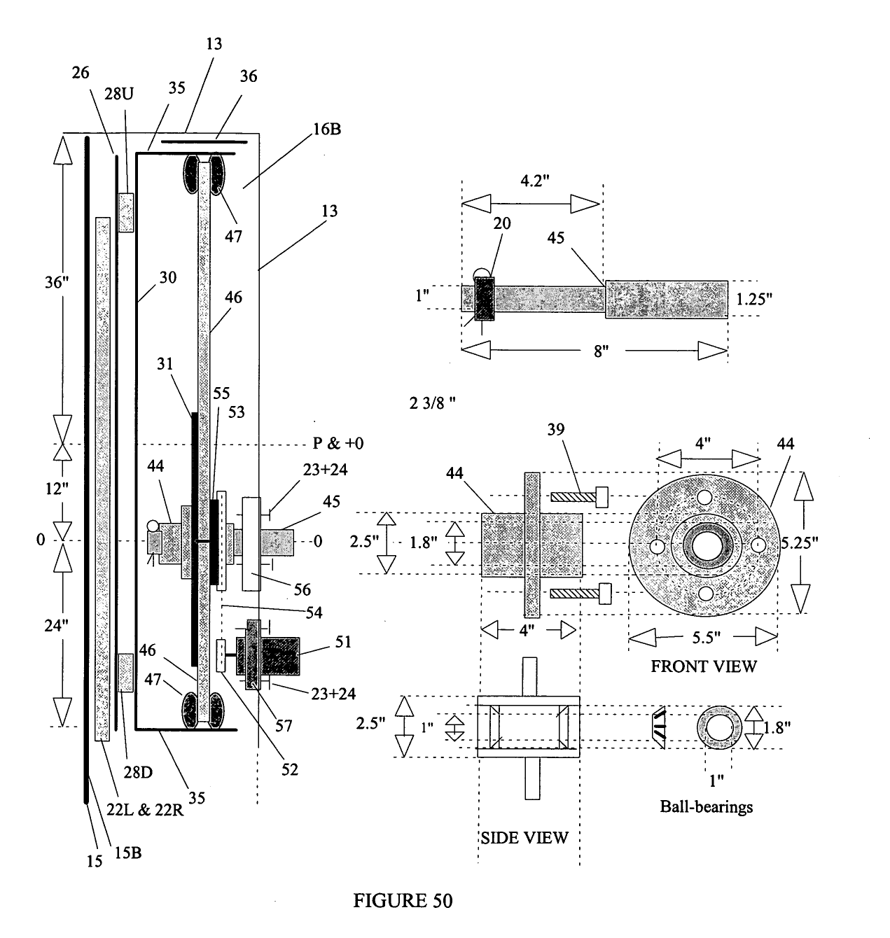

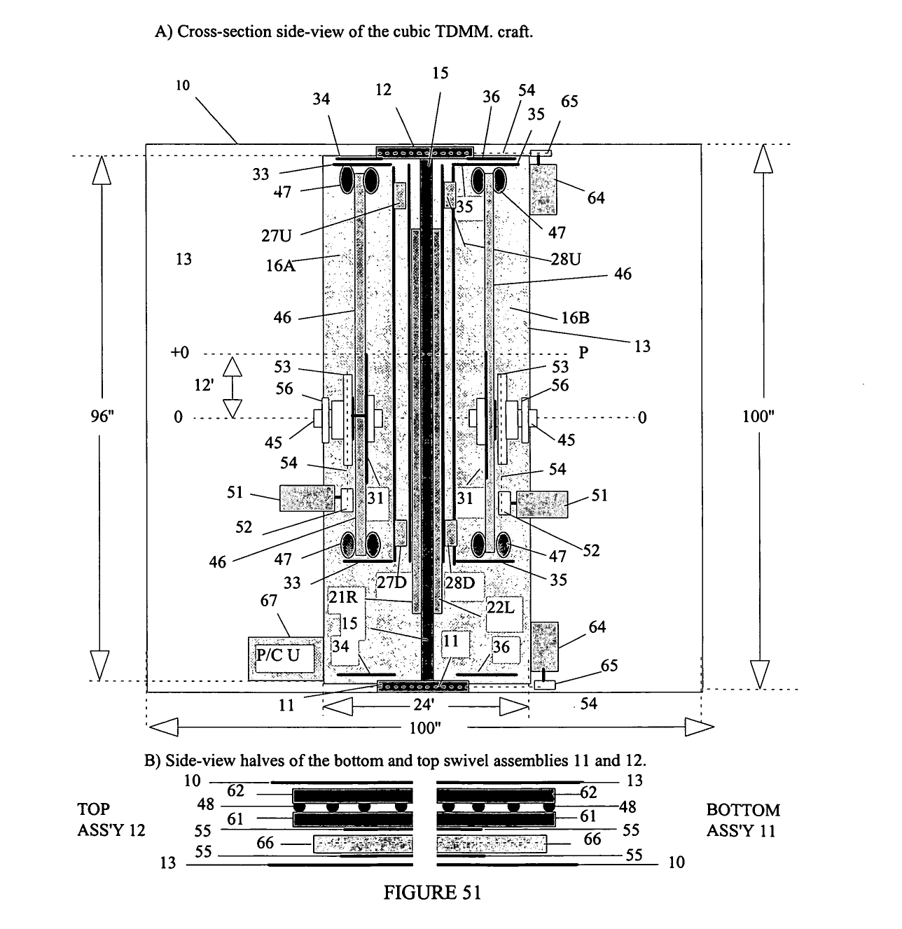

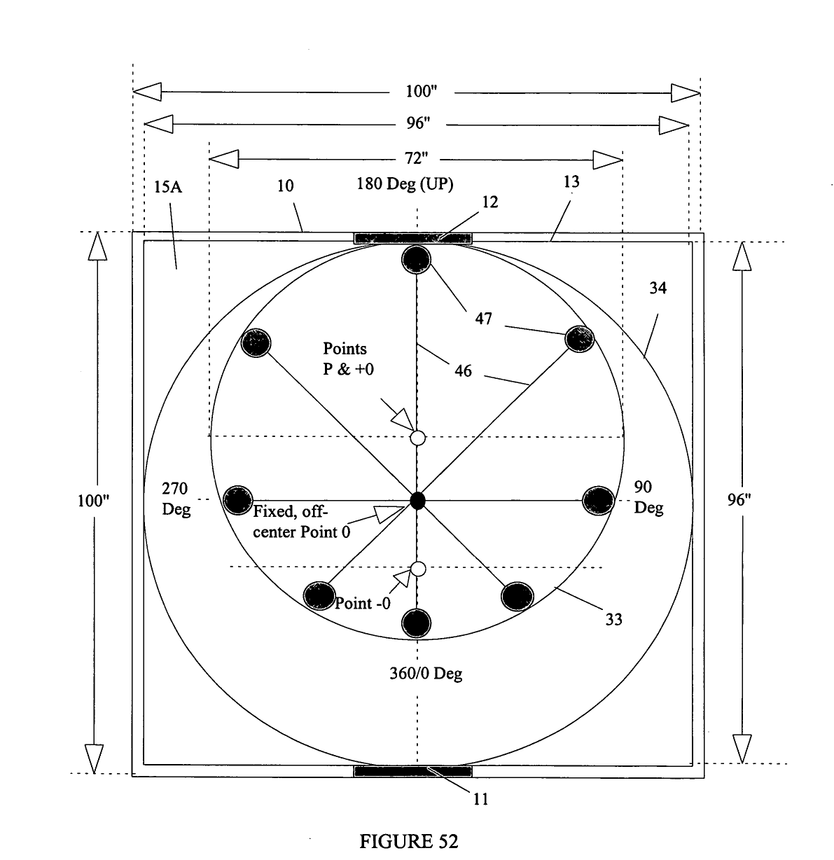

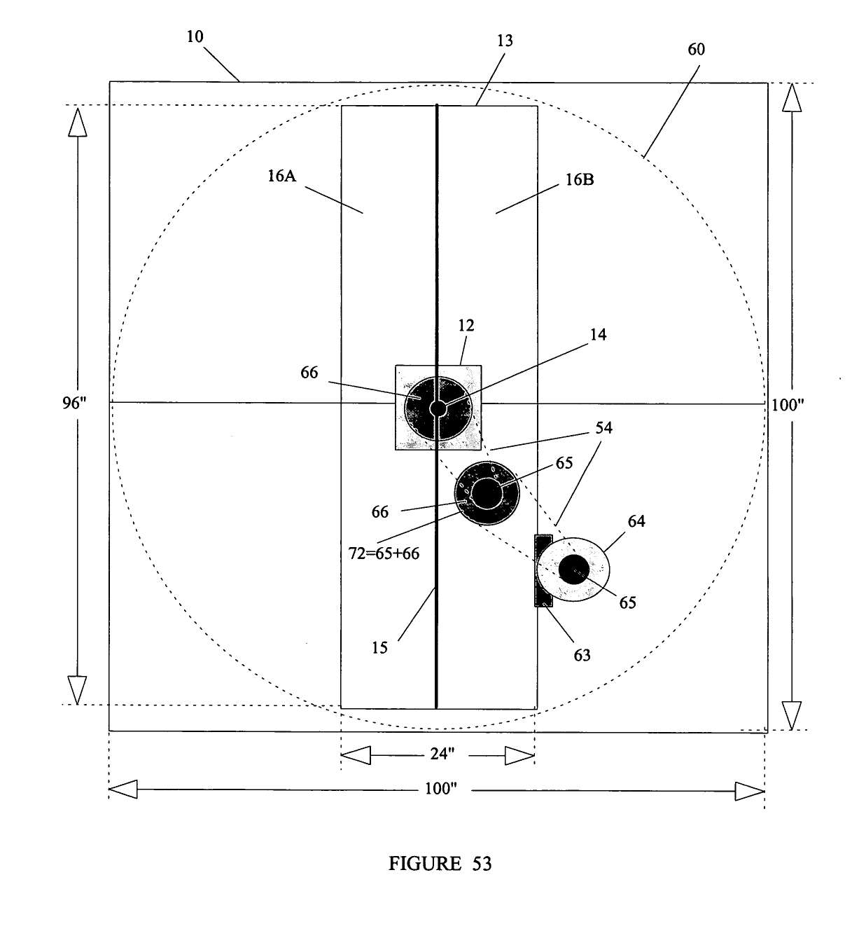

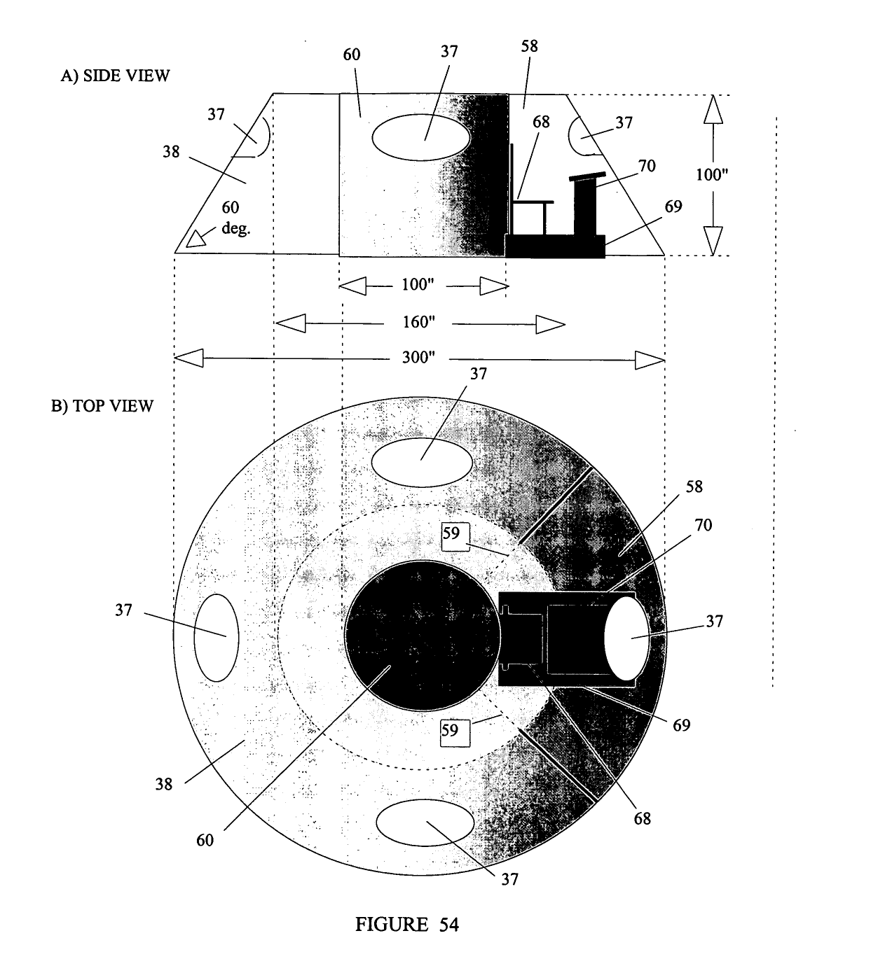

FIG. 10 shows how the fixed 96-inch-diameter outer rim 34 is mounted inscribed onto the inside surfaces of the four rectangular 96×12-inch side-walls of the internal housing frame's right 16A-side (see FIG. 2) in 8 equally-spaced places, as shown in the front-view diagram. The internal housing frame's side-view diagram shows end-views of both the outer rim 34, which is vertically mounted in the middle of the internal housing frame's left 16A-side, and of the 96-inch square central plate 15 (see FIG. 2).

FIG. 11 is a diagram showing the relationship between the fixed outer rim 34 (see FIG. 10), the movable circular inner rim 33 (see FIG. 8) and the set of 8 equally-spaced subassemblies 40. Inner rim 33 is shown here in the “neutral position” (in the center of outer rim 34), in which, as shown in FIG. 9, the 8 subassemblies 40 (each consisting of one slide 46 and one 2-wheel device 47) are all forced to be of equal lengths, rotating at 100 rad/sec about both superimposed point P (the movable inner rim's center) and point 0 (the outer rim's fixed center) inside the vertical plane of the movable circular inner rim 33. The 8 subassemblies 40 are numbered from 1 to 8 for future reference.

FIG. 12 shows another diagram illustrating the relationship between the fixed outer rim 34 (see FIG. 10), the movable circular inner rim 33 (see FIG. 8) and the 8 equally-spaced variable-length (telescoping) subassemblies 40, rotating at 100 rad/sec about the outer rim's fixed, off-center point 0 (with respect to the inner rim's center point P). Here, inner rim 33 is shown in the maximum “active position”, in which it has been vertically moved up by the two-dimension all-way movable mechanism 49 to make contact with the inside surface of outer rim 34 at 180 degrees, thereby forcing the 8 subassemblies 40 to all have different lengths, as functions of their angles of rotation. The 8 subassemblies 40 are also numbered from 1 to 8 for future reference.

FIGS. 13 and 14 show two sets of three diagrams (on the same page), each representing the relationship of the various slide assemblies, plates, inner rims and outer rims (shown in FIGS. 6, 7 and 8) in each mirror-image half of the two-dimension, all-way movable mechanism 49 (respectively mounted on sides 15A and 15B of the central plate). These two figures can be used as reference maps for visually locating the various plates, slide assemblies, inner rims and outer rims in the Machine's two-dimension, movable mechanism 49.

FIG. 15 illustrates the trigonometric relationships between sides a, b and c and angles A, B and C of any triangle. Sides a, b and c respectively represent the variable-length radius R3_{W} (i.e., subassembly 40), the constant-length radius R1_{W} of inner rim 33 and segment R2 (shown between points P and 0). As shown in FIGS. 9, 11 and 12, the subscript (_{W}) is used in both R1_{W} and R3_{W} to indicate that their radial lengths are from points P and 0 respectively to the inside surface of inner rim 33 (see FIG. 8)—on the inside surface of which the two-wheel devices 47 (hereinafter also referred to as W for wheels) run. The angles A, B and C and their opposite sides R3_{W}, R1_{W} and R2 (representing the triangle's sides a, b and c respectively) are used in the derivation of the variable-length radius R3_{W} (see equations A1 through A5), in which R3_{W} is calculated as a function of angle theta0, rotating about the fixed, off-center point 0. In this figure, the variable-length R3_{W}=3.62 ft, for an angle value theta0=135 deg.

FIG. 16 shows two diametrically opposite (antiparallel) variable-length radii R3_{W} of different lengths, along the 0-to-180 degree line through the fixed off-center point 0, when rotating in the maximum “active position” about point 0.

FIG. 17 shows two diametrically opposite (antiparallel) variable-length radii R3_{W} of different lengths, along the 45-to-225 degree line through the fixed off-center point 0, when rotating in the maximum “active position” about point 0.

FIG. 18 shows two diametrically opposite (antiparallel) variable-lengths radii R3_{W} of equal lengths, along the 90-to-270 degree line through the fixed off-center point 0, when rotating in the maximum “active position” about point 0.

FIG. 19 illustrates the constant-length radius R1_{W} of inner rim 33 (with center at point P) and its radius of gyration R1_{br} (with center at point S), running along the dashed circular locus of R1_{br}. Here, both R1_{W} and R1_{br} rotate in the “neutral position” about the fixed point 0, upon which their respective points P and S are superimposed.

FIG. 20 shows the variable-length radius R3_{W} (from the fixed, off-center point 0 to the inside surface of inner rim 33) and its variable-length radius of gyration R3_{br} (from the fixed point 0 to its circular locus, shown as a dashed circle with center at point S and constant-length radius Rₛ). Both R3_{W} and R3_{br} rotate about the fixed point 0 in the maximum “active position”.

FIG. 21 is a graphical representation of the rotational tangential force FT, the radial force FR and the resultant centrifugal force ResF) and their related angles ALF (between FR and ResF), A (which is the direction of FR from point P) and DIRA (which is the direction of ResF from the fixed point 0). All angles and forces shown here are for theta0=40 degrees.

FIG. 22 presents plots of angles ALF, A and DIRA as functions of theta0. Note that the ALF, A and DIRA angle values shown in FIG. 21 can also be found at theta0=40 degrees.

FIG. 23 presents plots of the variable-length radius R3_{W}, for W (running along the inside surface of inner rim 33) and of the variable-length bar's radius of gyration R3_{br}, for slide 46 (running along the dashed circular locus of R3_{br}—see FIG. 20) as functions of theta0. R3_{W} and R3_{br} were obtained with one variable-length subassembly 40 only, rotating about the fixed, off-center point 0. Plots of the constant-length radii R1_{W}, for W, and R1_{br}, for the bar (see FIG. 19), rotating about points P, S and 0, are also shown here for comparison with R3_{W} and R3_{br}.

FIG. 24 presents plots of the variable tangential velocities VT_{W}, for W, (running along the inside surface of inner rim 33), and VT_{br}, for the bar, (running along the locus of its radius of gyration R3_{br}—see FIG. 20), as functions of theta0. VT_{W} and VT_{br} were obtained with one subassembly 40 only, rotating at 100 rad/sec about the fixed, off-center point 0. Plots of the constant tangential velocities VT1_{W}, for W, and VT1_{br}, for the bar, rotating at 100 rad/sec about the inner rim's center, at point P, are also shown here for comparison with VT_{W} and VT_{br}.

FIG. 25 presents a plot of the variable relative angular velocity ω₂, for W, as a function of theta0. The ω₂ plot was obtained with one subassembly 40 only, as if W were rotating about the inner rim's center point P, at the end of R1_{W} (see FIG. 12), with variable tangential velocity VT_{W}, instead of rotating at a constant 100 rad/sec about the fixed, off-center point 0, at the end of R3_{W} with variable tangential velocity VT_{W}. The input constant angular velocity ω₀ plot is shown here for comparison with the variable ω₂ plot.

FIG. 26 presents plots of the average variable tangential acceleration AT_{brav} for the bar, AT_{Wav} for W, and ATₐᵥ for both combined, as functions of theta0. They were obtained with one subassembly 40 only, rotating at 100 rad/sec about the fixed, off-center point 0.

FIG. 27 presents plots of the variable radial accelerations AR_{br} for the bar, AR_{W} for W and AR for both combined, as functions of theta0. They were obtained with one subassembly 40 only, rotating at 100 rad/sec about the fixed, off-center point 0. Their bell shapes depends directly on the tangential velocity plot of VT_{W} in FIG. 24.

FIG. 28 presents plots of the variable resultant accelerations ResA_{br} for the bar, ResA_{W} for W, and ResA for both combined, as functions of theta0. They were obtained with one subassembly 40 only, rotating at 100 rad/sec about the fixed, off-center point 0.

FIG. 29 presents plots of the variable tangential forces FT_{brav} for the bar, FT_{Wav} for W and FTₐᵥ for both combined, as functions of theta0. They were obtained with one subassembly 40 only, rotating at 100 rad/sec about the fixed, off-center point 0 (using the basic force equation F=MA, in which M is the mass of the rotating body in slugs and A is its acceleration in ft/sec²).

FIG. 30 presents plots of the variable radial forces FR_{br} for the bar, FR_{W} for W and FR for both combined, as functions of theta0. They were obtained with one subassembly 40 only, rotating at 100 rad/sec about the fixed, off-center point 0 (using the basic force equation F=MA, in which M is the mass of the rotating body in slugs and A is its acceleration in ft/sec²).

FIG. 31 presents plots of the variable resultant centrifugal forces ResF_{br} for the bar, ResF_{W} for W and ResF for both combined, as functions of theta0. They were obtained with one subassembly 40 only, rotating at 100 rad/sec about the fixed, off-center point 0 (also using equation F=MA).

FIG. 32 is a graphical representation of the 8 different centrifugal forces generated by the 8 equally-spaced, variable-length subassemblies 40 shown in FIG. 12, acting simultaneously at the fixed, off-center point 0, about which the 8 subassemblies 40 rotate at 100 rad/sec. These 8 forces can be found in the plot of FIG. 31, 45 degrees apart, starting at theta0=0 degree.

FIG. 33 is a graphical representation of the combined use of the triangle and the polygon methods for vectorially combining the 8 forces shown in FIG. 32 into a single resultant centrifugal force vector ResF of 1,989.4 lbs, in the direction of 180 degrees (from the fixed, off-center point 0 to the head of the 8th vector), shown as a heavy black arrow closing the polygon.

FIG. 34 is a plot of 10 SOUCVOL-calculated resultant forces (ResF), obtained for the same set of 8 subassemblies 40 shown in FIG. 12, rotating about the fixed, off-center point 0 at 100 rad/sec. They were obtained at every 5-degree starting position of the #1 subassembly 40 (see FIG. 12) from 0 degree to 45 degrees. The 10 calculated ResF values in this plot were also obtained with the combined use of the triangle and the polygon methods shown in FIG. 33. The other constant plot represents the average ResF plot of 1,989.46 lbs for the 10 calculated ResF values shown between 1,989.39 lbs and 1,989.54 lbs (for one Machine mirror-image half only).

FIG. 35 shows another plot of resultant centrifugal force (ResF) results versus angular velocity, generated by one Machine mirror-image half only, using the same set of 8 variable-length subassemblies 40 shown in FIG. 12. These ResF values are plotted every 25 rad/sec, from 0 rad/sec to 350 rad/sec. In the upper left corner of this figure, a small table shows the rpm and ResF values associated with each indicated angular velocity, along with two equations to obtain the rpm and the ResF values for any given angular velocity.

FIG. 36 shows three plots of resultant centrifugal force (ResF) results as functions of 6, 8 and 10 identical, equally-spaced variable-length subassemblies 40, rotating at 100 rad/sec in each Machine mirror-image half. The IX plot represents the 6, 8 and 10 subassemblies 40 cases, run with one slide 46 (the bar) and one 2-wheel device 47 (W) weighing 1 lb each, a fixed outer rim's radius R0=4 ft and a movable inner rim's radius R1=3 ft. The 2X and 3X plots are for the other two cases run with 2 and 3 times the above weights and radii lengths.

FIG. 37 presents plots of three constant rotational kinetic energy (KE) results, KE0_{br} for the bar, KE0_{W} for W and KE0 for both combined, as functions of theta0. They were obtained with one subassembly 40 only, rotating at 100 rad/sec about both superimposed points P and 0 in the “neutral position” (see FIGS. 11 and 19).

FIG. 38 shows plots of three variable rotational KE results, KE1_{br} for the bar, KE1_{W} for W and KE1 for both combined, as functions of theta0. They were obtained with one subassembly 40 only, rotating at 100 rad/sec about the fixed, off-center point 0 (relative to the of the inner rim's center point P) in the maximum “active position” (see FIGS. 12 and 20).

FIG. 39 is a graphical representation of the 8 rotational KE1 results, shown 45 degrees apart (obtained from FIG. 38—with subassembly #1 at 0 degree on inner rim 33). They were generated simultaneously by the 8 variable-length subassemblies 40 shown in FIG. 12, rotating counterclockwise at 100 rad/sec about the fixed, off-center point 0.

FIG. 40 presents both a constant KE2 plot (obtained from the KE0 lot of FIG. 37) and a variable KE3 plot (obtained from the KE1 plot of FIGS. 38—and/or from FIG. 39) as functions of the cumulative number of identical, equally-spaced, variable-length subassemblies 40 (from 1 to 8, as shown in FIG. 12), rotating at 100 rad/sec about the fixed, off-center point 0. Both the KE2 and KE3 plots respectively represent the 8 cumulatively-added KE0 and KE1 plotted results, obtained every 45 degrees apart from FIG. 37 (for the “neutral position”) and from FIG. 38 (for the “active position”). Note that both the KE2 and KE3 plots are different for the 1 to 7 cumulatively-added KE values, but that both plots end up with the same total cumulative KE values of 14,918.9 ft*lbs when their respective 8th KE values are added.

FIG. 41 shows five acceleration plots versus vertical “near-earth” altitude, from 0 miles up to 250.0 miles, in the direction of the moon. Three of these plots represent the three cubic TDMM craft accelerations (A_{cc}), respectively obtained with the three Machine angular velocities (ω) of 50, 75 and 100 rad/sec. The other two plots represent the moon's positive acceleration of gravity (gₘ) and the earth's negative acceleration of gravity (gₑ), acting simultaneously on the three cubic craft A_{cc} plots as functions of “near earth” vertical altitude from earth.

FIG. 42 presents five plots of force versus vertical “near-earth” altitude, from 0 miles up to 250.0 miles, in the direction of the moon. Three of these plots represent the three cubic TDMM craft motive forces (F_{cc}), respectively obtained with the three Machine angular velocities (ω) of 50, 75 and 100 rad/sec. The other two plots represent the moon's positive gravitational force (Fₘ) and the earth's negative gravitational force (Fₑ), acting simultaneously on the three cubic craft motive force F_{cc} plots as functions of “near earth” altitude from earth.

FIG. 43 shows three plots of cubic TDMM craft velocity (V_{cc}) versus “near-earth” altitude from earth, from 0 mile up to 250.0 miles, in the direction of the moon. They represent the instantaneous cubic TDMM craft velocities obtained with the three Machine angular velocities (ω) of 50, 75 and 100 rad/sec respectively.

FIG. 44 shows three plots of cubic TDMM craft average flight time (T_{cc}) from earth launch time (at 0 sec) versus “near-earth” altitude from earth, from 0 mile up to 250.0 miles, in the direction of the moon. They were obtained with the three Machine angular velocities (ω) of 50, 75 and 100 rad/sec respectively.

FIG. 45 shows five acceleration plots versus “far-earth” distance from earth, from 0 miles all the way to the moon, 230,000.0 miles away. Three of these plots represent the three cubic TDMM craft accelerations (A_{cc}), respectively obtained with the three Machine angular velocities (ω) of 50, 75 and 100 rad/sec. The other two plots represent the moon's positive acceleration of gravity (gₘ) and the earth's negative acceleration of gravity (gₑ), acting simultaneously on the three cubic TDMM craft A_{cc} plots as functions of “far-earth” distance from earth.

FIG. 46 presents five plots of force versus “far-earth” distance from earth, from 0 miles all the way to the moon, 230,000.0 miles away. Three of the plots represent the three cubic TDMM craft motive forces (F_{cc}), respectively obtained with the three Machine angular velocities (ω) of 50, 75 and 100 rad/sec. The other two plots show the effects of the moon's positive force (Fₘ) and the earth's negative force (Fₑ), acting simultaneously on the above three cubic TDMM craft F_{cc} plots as functions of “far-earth” distance from earth.

FIG. 47 shows three plots of cubic TDMM craft velocity (V_{cc}) versus “far-earth” distance from earth, from 0 miles all the way to the moon, 230,000.0 miles away. They represent the instantaneous cubic TDMM craft velocities obtained with the three Machine angular velocities (ω) of 50, 75 and 100 rad/sec respectively.

FIG. 48 shows three plots of cubic TDMM craft average flight time (T_{cc}) from earth launch time (at 0 sec) versus vertical “far-earth” distance from earth, from 0 miles all the way to the moon, 230,000.0 miles away. They were obtained with the three Machine angular velocities (ω) of 50, 75 and 100 rad/sec respectively.

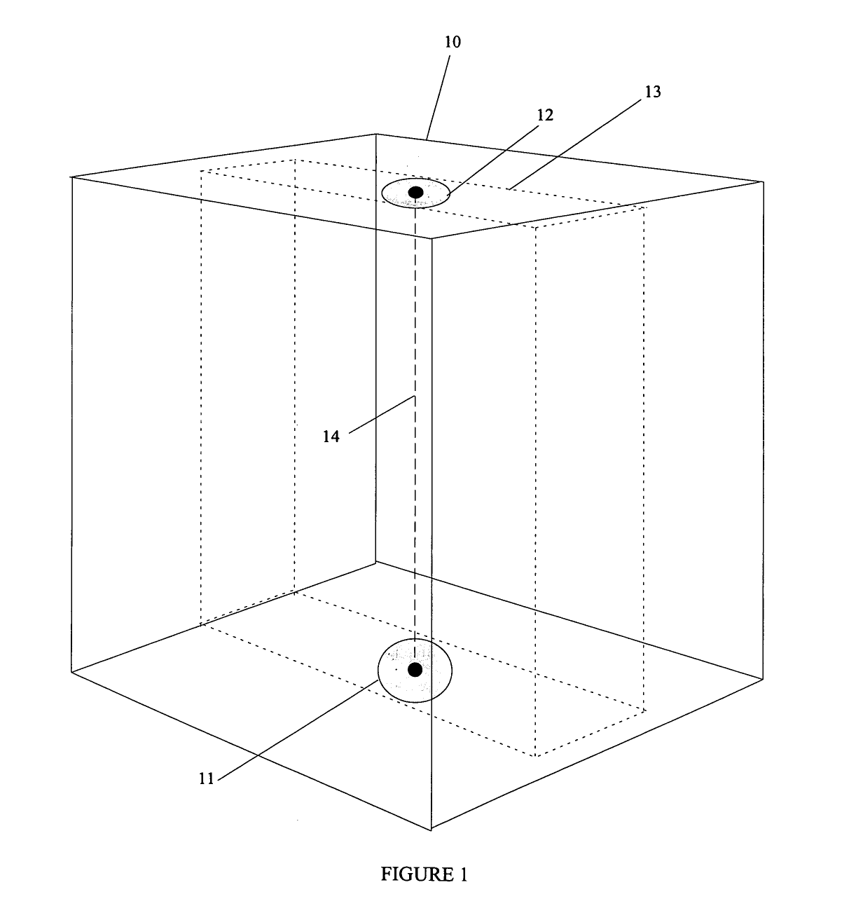

FIG. 49 shows diagrams of an 11-inch square heavy-duty swivel and of three different sprockets 66, 53 and 52, with 60, 40 and 20 teeth respectively. These sprockets are variously used with motors and chains in the swivel-and-sprocket assemblies 11 and 12 (see FIG. 51) and in the idler subassembly 72 (see FIG. 53), for horizontally-rotating the internal housing frame 13 (see FIGS. 1, 2), and for providing rotation to the Machine's two sets of 8 subassemblies 40 (see FIGS. 11, 12, 50 and 51).

FIG. 50 presents a cross-sectional diagram of the right Machine mirror-image half (which is enclosed in the right 16B half side of the internal housing frame 13), along with front and side-view diagrams of the heavy-duty, high-speed hub 44 (which comes with two tapered ball-bearings) and a side view of the stub axle 45. Stub axle 45 is used as the fixed axis, about which the hub 44, the circular 16-inch radius metal disk 31 (see FIG. 9) and the set of 8 telescoping subassemblies 40 rotate together as one unit. This figure also shows the relationship between the upper part of the circular inner rim 35 (making contact with the inside surface of outer rim 36), the set of 8 telescoping subassemblies 40, rotating about the fixed stub axle 45 (which is shown mounted in line with the fixed center point 0) and the ½ hp, 1800 rpm electric motor 51 and its motor mount 57 (which are mounted on the square 96×96-inch 16A-side-wall of the internal housing frame 13 as shown). The 20-tooth sprocket 52 of motor 51 provides rotation to the coupled 40-tooth sprocket 53 and the set of 8 subassemblies 40 by means of a #35 chain 54 (which goes around both sprockets 52 and 53).

FIG. 51 consists of two parts, A and B. The upper part A shows a cross-sectional cut-away view diagram of the entire cubic TDMM craft, illustrating the relationship between the external cubic frame 10, the internal housing frame 13 and the two Machine mirror-image halves, separated by the central square plate 15. Also shown in part A are the two motors 51, which (as shown in FIG. 50) provide counter-rotation to the two sets of 8 subassemblies 40, and the other two motors 64 which, via sprockets, chains and swivel-and-sprocket assemblies 11 and 12, provide horizontal counter-rotations to both the internal housing frame 13 and to the external cubic frame 10. A power and control unit (P/CU) 67 is also shown mounted in the center of the lower left outside of the internal housing frame's 16A side. The lower part B of FIG. 51 shows two side-view halves of the swivel-and-sprocket assemblies 12 and 11 respectively, and how they are both mounted sandwiched between the bottom and top centers of both the external cubic frame 10 and the internal housing frame 13.

FIG. 52 shows a diagram of the cross-sectional side-view of the left Machine mirror-image half (mounted in the 16A-side of the internal housing frame 13), showing the relationship between the external cubic frame 10, the internal housing frame 13, the bottom and top swivel-and-sprocket assemblies 11 and 12, the fixed outer rim 34, the movable circular inner rim 33 (shown in the maximum “active position”, making contact with the inside surface of outer rim 34 at 180 degrees) and the set of 8 variable-length subassemblies 40, rotating at 100 rad/sec about the fixed off-center point 0 (relative to the movable inner rim's center point P).

FIG. 53 is a top-view diagram of the cubic TDMM craft, showing the relationship between the external cubic frame 10, the alternate cylindrical frame 60 (shown as a 100-inch-diameter dashed circle for use in FIG. 54), the internal housing frame 13 (which encloses the Machine) and the central square plate 15 (separating the internal housing frame 13 into two half sides 16A and 16B). It also illustrates the top two-stage rpm-reducing arrangement that is used for reducing the 1800 rpm of motor 64 down to 32 rpm at the swivel assembly 12—which, being coupled to the internal housing frame 13, also causes the said internal housing frame 13 to rotate horizontally with it at 32 rpm inside the external cubic frame 10. The two-stage rpm-reducing arrangement consists of motor 64 and its 8-tooth sprocket 65 (which, as shown in FIG. 51, is secured onto the upper outside of the internal housing frame 13 with motor mount 63), of idler subassembly 72 (which consists of a pair of free-wheeling sprockets 65 and 66, secured together as one unit), mounted on top of the internal housing frame 13 as shown, of the top swivel assembly 12 and its coupled 60-tooth sprocket 66 (see part B of FIG. 51) and of the two #35 chains 54.

FIG. 54 is a diagram of an application of the invention, depicting a “flying saucer”. The alternate internal cylindrical frame 60, which is first shown in FIGS. 2 and 53 (looking like a dashed circle) is shown here looking like a square in the upper part A side-view diagram and looking like a circle in the lower part B top-view diagram. In this figure, the cubic craft's built-in TDMM has been adapted to drive this conceptual reduction of the invention to practice.

### DESCRIPTION OF THE PREFERRED EMBODIMENT

A preferred reduction to practice, the best mode of practicing the invention within the bounds of known engineering arts, is illustrated FIG. 1. The wingless and tailless cubic air and space craft with a built-in Three Dimension Motive Machine (TDMM), herein simply referred to as the cubic TDMM craft, basically consists of three separate functional parts, namely:
1) an external 100-inch cubic framework 10,
2) a 96×96×24-inch internal parallelepiped housing framework 13 (which is sized to fit and freely rotate inside the larger external cubic frame 10) and
3) a variable centrifugal force motive machine mechanism (the Machine), which is enclosed inside (2) above.

The physical dimensions mentioned in (1) and (2) above are arbitrary but relative to each other and are a function of both the size and power output desired of the cubic TDMM craft invention.

To demonstrate the preferred embodiment of the invention, the Machine is enclosed inside the internal housing frame 13, which can be oriented towards any chosen horizontal direction (azimuth), relative to the external cubic frame 10, by rotating it about a central, vertical axis 14, which, as shown in FIG. 1, runs between the centers of the two swivel-and-sprocket assemblies 11 and 12. As also shown in FIGS. 51 and 52, the two swivel assemblies 11 and 12 are sandwiched between the centers of the bottom and top sides of both the external cubic frame 10 and the internal housing frame 13, supporting and rotating the internal housing frame 13 (and its enclosed Machine) inside the larger external cubic frame 10 (see FIG. 51).

The external 100-inch cubic frame 10 represents the wingless and tailless outer body of the cubic TDMM craft, which is sized to accommodate the dimensions of the smaller rotating internal housing frame 13 (see FIGS. 1 and 2). The external cubic frame 10 is also used in the cubic craft as a variably counter-rotating part to balance out the opposite rotating action of the internal housing frame 13, in order to obtain a true horizontal orientation (azimuth) for the internal housing frame 13 (and its enclosed Machine).

The Machine (which is housed in the internal housing frame 13) is divided into two identical mirror-image halves, separated by a 96-inch square central plate 15, which is itself aligned on the central vertical axis 14 (see FIGS. 1, 2 and 51). Each Machine mirror-image half consists of two separate functional parts, working together as one unit in the vertical plane of internal housing frame 13, namely:
1) a two-dimension, all-way movable mechanism 49 (made up of parts shown in FIGS. 6, 7 and 8) and
2) a set of 8 variable-length subassemblies 40, rotating about a common, fixed axis, at point 0 (see FIGS. 11 and 12).

Each Machine mirror-image half occupies an opposite 96×96×12-inch half side of the internal housing frame 13, respectively referred to as sides 16A on the left and 16B on the right, separated by the 96×96-inch square central plate 15 (see FIG. 2), as dictated by the arbitrary size selected for the exemplary Machine.

The most important part used in both (1) and (2) above is shown in FIGS. 3, 4 and 5, which respectively show three schematic diagrams of the commercially-available telescoping full extension slide 46 in the “closed”, “opened” and “closed end-view” positions on the same page. Slide 46 (which is made of heavy-duty steel with steel ball bearings and a 100-lb load rating when fully extended to 48 inches) consists of three sections of equal lengths but different widths, respectively numbered 41, 42 and 43. Section 41, which is the widest of the three sections, is the fixed (non-movable) part of the slide, which is directly mountable onto any flat surface with two bolts 24 and nuts 23 through two ¼-inch mounting holes 19 (see FIGS. 6, 7, 8 and 9). The second section 42 slides back and forth, on electro-plated steel ball bearings 48, half-way inside the fixed section 41 and the third section 43 also slides back and forth, also on electro-plated ball bearings 48, half-way inside section 42. As a result, the combined, all-ball bearing, half-way progressive sliding actions of both sections 42 and 43 enables section 43 to slide back and forth the entire 24-inch length of the fixed section 41—thereby causing the telescoping, full extension slide 46 to extend to any desired length, from a closed length of 24 inches up to a maximum opened length of 48 inches.

Identical slides 46 are used in both the two-dimension, all-way movable mechanism 49 (comprised of parts shown in FIGS. 6, 7 and 8) and in the two sets of 8 counter-rotating variable-length subassemblies 40 (one set of which is shown in FIG. 12 for example). Both the two-dimension movable mechanism 49 and the two sets of 8 subassemblies 40 comprise the cubic TDMM craft's Machine mechanism. As shown in FIG. 9, each subassembly 40 consists of one telescoping bar (slide 46) and of one two-wheel device 47 (which is herein also referred to as W for wheels). Because slide 46 can be extended from a closed 24 inches up to a fully opened 48 inches, it enables both the two-dimension all-way mechanism 49 and the two rotating sets of eight variable-length subassemblies 40, working together as one integrated unit in the Machine, to give the cubic TDMM craft far greater motive power, performance and maneuverability than any of the other related inventions (see the “Discussion Of The Related Arts” section) are capable of achieving with their various means and mechanical devices described in the “Background Of The Invention” section. That is the reason why, the above-mentioned uses of the telescoping (variable-length) full extension slide 46 in the Machine mechanism makes it the most important component part of the cubic TDMM craft invention.

For example, slide 46 enables the two-dimension, all-way movable mechanism 49 to move both circular inner rims 33 and 35 to any position within the vertical, two-dimensional planes of outer rims 34 and 36 (see FIGS. 13 and 14 for reference)—thereby making it possible for the two sets of 8 subassemblies 40 (counter-rotating inside the vertical planes of their respective inner rims 33 and 35) to generate together any variable amount of outwardly-directed, single resultant centrifugal force (ResF) in any desired direction inside the vertical planes of both circular inner rims. This is accomplished in the two-dimension, all-way movable mechanism 49, by incorporating slides 46 in pairs, mounted end to end (one “closed” and one “opened”) to form one slide assembly, in which the two slides 46 alternately slide back and forth together. As shown in FIGS. 6, 7 and 8, these pairs of slide assemblies are used in the two-dimension, all-way movable mechanism 49 for variably moving plates 25 and 26 vertically and plates 29 and 30 (and their associated inner rims 33 and 35) horizontally on both sides of the central square plate 15 (see also FIGS. 13 and 14).

The central square plate's two sides, 15A and 15B (see FIG. 2), are used for mounting, in mirror-image reversed order, all the various parts comprising the two-dimension, all-way movable mechanism 49 (see FIGS. 6, 7, 8, 13 and 14), which is used for moving inner rims 33 and 35 anywhere inside the vertical, circular plane of their respective fixed outer rims 34 and 36. These outer rims act as fixed circular boundaries for the movable inner rims which, in turn, act as circular tracks for the 2-wheel devices 47 (W), which are mounted at the ends of the two sets of 8 counter-rotating, variable-length subassemblies 40 (see FIGS. 9, 11 and 12).

However, to simplify the following, more complete description of the exemplary embodiment of the invention, only the left side of the mirror-image half of the Machine mechanism (which is mounted on the 15A-side of the square central plate 15) is described next—because, since each Machine half is a mirror-image of the other half, an explanation of one half is applicable to the other half.

To begin with, FIG. 6 presents a front-view diagram of the left 15A-side of the fixed 96-inch square central plate 15 with center at the fixed point 0 (see FIG. 2, which shows a top-side view of the square central plate 15 and its two opposite sides 15A and 15B). In this figure, the two pairs of vertical slide assemblies 21L (on the left side) and 21R (on the right side) are secured in parallel, with their four non-movable sections 41 mounted directly onto the central plate's 15A-side by any fastening means (such as bolts 24 and nuts 23 through mounting holes 19, as shown). Another pair of identical vertical slide assemblies 22L and 22R are similarly secured in parallel onto the central plate's opposite 15B-side (see FIG. 14).

FIG. 7 illustrates how the vertically-movable plate 25 (shown in the center of the central 96×96-inch square plate's 15A side) is mounted directly on top of the four movable sections 43 (see FIGS. 3 and 4) of the two vertically-movable pairs of slide assemblies 21L and 21R shown in FIG. 6. Slide assemblies 21L an 21R are used for variably moving plate 25 vertically up or down, thereby allowing the center of plate 25 to be moved up and down by as much as 12 inches from the fixed point 0 along the vertical 0 line to any position between and on the two (+0) and (−0) horizontal lines. Two more pairs of slide assemblies 27U (on the up side) and 27D (on the down side) are horizontally-mounted as shown onto the opposite side of plate 25 (facing out, away from the central plate's 15A-side), such that the four end-holes 19 of their fixed sections 41 (see FIG. 4) are aligned with the four end-holes 19 of the fixed sections 41 of slide assemblies 21L and 21R on the other side of plate 25 facing the central square plate 15—thereby making it possible to secure the four slide assemblies to plate 25 with bolts and nuts through their end-holes 19. A similar arrangement of a vertically-movable plate 26, secured on top of vertical slide assemblies 22L and 22R, with a pair of horizontal slide assemblies 28U and 28D mounted on its opposite side (away from the central square plate 15) is also mounted on the central plate's 15B-side (see FIG. 14).

FIG. 8 shows how the 72-inch square plate 29 is secured onto the four movable sections 43 of the two horizontal slide assemblies 27U and 27D (shown in FIG. 7) with bolts 24 and nuts 23. Slide assemblies 27U and 27D are used for variably moving plate 29 horizontally left or right, thereby allowing the center point P of plate 29 to be moved by up to 12 inches from the fixed point 0 to any position between and on the two (+0) and (−0) vertical lines. A 72-inch-diameter circular inner rim 33 is also secured directly onto the opposite side of the horizontally-moving plate 29 facing out (away from the central plate's 15A-side), inscribed inside the plate's four sides as shown. Thus, by combining the variable vertical motion of plate 25 with the variable horizontal motion of plate 29, the circular inner rim 33 can be moved anywhere inside the vertical, circular plane of the fixed outer rim 34 (shown inscribed inside the four sides of the square central plate's 15A-side). A second identical inner rim 35 is also similarly mounted on the opposite side of the horizontally-moving plate 30, on the central plate's 15B-side (see FIG. 14).

The above-described vertically-moving slide assemblies 21L, 21R and plate 25 and the horizontally-moving slide assemblies 27U, 27D and plate 29 (with inner rim 33 mounted on its opposite side, facing away from the central square plate 15) make up the left mirror-image half of the two-dimension, all-way movable mechanism 49, which is mounted on the central plate's 15A-side. Similarly, as shown in FIG. 14, the vertically-moving slide assemblies 22L, 22R and plate 26 and the horizontally-moving slide assemblies 28U, 28D and plate 30 (see FIG. 14), with inner rim 35 mounted on its opposite side, constitute the right mirror-image half of the two-dimension, all-way movable mechanism 49, mounted on the central plate's other 15B-side.

Both pairs of vertically-movable plates 25 and 26 and horizontally-movable plates 29 and 30 (see FIGS. 13 and 14) are each connected (i.e., coupled together) in a manner consistent with acceptable engineering practice, so that both pairs of coupled plates can respectively be simultaneously, independently and variably moved vertically and horizontally. As a result, the combined vertical motions of the coupled plates 25 and 26 with the horizontal motions of the coupled plates 29 and 30 enables the two-dimension, all-way movable mechanism 49:
1) to move both inner rims 33 and 35 together, from their “neutral position” (in which, as shown in the example of FIG. 11, the 8 rotating subassemblies 40 are all of equal lengths) to any other position between their “neutral position” and their maximum “active position” (in which, as shown in the example of FIG. 12, the same 8 rotating subassemblies 40 now all have different lengths, as functions of their angles of rotation), and
2) to cause the two sets of 8 variable-length subassemblies 40, counter-rotating in the “active position” in the vertical planes of their respective inner rims, to each generate 8 different centrifugal forces (see F_{c} equation A1), as functions of both their different lengths and angles of rotation (see FIG. 32).

When the 8 subassemblies 40 mentioned in (2) above are rotating in the maximum “active position” in each Machine mirror-image half, they each successively achieve their maximum radial lengths in the direction in which their movable inner rim is making contact with the inside surface of their associated outer rim (which act as fixed circular boundary for the inner rim). Also, as illustrated in FIG. 32, the 8 different F_{c} centrifugal forces mentioned in (2) above (which are simultaneously generated in each inner rim's vertical plane) automatically vectorially combine (see the polygon of FIG. 33) into a single, outwardly-directed maximum resultant centrifugal force (ResF) of 1,989.4 lbs (which always points in the same direction in which the inner rim is making contact with the inside surface of its associated outer rim)—and, since there are two counter-rotating sets of 8 subassemblies 40 in the Machine, then the total maximum ResF generated doubles to 3,978.8 lbs.

Finally, by combining the selected directions of the above-mentioned total maximum ResF with the chosen direction (azimuth) of the internal housing frame 13 (and its enclosed Machine) which, as shown in FIGS. 1, 2, and 53, can be horizontally rotated inside the external cubic frame 10 in either direction about its vertical central axis 14, a powerful, steerable and variable centrifugal motive force is then available to smoothly propel the cubic TDMM craft (or any other water, air and outer space craft type) with spectacular performance (see FIGS. 41 through 48 and the “Discussion Of The Cubic TDMM Craft Performance Results” section) and maneuverability in three dimensions, anywhere on earth and in outer space.

The identical telescoping (variable-length) slides 46 used in both the slide assemblies of the two-dimension, all-way movable mechanism 49 and the two counter-rotating sets of 8 subassemblies 40 may be of any desired form and design consistent with acceptable engineering practice. For example, the pair of slide assemblies 21L and 22R and the other pair of slide assemblies 21R and 22L (see FIGS. 13 and 14), which are respectively mounted on opposite sides of the central square plate 15, may instead be combined into two slide assemblies 21 and 22, which would be located within open slots in the central square plate 15 and be adapted to support and to simultaneously vertically move both plates 25 and 26 together to any position on opposite sides of the central plate 15. Furthermore, the central square plate 15 may itself be replaced by a lighter, square central framework 15 of the same size, upon which the above-mentioned single slide assemblies 21 and 22 and their associated vertically-movable plates 25 and 26 may be properly mounted. However, in the exemplary cubic TDMM craft invention described herein, all the slides assemblies used in the Machine each consists of a pair of commercially available telescoping full extension slides 46—similar to the one illustrated in FIGS. 3, 4 and 5.

The 8 identical, equally-spaced, variable-length subassemblies 40 in the Machine's left mirror-image half are shown in FIG. 11 rotating about both superimposed points P and 0 in the “neutral position” (in which inner rim 33 is in the center of fixed outer rim 34—thereby causing the lengths of the 8 subassemblies 40 to all be equal to the inner rim's radius R1_{W}) and are shown in FIG. 12 rotating about the fixed, off-center point 0 in the maximum “active position” (in which inner rim 33 is making contact with outer rim 34 at 180 degrees—thereby causing the lengths of the same 8 subassemblies 40 to all be different). In both FIGS. 11 and 12, the 8 subassemblies all look very much like the spokes of a wheel, radiating from point 0.

As best shown in FIG. 9, each identical, variable-length subassembly 40 consists of one bar (telescoping full extension slide 46) and of one 2-wheel device 47 (also referred to as W for wheels). Each slide 46 has the 2-wheel device 47 mounted onto the end of its moving section 43 and has its fixed section 41 secured directly onto a circular metal disk 31, which is itself mounted onto a high-speed hub 44 with four lug bolts 39 on a 4-inch circle (see FIG. 50). Therefore, the set of 8 subassemblies 40, the metal disk 31 and the hub 44 all rotate together as one unit about the 2000-lb capacity stub axle 45 which, as shown in FIG. 50, is mounted onto the right 16B-side square end-wall of the internal housing 13, perpendicular to the vertical plane of the central plane 15 and axially aligned with the central plate's fixed center at point 0.

In the full side-view diagram of the exemplary cubic TDMM craft shown in FIG. 51 (in which one Machine mirror-image half is shown mounted on each side of the central square plate 15), the 8 variable-length subassemblies 40 in each Machine mirror-image half continuously change their radial length R3_{W} (see FIGS. 12 and 23), from a fully closed minimum of 24 inches up to a fully opened maximum 48 inches and vice versa, as they rotate in the maximum “active position” inside the vertical plane of its movable inner rim. As a result, the outwardly-directed centrifugal force generated by each rotating subassembly 40 causes it to extend its variable length from its fixed point 0 and to force the 2-wheel device 47 (at its movable end) to make contact with the inside surface of its movable inner rim 33 and to push against it with a resultant centrifugal force ResF as a function of its angle of rotation theta0 (see FIGS. 31 and 32).

FIG. 11 shows movable inner rim 33 in the “neutral position” (in the center of the larger outer rim 34), with its center point P superimposed on the fixed outer rim's center point 0. In this “neutral position” the lengths of the 8 variable-length subassemblies 40, rotating about both superimposed points P and 0, are all equal to the length of the inner rim's radius R1_{W}=3 ft in the exemplary apparatus. On the other hand, as shown in FIGS. 12 and 15 through 18, when inner rim 33 is moved its maximum allowable distance from its “neutral position” in any direction to make contact with the inside surface of outer rim 34 (shown here to arbitrarily be at 180 degrees), then inner rim 33 is now in the maximum “active position”, in which its center point P is now separated from the outer rim's fixed, off-center point 0 by a distance R2=(R0−R1_{W})=1 ft.

FIG. 12 also shows that when the 8 variable-length subassemblies 40 rotate in the maximum “active position” they successively achieve their maximum length of 48 inches at 180 degrees, and their minimum length of 24 inches at 360/0 degrees on the inside surface of outer rim 34 respectively. Although the movable inner rim 33 is arbitrarily shown to make contact with outer rim 34 at 180 degrees, the contact point could just as easily have been at 225 degrees, or 315 degrees, and the 8 subassemblies' different lengths would still be the same as they were at 180 degrees (but relative to the new selected contact point)—with the 8 rotating subassemblies 40 achieving their maximum lengths of 48 inches at that new contact point between the two rims.

To more fully understand the concept of using rotational centrifugal force as a motive force, let's look at the equation for centrifugal force (which is the reaction against centripetal force), namely:
F_{c}=Mω²R (1)
in which: F_{c}=centrifugal force, lbs
   M=mass of one rotating body, slugs,
   ω=angular velocity, rad/sec, and
   R=radius, ft.

Equation (1) above basically says that, if M and ω are both constant parameters (see Table 1), then F_{c} varies in direct proportion to R—or F_{c} increases as R increases and vice versa. However, as shown in FIG. 9, since each rotating variable-length subassembly 40 used in the Machine consists of two separate parts (namely: a telescoping slide 46 and a 2-wheel device 47, also referred to as W), each with a different variable-length radius R (which both continually vary as they rotate in the “active position” about the fixed point 0), the two different slide 46 and W radial lengths must therefore first be calculated separately, in order to later be able to calculate their associated rotational velocities, forces, . . . etc . . . , and combine them for each subassembly 40.

Therefore, in order to identify the separate equations for the bar (slide 46) and for W, it is necessary to use the subscripts “_{br}” and “_{W}” respectively—because, as shown in FIG. 20, the mass of W (mass_{W}) runs on the inside surface of inner rim 33 (at the telescoping end of the bar) while the mass of the bar (mass_{br}) runs along the locus of its radius of gyration R3_{br} (which is the bar's radial distance from its axis of rotation to where its mass, mass_{br}, is concentrated without altering its moment of inertia I_{br} (see equation A7). For example, in the “neutral position” case (see figures 11 and 19), the two constant-length radii are respectively identified as R1_{br} for the bar's radius of gyration and as R1_{W} for W (at the end of the bar's radius) and, likewise, in the “active position” case (see FIGS. 12 and 20), the two variable-length radii are identified as R3_{br} for the bar's radius of gyration and R3_{W} for W. Thus, using equations A5 and A8, the variable-length radii R3_{W} and R3_{br} results are first obtained separately as functions of theta0 (see FIG. 23) and are then used in equations B1a through B8c to obtain all the other cubic TDMM's various performance results (such as velocities, centrifugal forces, . . . etc . . . , for the bar and for W as functions of theta0, which are then combined for the entire subassembly 40 (see FIGS. 24 through 31, where they are shown as functions of the angle of rotation theta0). All the above-mentioned equations derived for the bar and W are respectively presented in both the Derivation Of The Variable-Length Radius R3_{W} Equation in part A and the Derivation Of The Ten Basic Rotational Equations in part B—see pages 34 through 37.

FIG. 19 shows the constant-length radii R1_{W} for W and R1_{br} for the bar, both rotating in the “neutral position” about the superimposed points P and 0, and the bar's circular locus of R1_{br} (shown as a dashed circle with constant-length radius Rₛ=1.732 ft, superimposed on R1_{br}).

FIG. 20 shows the variable-length radii R3_{W} for W and R3_{br} for the bar, both rotating in the “active position” about the fixed, off-center point 0 only, and the bar's circular locus of R3_{br}, shown as a dashed circle with constant-length radius Rₛ and center at point S. Unlike in FIG. 19, FIG. 20 shows that the constant-length radius Rₛ and the variable-length radius R3_{br} are separate and unequal, except at 100 and 260 degrees, where they are both equal to 1.732 ft respectively (see FIG. 23, in which plots of R3_{W} for W and R3_{br} for the bar are also shown as functions of the angle of rotation theta0, along with the plots for R1_{W} for W and R1_{br} for the bar, shown here for comparison with R3_{W} and R3).

To assist in the derivation of the variable-length radius R3_{W} equation, an additional line segment R2 (see FIGS. 15 through 18) has been introduced between the center of outer rim 34, at the fixed point 0 (which is also the center of the central plate 15) and the center of the movable inner rim 33, at point P (along a line from point 0 to the point of contact of inner rim 33 with outer rim 34). In these figures, R2 is shown as a heavy black line, representing the difference between the constant-length radius R0 of the fixed, circular outer rim 34 (which is also the maximum achievable variable-length R3_{W}) and the constant-length radius R1_{W} of the movable circular inner rim 33—which is shown making contact with outer rim 34 at the arbitrarily chosen 180 degrees. Therefore, in FIGS. 15 through 18, since the outer rim's constant-length radius R0=4 ft and the inner rim's constant-length R1_{W}=3 ft (see Table 1), then R2=(R0−R1_{W})=(R3_{W}−R1_{W})=(4 ft−3 ft)=1 ft—which is also the maximum R2 length achievable, as dictated by the selected size of the cubic TDMM craft invention.

However, if the movable inner rim 33 is moved in any direction towards outer rim 34 without making contact with its inside surface, then the length of R2 in that direction will be less than 1 ft. For example, looking at FIGS. 16 through 18, if inner rim 33 is moved only 0.5 ft from its “neutral position” towards outer rim 34 in the direction of 180 degrees, such that its center point P is only 0.5 ft away from the fixed point 0, then R2=0.5 ft in that same direction.

The above-mentioned variable R2 capability feature (which is made possible by the capability of the Machine's two-dimension, all-way movable mechanism 49 to move inner rim 33 any given distance from its “neutral position” towards, and up to, the inside surface of outer rim 34 in any direction) is most important, because it can be used to control the rotating variable-length of radius R3_{W} which, in turn, and according to the F_{c} centrifugal force equation (1), can be used to obtain the appropriate amount of variable resultant centrifugal force (ResF) output desired of the cubic TDMM craft in order to:
1) keep it accelerating, decelerating or just cruising along on any “far-earth” voyage,
2) keep it stationary (hovering) at any desired point anywhere on earth and in outer space,
3) keep it moving at any given “near-earth” orbital velocity at any altitude, and
4) most importantly, control its descent velocity when re-entering any atmospheric environment (such as that of earth) without burning up and safely land (thereby making the use of thermal tiles unnecessary and obsolete).

The input parameters used in SOUCVOL to obtain all the various cubic TDMM craft's rotational and kinetic energy performance results presented herein in FIGS. 22 through 40 are listed in the following Table 1.

TABLE 1
R0 = 4 ft = constant-length radius of the fixed, circular outer rim 34,

(Note: R0 is also the maximum achievable variable-length radius
R3_{w})

R1_{w} = 3 ft = constant-length radius of the movable, circular inner rim 33,

ω₀ = 100 rad/sec = constant angular velocity of variable-length
subassembly 40,

Delrot = 0.5 deg = small “delta” incrementation of the angle of rotation
theta0,

W_{w} = 1 lb = weight of 2-wheel device 47 (rotating at end of variable-
length bar R3_{w}),

W_{br} = 1 lb = weight of the rotating variable-length bar R3_{br}.

(Note: The SOUCVOL input parameter values listed in Table 1 are
arbitrary and can therefore be assigned any other values, as needed
for different model sizes).

A) Derivation of the Variable-length Radius R3_{W} Equation.

As shown in FIG. 15, the three line segments R1_{W} (the constant-length radius of inner rim 33), R2 (the variable segment length, or difference between the outer rim's fixed, off-center point 0 and the inner rim's center point P) and R3_{W} (the variable-length radius of the subassembly 40, which consists of one telescoping slide 46 and of one 2-wheel device 47, also referred to as W) represent the three sides of a plane triangle—which continuously changes its shape as the variable-length radius R3_{W} rotates around the fixed, off-center point 0 (as shown in FIGS. 15 through 18).

From geometry, the relationship between sides a, b and c and angles A, B and C of any plane triangle is obtained by the law of Sines. Therefore, after substituting the variable-length radius R3_{W} for side a, the inner rim's constant-length radius R1_{W} for side b and the line segment R2 for side c, the law of Sines gives the following relationship:
R3_{W}/(SIN A)=R1_{W}/(SIN B)=R2/(SIN C) (A1)

In equation A1, the constants radius R1_{W} and the maximum line segment R2=(R0−R1_{W}) are already known (see Table 1) and angle B, which depends directly on angle theta0 for its value (see FIGS. 15 through 18), can be obtained as follows:

When angle theta0 is:
1)=0 degree (or 360 degrees), then angle B=180 degrees,
2)<180 degrees, then angle B=(180 degrees−theta0),
3)=180 degrees, then angle B=0 degree,
4)>180 degrees, then angle B=(theta0−180 degrees).

Therefore, from equation A1, angle C is obtained as follows:
R1_{W}/(SIN B)=R2/(SIN C) (A2)
which, when solving for angle C, gives:
C=SIN⁻((R2/R1_{W})(SIN B)) (A3)

Now that we have an equation for angle C, we can easily obtain a value for angle A, which is needed to calculate R3_{W} in equation A1. From plane trigonometry, we know that the sum of the three angles A, B and C in any triangle is always equal to 180 degrees, therefore:
angle A=(180 degrees)−angle B−angle C (A4)

Then, going back to the first two terms of equation A1 and solving for R3_{W} gives the following equation, namely:
R3_{W}=R1_{W}(SIN A/SIN B) (A5)
in which the value of SIN A is obtained by using the value of angle A given in equation A4.

A value for the variable-length radius R3_{W}(from the fixed point 0 to any contact point on the inside surface of the circular inner rim 33) can now be easily obtained as a function of the angle of rotation theta0—by using the appropriate angle B value from one of the four theta0options given above. For example, as shown in FIG. 15, when theta0=135 degrees (which is less than 180 degrees), then angle B=180−135=45 degrees.

For the purpose of illustration, let's also look at FIGS. 16, 17 and 18. In FIG. 16, when theta0=0 degree, R3_{W}=(R1_{W}−R2)=(3 ft−1 ft)=2 ft (which is the shortest achievable R3_{W} length), and when theta0=180 degrees, R3_{W}=(R1_{W} +R2)=(3 ft+1 ft)=4 ft which is the maximum, longest achievable R3_{W} length)—which is also equal to the circular outer rim's input parameter R0=4 ft. Also note that, in FIG. 16, both the shortest and the longest radii R3_{W} lengths add up to 6 ft—which is the diameter length of circular inner rim 33. In FIG. 17, at theta0=45 degrees, R3_{W}=2.208 ft and, at theta0=225 degrees, R3_{W}=3.623 ft (when using the appropriate angle B values obtained from one of the 4 angle B relationships given earlier). Finally, in FIG. 18, when theta0 is equal to either 90 degrees or 270 degrees, both R3_{W} radii are each equal to 2.828 ft.

Furthermore, since R3_{W} is a variable-length bar (telescoping slide 46) with a given mass_{br}, it is also necessary to obtain an equation for the bar's radius of gyration R3_{br}, which is given as:
R3_{br}={square root over (()}I_{br}/mass_{br}) (A6)
and, for a bar with the axis of rotation through one end, its moment of inertia I_{br} is:
I_{br}=(mass_{br}/3)(R3_{W})² (A7)
which, after substituting the right side of equation A7 for I_{bar} in equation A6, gives:
R3_{br}=R3_{W}/\sqrt{3} (A8)
and, for the purpose of simplifying many other calculations, let
1/\sqrt{3}=M_{br}=0.5773503 (A9)
(in which, for example, the value of M_{br} is used as a constant multiplier to quickly calculate the variable-length of the bar's radius of gyration R3_{br}=R3_{W}(0.5773503).

As shown in FIG. 20, the circular locus of the variable-length R3_{br}(rotating in the maximum “active position” about the fixed point 0) has its center at point S and a radius R_{S}. Similarly, as shown in FIG. 19 (in which points P and S are superimposed on the fixed point 0), the circular locus of the constant-length radius of gyration R1_{br}(rotating in the “neutral position” about al three points P, S and 0) has its center at point S but has its radius=R1_{W}(M_{br}), which is superimposed on and equal to R_{S}. Note that the sizes of both the circular loci of R1_{br}in FIG. 19 and of R3_{br} in FIG. 20 are identical, with the same radius R_{S}=1.73 ft, as measured from point S in both figures.

Plots of the variable-length radii R3_{W} and R3_{br} are presented in FIG. 23 as functions of theta0(along with plots of the constant-length radii R1_{W} and R1_{br}, for comparison with the plots of R3_{W} and R3_{br})—and can now be used to derive the other rotational equations needed to obtain the cubic TDMM craft velocity, acceleration, force and kinetic energy plots as functions of theta0. The R3_{W} and R3_{br} plots presented in FIG. 23 are all based on calculations obtained at every incremented 0.5 degree (see delrot in Table 1) of angle theta0(for greater accuracy), using one subassembly 40 only, rotating counterclockwise, but are only plotted every 10 degrees.

B) Derivation of the Ten Basic Rotational Equations.

To aid in the calculations of the Machine's 10 rotational results presented herein, a dedicated computer simulation program, identified by the acronym “SOUCVOL” (formed from the initial letters of SOUCoupe VOLante) throughout this patent was written. The SOUCVOL calculations performed in each iteration first require the use of the variable-length radius R3_{W} equations A1 through A9(presented in the above section A), in order to obtain the various angles and radii values needed as inputs into the following 10 basic rotational equations B1a through B10.3c. However, the detailed program coding is not presented herein in the interest of brevity.

Briefly, all 10 basic rotational equations are used in each successive iteration, at the start of which, angle theta0(which, as shown in FIGS. 11 and 12, is the angle of rotation of the 8 subassemblies 40 about the fixed point 0) is incremented by a small delta rotation of 0.5 degrees (see “delrot” in Table 1)—the value of which was arbitrarily selected to be the primary incrementation input parameter used in SOUCVOL. Next, SOUCVOL obtains the appropriate angle B value (from the four theta0 options given in paragraph 0124) and angle C (see equation A3), which are then used to calculate the variable-length radius R3_{W}(see equation A5) and the bar's radius of gyration R3_{br}(see equation A8), which are then respectively used in the 10 rotational equations B1a through B10.3c to obtain the 10 sets of rotational performance results presented in FIGS. 22 and 24 through 31—upon which they depend, directly or indirectly, for their values.

Furthermore, since there are 360 degrees per each theta0 rotation about the fixed point 0 inside the circular movable inner rim 33 (see FIGS. 11 and 12), there is therefore a total of 721 iterations per each SOUCVOL run (namely: (360 deg/0.5 deg)+1), each with one complete set of 10 rotational results obtained at the end of each delrot-incremented iteration. There is therefore a total of 721 sets of 10 different rotational results for each of the 8 equally-spaced (45 degrees apart) subassemblies 40—regardless of where the number 1 subassembly 40 (in the set of 8 rotating subassemblies 40 shown in both FIGS. 11 and 12) is located on the inside surface of the circular inner rim 33.

As already mentioned, both subscripts “_{W}” and “_{br}” are used in the following 10 sets of equations to differentiate the results obtained for the 2-wheel device W (on the inside surface of the movable inner rim 33) from those obtained for the bar (on the locus of its radius of gyration, represented by the dashed circles in both FIGS. 19 and 20). The subscript “₀” is also used in some equations to indicate either an initial input parameter (such as in the constant input angular velocity ω₀), or a parameter value obtained in a previous iteration, such as, for example, in VT_{W0} (which is used in equation B2a to calculate the average tangential acceleration AT_{Wav}=(VT_{W}−VT_{W0})/deltm.

The 10 sets of rotational equations for both W (at the end of the rotating variable-length bar R3_{W}) and for the variable-length bar (at its radius of gyration R3_{br}), are:

1) TANGENTIAL VELOCITY (VT), ft/sec.
a) For W,
   VT_{W}=R3_{W}ω₀ (B1a)
(in which ω₀ is the input constant angular velocity given in Table 1)
b) For the bar,
   VT_{br}=R3_{br}ω₀=VT_{W}(M_{br}) (B1b)
(in which the constant multiplier M_{br}=0.57773503—see equation A9).

2) AVERAGE TANGENTIAL ACCELERATION (ATₐᵥ), ft/sec².
a) For W,
   AT_{Wav}=(VT_{W}−VT_{W0})/deltm (B2a)
(in which “deltm”=0.5 deg/(5729.578 deg/sec)=8.726646⁻⁵ sec).
b) For the bar,
   AT_{brav}=(VT_{br}−VT_{br0})/deltm (B2b)
c) For both W and bar combined,
   ATₐᵥ=AT_{Wav}+AT_{brav} B2c)

3) RELATIVE ANGULAR VELOCITY (ω₂), relative to R1_{W} instead of R3_{W}, rad/sec.
a) For W,
   ω₂=VT_{W}/R1_{W}=VT_{br}/R1_{br} (B3a)

4) AVERAGE TANGENTIAL FORCE (FTₐᵥ), lbs.
a) For W,
   FT_{Wav}=mass_{W}(AT_{Wav}) (B4a)
b) For the bar
   FT_{brav}=mass_{br}(AT_{brav}) (B4b)
c) For W and bar combined,
   FTₐᵥ=FT_{Wav}+FT_{brav} (B4c)

5) RADIAL ACCELERATION (AR), ft/sec².
a) For W,
   AR_{W}=(VT_{W})²/R3_{W} (B5a)
b) for the bar,
   AR_{br}=(VT_{br})²/R3_{br}=AR_{W}(M_{br}) (B5b)
c) for W and bar combined,
   AR=AR_{W}+AR_{br} (B5c)

6) RADIAL FORCE (FR), lbs.
a) For W,
   FR_{W}=mass_{W}(AR_{W}) (B6a)
b) For the bar,
   FR_{br}=mass_{br}(AR_{br}) (B6b)
c) For W and bar combined,
   FR=FR_{W}+FR_{br} (B6c)

7) RESULTANT CENTRIFUGAL ACCELERATION (ResA), ft/sec.
a) For W,
   ResA_{W}={square root over (()}(AT_{Wav})²+(AR_{W})²) (B7a)
b) For the bar,
   ResA_{br}={square root over (()}(AT_{brav})²+(AR_{br})²) (B7b)
c) For W and bar combined,
   ResA=ResA_{W}+ResA_{br}={square root over (()}ATₐᵥ²+AR²) (B7c)

8) RESULTANT CENTRIFUGAL FORCE (ResF), lbs.
a) For W,
   ResF_{W}=mass_{W}(ResA_{W}) (B8a)
b) For the bar,
   ResF_{br}=mass_{br}(ResA_{br}) (B8b)
c) Combined resultant force
   ResF=ResF_{W}+ResF_{br} (B8c)

9) ANGLE DIRA=DIRECTION ANGLE FOR BOTH THE CENTRIFUGAL ACCELERATION AND THE CENTRIFUGAL FORCE, degrees.
a) Angle ALF (between ATₐᵥ and AR),
   ALF=TAN⁻¹(ATₐᵥ/AR)=TAN⁻¹(FTₐᵥ/FR) (B9a)
b) Angle DIRA (direction angle of both ResA and ResF),
   DIRA=Angle A+angle ALF (B9b)

NOTES: 1) Angle A is defined in equation A4.
2) See FIG. 21 for the graphical representation of angles A, ALF and DIRA for theta0=40 degrees.
3) See FIG. 22 for plots of angles ALF, A and DIRA as functions of theta0.

10) R0TATIONAL KINETIC ENERGY (KE), ft*lbs,

The following set of KE equations is based on the standard rotational kinetic energy (KE) equation, namely:
KE=Σ(1/2)M(Rω)² (10.1)

in which 1) M=mass of the rotating body, slugs,
2) R=length of radius, ft, and
3) ω=angular velocity of the rotating body, rad/sec.

These kinetic energy (KE) equations are also used with only one rotating subassembly 40, which consists of one 2-wheel device 47 (also referred to as W for wheels) plus one slide 46 (referred to as the bar). The KE calculations are first done separately for W and then for the bar and are then combined to obtain the KE result for the entire subassembly 40 in each SOUCVOL iteration, which occurs each time the subassembly 40 angle of rotation theta0 is incremented by a small input delrot value of 0.5 degree (see Table 1). Therefore, as already mentioned, since there is a total of 721 angle theta0 increments (one every 0.5 degree, from 0 degree to 360 degrees) around the circular inner rim 33, there is also a total of 721 sets of W, bar and subassembly 40 KE results per each SOUCVOL run—or, one complete set of KE results is simultaneously available for each of the 8 equally-spaced (45 degrees apart) subassemblies 40 (see FIG. 39), no matter where the #1 subassembly 40 starts on the 360-degree circular inner rim 33.

In the following tenth set of KE equations, mass_{W} and mass_{br} represent the masses of the two-wheel device 47 (W) and of the telescoping slide 46 (bar) respectively. They are used in each SOUCVOL iteration (after first incrementing theta0 by delrot=0.5 degree) for calculating the rotational KE values of both W and the bar separately and then combining them to obtain the KE value for one subassembly 40 in both the “neutral position” and the “active position”. These two sets of KE equation are:
1) The first set of kinetic energy equations is called KE0, which represents the “neutral position” case shown in FIGS. 11 and 19 (in which the constant-lengths of both the inner rim's constant radius R1_{W} and of the bar's constant radius of gyration R1_{br} (which are of equal lengths) rotate about superimposed points P, S and 0).
   a) For W,
      KE0_{W}=(1/2)mass_{W}(R1_{W}ω₀)² (B10.2a)
   b) For the bar,
      KE0_{br}=(1/2)mass_{br}(R1_{br}ω₀)² (B10.2b)
   (in which R1_{br}=R1_{W}(M_{br})—see equation A9 for the definition of M_{br})
   c) For W and the bar combined,
      KE0=KE0_{W}+KE0_{br} (10.2c)
   2) The second set of kinetic energy equations is called KE1, which represents the “active position” case shown in FIGS. 12 and 20 (in which the radii lengths of R3_{W}, for W, and of R3_{br}, for the bar's radius of gyration, continually vary as a function of theta0(se FIG. 23).
   a) For W,
      KE1_{W}=(1/2)mass_{W}(R3_{W}ω₀)² (B10.3a)
   b) For the bar,
      KE1_{br}=(1/2)mass_{br}(R3_{br}ω₀)² (B10.3b)
   (in which R3_{br}=R3_{W}(M_{br}))
   c) For W and the bar combined,
      KE1=KE1_{W}+KE1_{br} (B10.3c)
      C) Equations for Evaluating the Performance of the Cubic TDMM Craft.

In order to perform all the parametric calculations needed for evaluating the performance of the cubic TDMM craft, I wrote a small computer program in QBASIC named “PRFMEVL” (for performance evaluation), in which the following equations (C1) through (C11) were used for calculating the various performance results of the said cubic craft. The initial input parameters used in the following equations are presented in the following Table 2, which is divided into four sections.

TABLE 2
1) Initial Constant Input Parameters:

ResF = total resultant centrifugal force generated by the Machine's two sets of

```
  8 subassemblies 40, counter-rotating at the following given angular
  velocities respectively:
= 995.0 lbs at 50 rad/sec.
= 2,238.1 lbs at 75 rad/sec.
= 3,979.8 lbs at 100 rad/sec.
```

Rinc = altitude (distance) range increment, miles.
Rmax = maximum cubic craft range, miles.
Rₑ = 3,950.0 miles = average earth's radius.
Rₘ = 1,071.0 miles = average moon's radius.
Dₑₘ = 230,000.0 miles = average distance between earth and moon.
gₑ = 32.174 ft/sec² = acceleration of gravity at the earth's surface.
gₘ = 5.32 ft/sec² = acceleration of gravity at the moon's surface.
W_{cc} = 600 lbs = approximate weight of cubic craft at the earth's surface.

2) Initialization of parameters at start of PRFMEVL run:

Tₑ = 0 sec = cubic craft elapsed time from launch.
ALT = 0 miles = altitude of cubic craft from earth (at Tₑ = 0 sec).
ALT1 = 0 feet = altitude of cubic craft (at Tₑ = 0 sec).
Xₑ = Rₑ = altitude of cubic craft from earth's center (at Tₑ = 0 sec).
Xₘ = Dₑₘ = distance of cubic craft from moon's surface (at Tₑ = 0 sec).
Kₑ = gₑ Rₑ² = constant parameter, obtained from equation gₑ = (GMₑ)/Rₑ² =

Kₑ/Rₑ², in which G = gravitational constant, Mₑ = the earth's

mass and Rₑ = distance to earth's center from the surface.

Kₘ = gₘ Rₘ² = constant parameter, similarly obtained as above, but for the

moon.

M_{cc} = (W_{cc}/gₑ) = 600/32.174 = 18.6486 slugs = Cubic craft's constant

mass.

```
3) Performance Evaluation Equations and algorithms used in “PRFMEVL”:
  Negative earth's acceleration of gravity on cubic craft at time Tₑ after launch from
  earth, ft/sec².
```

| | |
|---|---|
| gₑ = −(Kₑ/Xₑ²) | (C1) |

Positive moon's acceleration of gravity on cubic craft at time Tₑ after launch from
earth, ft/sec².

| | |
|---|---|
| gₘ = Kₘ/(Xₘ + Rₘ)² | (C2) |

Negative force on cubic craft at time Tₑ after launch due to earth's gravity, lbs.

| | |
|---|---|
| Fₑ =M_{cc}gₑ | (C3) |

Positive force on cubic craft at time Tₑ after launch due to moon's gravity, lbs.

| | |
|---|---|
| Fₘ = M_{cc}gₘ | (C4) |

Cubic craft motive force versus vertical altitude, lbs.

| | |
|---|---|
| F_{cc} = Fₑ + ResF + Fₘ | (C5) |

Cubic craft Instantaneous acceleration versus vertical altitude from earth, ft/sec².

| | |
|---|---|
| Aₑ = F_{cc}/M_{cc} | (C6) |

Cubic craft elapsed flight time from launch time from earth, sec.

| | |
|---|---|
| IF ALT > 0 THEN Tₑ = √(ALT1/(0.5Aₑ)) | (C7) |

Cubic craft instantaneous velocity at time Tₑ after launch from earth, miles/sec.

| | |
|---|---|
| Vₑ = (AₑTₑ)/5280.0 | (C8) |

Cubic craft average acceleration in the nth incremented range (Rinc), ft/sec².

| | |
|---|---|
| A_{cc} = ((Vₑ² − Vₑ₀²)/2Rinc)5280 | (C9) |

(in which Vₑ₀ was obtained in the previous iteration).

Cubic craft average flight time (Tₐᵥ) in the nth incremented range (Rinc), sec.

| | |
|---|---|
| IF ALT > 0 THEN Tₐᵥ = ((Vₑ − Vₑ₀)5280)/A_{cc} | (C10) |

Cubic craft average flight time from earth launch to the end of the nth incremented
range (Rinc), sec.

| | |
|---|---|
| T_{cc} = T_{cc} + Tₐᵥ | (C11) |

NOTE: Read the “Discussion Of The Cubic TDMM Craft Performance Results”

section for an explanation of the two flight times Tₑ and T_{cc}.

4) Increment new parameter values for the next iteration:

Vₑ₀ = Vₑ, mi/sec.

(Vₑ₀ is saved in this iteration for use in the next iteration)
Xₑ = (Xₑ + Rinc) = new incremented altitude from earth at time Tₑ, miles.
ALT = (Xₑ − Rₑ) = new decreased altitude from earth at time Tₑ, miles.
ALT1 = (ALT) 5280 = new cubic craft altitude at time Tₑ from earth, ft.
Xₘ = (Dₑₘ − ALT) = new decreased distance from earth to moon's surface

at time Tₑ, miles.

IF ALT > Rmax THEN END.

Otherwise, go back to gₑ(equation C1) above for another iteration with the
new incremented parameter values.

Discuccion of the Cubic TDMM Craft Rotational Results

The following plots of the cubic TDMM craft's rotational results, presented in FIGS. 22 through 40, were obtained with the computer simulation program SOUCVOL—in which equations A1 through A9, which were used in the derivation of the variable-length radius R3_{W}, and the 10 basic rotational equations B1a through B10.3c were all used in each of the previously-mentioned 721 iterations. The plots presented in FIGS. 22 through 31 and in FIGS. 37 and 38 as functions of theta0(from 0 to 360 degrees) were all obtained using one subassembly 40 only, rotating about the fixed point 0 at a constant counterclockwise angular velocity ω₀=100 rad/sec. FIGS. 32 through 36 and FIGS. 39 and 40 present other aspects of the cubic TDMM craft's Machine performance rotational results in which, for example, the number of rotating subassemblies 40 and/or the angular velocity values were variously used and/or combined.

The performance results for one rotating subassembly 40 were calculated at every 0.5 degree “delrot” incrementation of the angle of rotation theta0, in order to provide several simultaneously-obtained, more accurate sets of rotational results for the 8 equally-spaced (45 degrees apart), variable-length subassemblies 40, no matter where the #1 subassembly 40 starts on the inside surface of inner rim 33 (see FIGS. 11 and 12). However, for simplicity and clarity in the figures, the cubic TDMM craft's performance results are plotted every 10 degrees only, from 0 to 360 degrees (which should not affect the accuracy of the results).

In FIGS. 22 through 31, the subscripts (_{W}) and (_{br}) are used with some parameters (such as with VT_{W} and VT_{br}) to refer to rotational results obtained for the 2-wheel device W (also referred to as part number 47 in both FIGS. 11 and 12), running at the end of the variable-length radius R3_{W} along the inside surface of inner rim 33, and for the variable-length bar's variable-length radius of gyration R3_{br}, running along its circular locus of R3_{br}(which is shown as a dashed circle in both FIGS. 19 and 20).

FIG. 22 shows plots of angles ALF, A and DIRA as functions of theta0. As illustrated in FIG. 21, angle ALF (see equation B9a) is the angle between the resultant centrifugal force ResF and the radial force FR, angle A (see equation A4) is the angle (measured from 0 degree) representing the direction of FR from point P, and angle DIRA (see equation B9b) is the angle (also measured from 0 degree) representing the direction of ResF from the fixed off-center point 0. As also shown in FIG. 21, the direction of FR was chosen to start at point P (the center of inner rim 33) to ensure that the tangential force FT is always at right angle with the radial force FR on inner rim 33 and that the direction of angle DIRA, which is equal to angle A+angle ALF, should always be equal to the angle of rotation theta0. As also indicated in the “Derivation Of The Variable-length Radius R3_{W} Equation” in section A, these angles are used (directly or indirectly) for deriving the equation for the variable-length R3_{W}(see equation A5), on which the other 10 basic rotational equations presented in section B, such as the tangential velocity VT_{W}(see equation B1a), the tangential acceleration (see equation B1b), . . . etc . . . ) all depend for their derivations. For example, FIG. 21 shows that, when theta0=40 degrees, R3_{W} (which is subassembly 40)=2.16 ft, angle ALF=12.3 degrees, angle A=27.7 degrees and angle DIRA=A+ALF=40.0 degrees, which are all used to calculate the tangential force FT=231.3 lbs in the direction of 117.6 degrees (as measured from 0 degree), making a right angle with the direction of the radial force FR=1061.1 lbs in the direction of 27.7 degrees (from 0 degree) and the vectorially combined resultant centrifugal force ResF=1086.0 lbs in the direction of angle DIRA=40.0 degrees. Note that the direction of DIRA is the same as that of theta0 and that the direction of FR is also the same as that of angle A at point P. The three angles ALF, A and DIRA, shown in FIG. 21 for theta0=40 degrees, can also be found in FIG. 22.

FIG. 23 presents plots of the variable-length radii R3_{W} and R3_{br} and of the constant-length radii R1_{W} and R1_{br} as functions of theta0. The R1_{W} and R1_{br} plots are also presented in this figure for visual comparison with the R3_{W} and R3_{br} plots. As shown in FIG. 20, R3_{W} represents the variable radial length of the 2-wheel device 47 (W), from the fixed, off-center point 0 to a point on inner rim 33, and R3_{br} is the variable-length of the bar's radius of gyration, also from the fixed, off-center point 0 to a point on the locus of the bar's radius of gyration (shown as a dashed circle with radius R_{S} and center at point S). The R3_{W} and R3_{br} plots were obtained with equations A5 and A8 respectively, using one subassembly 40 only. The R1_{W} plot represents the constant-length radius of inner rim 33 and the R1_{br} plot (which is equal to R1_{W}M_{br}) represents the constant-length radius of gyration of the bar (slide 46). The variable-length R3_{W} plot is the most important of all the plots, because all the other plots (including R3_{br}) depend on it directly or indirectly for their plotted values as functions of theta0. The trigonometric relationships between angles A (see equation A4), B (see the four angle B options on page 35) and C (see equation A3) and the radial lengths of R3_{W}, R1_{W} and R2 for angle theta0=135 degrees is shown in FIG. 15. Angles A, B and C were all used (directly or indirectly) to derive the variable-length radius R3_{W}(see equation A5).

FIG. 24 shows plots of the variable tangential velocities VT_{W}=(R3_{W})ω₀, in which ω₀=100 rad/sec, and VT_{br}=VT_{W}(M_{br})—in which the constant multiplier M_{br}=0.5773503(see equation A9) is used to calculate it. The constant tangential velocity plots of VT1_{W} and VT1_{br} are also presented here for comparison with the VT_{W} and VT_{br} plots. The VT_{W} and VT_{br} plots were obtained with equations B1a and B1b respectively, using one subassembly 40 only, rotating at 100 rad/sec. The reason why the four tangential velocity plots appear to be identical to the four radii plots in FIG. 23 is because an initial input angular velocity ω₀=100 rad/sec was used in the above variable and constant tangential velocity equations, thus causing the Y-axis tangential velocity scale to be 100 times greater than that of the Y-axis radius scale in FIG. 23.

FIG. 25 presents an interesting angular velocity ω₂ plot, representing the relative variable angular velocity of subassembly 40 as a function of theta0. It shows another aspect of the angular velocity of the 2-wheel device 47 (W), running along on the inside surface of the movable inner rim 33 as if it were rotating at the end of the constant-length radius R1_{W} about the inner rim's center point P with the same variable tangential velocity VT_{W}(see FIG. 24) obtained when W was rotating at the end of the variable-length radius R3_{W} about the fixed, off-center point 0 (see FIGS. 11 and 12) with a constant angular velocity ω₀=100 rad/sec. The reason for this variable ω₂ plot (which appears to conflict with the actual constant input angular velocity ω₀=100 rad/sec) is found in the expanded relationship ω₂=VT_{W}/R1_{W}=(R3_{W}ω₀)/R1_{W}=R3_{W}(ω₀/R1_{W}), in which the last term shows that, since R1_{W} and ω₀ are both constant input parameters (see Table 1), then ω₂ varies proportionately with the variable-length radius R3_{W}. As a result, and unlike the constant input angular velocity ω₀ of 100 rad/sec, the angular velocity plot of ω₂ varies continually from 66.67 rad/sec, at both theta0=0 degree and at 360 degrees, to 133.33 rad/sec, at theta0=180 degrees. Note that, at both theta0=100 degrees and 260 degrees, the variable relative ω₂ and the constant ω₀ plots are both equal to 100 rad/sec, because, as shown in FIG. 23, both R3_{W} and R1_{W} are equal to 3 ft at those same two theta0 angles. The input constant angular velocity plot of 100 rad/sec is shown here for comparison with the variable angular velocity plot.

FIG. 26 shows three average variable tangential acceleration plots with similar sinusoidal shapes. They were obtained with equations AT_{Wav}=(VT_{W}−VT_{W0})/deltm and AT_{brav}=(VT_{br}−VT_{br0})/deltm (see equations B2a and B2b), which are both combined in equation ATₐᵥ=AT_{Wav}+AT_{brav}(see equation B2c). The sinusoidal shapes of these three tangential plots are caused by the numerators (WT_{W}−WT_{W0}) and (WT_{br}−WT_{br0}) respectively, which both represent small changes in the tangential velocities of W (running along the inside surface of movable inner rim 33—see FIGS. 11 and 12) and of the bar's radius of gyration R3_{br}(running along its locus, shown as a dashed circle in FIG. 20), which occur between the start and the end of the small elapsed delta time “deltm”, which is the time required for subassembly 40 to rotate about the fixed off-center point 0 through each incremented 0.5 degree of angle theta0(see delrot in Table 1). For example (keeping in mind that angle theta0 rotates counterclockwise around the fixed point 0), VT_{W} and VT_{br} in the above two numerators always represent the exact calculated angular velocities at the start of the newly 0.5-degree-incremented theta0 interval in the current iteration while VT_{W0} and VT_{br0}(at the end of each 0.5 degree interval) represent the velocities which were obtained 0.5 degree earlier, or “deltm” (see equation B2a) earlier, in the previous iteration. Therefore, as shown in FIG. 24, both VT_{W} and VT_{br} values in both numerators (VT_{W}−VT_{W0}) and (VT_{br}−VT_{br0}) are always identical at any two symmetrical theta0 values on each side of 180 degrees in the current iteration (such as at 45 and 315 degrees), while the VT_{W0} and VT_{br0} values, which were obtained 0.5 degree earlier in the previous iteration (such as at 44.5 and 314.5 degrees instead of 45 and 315 degrees), are always slightly smaller that the VT_{W} and VT_{br} between 0 and 180 degrees and slightly larger than the VT_{W} and VT_{br} values between 180 and 360 degrees. That is why the numerators (VT_{W}−VT_{W0}) and (VT_{br}−VT_{br0}) always cause the AT_{Wav} and AT_{brav} plots to be positive between 0 and 180 degrees and negative between 180 and 360 degrees—thereby causing the sinusoidal shapes of the three tangential acceleration plots.

However, the small difference between the two VT_{W} and VT_{W0} tangential velocities in the (VT_{W}−VT_{W0}) numerator introduces a small, insignificant discrepancy when calculating the absolute average AT_{Wav} values on each symmetrical side of 180 degrees every time theta0 is incremented by 0.5 degree. For example, as shown in FIG. 24, the two symmetrical VT_{W} values shown at both theta0=110 and 250 degrees are both equal to 319.1 ft/sec respectively (which is as it should be) while VT_{W0}, which was obtained 0.5 degree earlier, has a value of 318.18 ft/sec when theta0 was at 109.5 degrees (which is slightly smaller than that of VT_{W} at 110 degrees) and a value of 320.02 ft/sec when theta0 was at 249.5 degrees (which is slightly larger than that of VT_{W} at 250 degrees). As a result, the absolute values of AT_{Wav}=(VT_{W}−VT_{W0})/deltm is equal to [+10,528.6] ft/sec² at 110 degrees and is equal to [−10,521.3] ft/sec at 250 degrees respectively (indicating a small, insignificant difference of 6.7 ft/sec² between the two average tangential accelerations—or a difference of about 0.0006%). Also, because there's no change in tangential velocities between VT_{W} and VT_{W0}at theta0=0, 180 and 360 degrees, AT_{Wav} is equal to 0 ft/sec at those three theta0 values. The same argument also applies to the plot of AT_{brav}=(VT_{br}−VT_{br0})/deltm. Finally, since both AT_{Wav} and AT_{brav} are parrallel vectors, they were simply added to obtain the ATₐᵥ plot.

FIG. 27 shows three variable radial acceleration plots of AR_{br}=VT_{br}²/R_{br}=AR_{W} (M_{br}), AR_{W}=VT_{W}²/R3_{W} and AR=AR_{br}+AR_{W}(see equations B5b, B5a and B5c) which, unlike the plots of FIG. 26, are bell-shaped and positive between 0 and 360 degrees—because these plots depend directly on the tangential velocity plots of FIG. 24 for their plotted values. Also, because both AR_{W} and AR_{br} are parallel vectors, they are simply added to obtain the AR plot.

FIG. 28 shows three variable resultant acceleration plots of ResA_{br}={square root over (()}AT_{brav}²+AR_{br}²), ResA_{W}={square root over (()}AT_{Wav}²+AR_{W}²) and ResA=ResA_{W}+Res_{br}(see equations B7b, B7a and B7c respectively). Both the ResA_{br} and the ResA_{W} plots were obtained from the tangential and radial acceleration plots shown in FIGS. 26 and 27. Here, since both the tangential and radial accelerations and their related forces (see FIG. 21) always intersect at right angles on inner rim 33 for any given theta0 value, they are vectorially combined by using the Pythagorean theorem to obtain their resultant accelerations. For example, at theta0=110 degrees, AT_{brav}=6,078.6 ft/sec in FIG. 26 and AR_{br}=18,423.5 ft/sec in FIG. 27, which both vectorially combine to give ResA_{br}=19,400.4 ft/sec² at theta0=110 degrees in this figure. Here also, because both ResA_{W} and ResA_{br} are parallel vectors, they are simply added to obtain the ResA plot.

FIGS. 29, 30 and 31 respectively present plots of the average tangential forces FT_{brav}, FT_{Wav} and FTₐᵥ(see equations B4b, B4a and B4c), radial forces FR_{br}, FR_{W} and FR (see equations B6b, B6a and B6c) and resultant centrifugal forces ResF_{br}, ResF_{W} and ResF (see equations B8b, B8a and B8c), which were all generated using one rotating subassembly 40 only. They were all obtained by substituting the tangential, radial and resultant acceleration plot results (see FIGS. 26, 27 and 28 plots) respectively into the basic force equation F=MA, in which M is the mass of the rotating body and A is its acceleration. As given in Table 1, the weights of both the 2-wheel device 47 (W_{W}), at the end of the variable-length bar's radius R3_{W}, and of the variable-length bar R3_{br} (W_{br}), in each subassembly 40, are each arbitrarily equal to one pound (which is equal to a mass of 0.031081 slug). Thus, for example, when substituting M=0.031081 slug and ResA=53,003.0 ft/sec² at 110 degrees in FIG. 28 in the above F=MA equation, a resultant centrifugal force ResF=1,647.4 lbs is obtained at 110 degrees in FIG. 31. This same ResF value of 1,647.4 lbs in FIG. 31 can also be obtained directly by substituting the values FTₐᵥ=516.17 lbs at 110 degrees in FIG. 29 and FR=1,564.4 lbs at 110 degrees in FIG. 30 in equation ResF={square root over (()}FTₐᵥ²+FR²). Also note that the maximum value of ResF=1,961.0 lbs at 180 degrees and the minimum values of ResF=980.5 lbs at both theta0=0 and 360 degrees in FIG. 31 are the same as those of the FR values at the same theta0 values in FIG. 30—simply because FTₐᵥ=0 lbs at those same theta0 values of 0, 180 and 360 degrees in FIG. 29 and therefore does not contribute anything to the combined values of ResF at those same angles in FIG. 31.

FIG. 32 shows a graphical representation of the 8 equally-spaced centrifugal forces (ResF) simultaneously acting at the fixed, off-center point 0. They were generated by the 8 equally-spaced, variable-length subassemblies 40 (see FIG. 12), rotating at 100 rad/sec about the fixed, off-center point 0. These 8 forces and their associated directions can also be obtained, 45 degrees apart (starting at theta0=0 degree), from the ResF plot of FIG. 31.

FIG. 33 presents a graphical representation of the use of both the triangle and the polygon methods for vectorially combining the 8 forces (numbered from 1 to 8) shown in FIG. 32 into a single resultant centrifugal force vector ResF=1,989.4 lbs, shown as a heavy black arrow closing the polygon, from the fixed, off-center point 0 (which is also the tail of force vector #1) to the head of the last force vector #8(which is the head of force vector #8), in the direction of 180 degrees. The direction of this vectorially combined, single ResF vector of 1,989.4 lbs always points outwardly, from the fixed, off-center point 0 to where inner rim 33 makes contact with the inside surface of outer rim 34—the contact point of which was arbitrarily chosen to be at 180 degrees. The 180-degree direction of this single ResF vector could just as easily have been chosen to be in some other direction, such as at 225 degrees, or 90 degrees, and still give the same single ResF vector result—by simply moving inner rim 33 to make contact with the inside surface of outer rim 34 in that other new direction (which is also the direction in which the variable-length subassembly 40 achieves its greatest maximum length).

Two methods can be used to combine the 8 forces in FIG. 32. The first method consists of drawing all 8 equally-spaced force vectors in succession on a graph paper, with the tail of each at the head of the vector preceding it, and then close the polygon by drawing a final vector from the tail of the first vector to the head of the last vector. However, while this technique is good to use when there is only one polygon to draw, it is preferable to write a computer program and use it to quickly do all the calculations needed to vectorially combine all the 8 separate force vectors when many polygons are involved (as is the case in the ResF plots of FIGS. 34 and 35).

The second triangle and polygon method mentioned above has therefore been programmed in SOUCVOL—using the law of cosine equation c²=a²+b²−2ab(cos C), in which a, b and c represent the three force vectors of any oblique triangle and A, B and C are the angles opposite those three sides (see FIGS. 15 and 33). Then, if the triangle's sides a and b are replaced with the appropriate two known force vectors Fₐ and F_{b}(from FIG. 32) in each of the seven triangles of FIG. 33, then side c becomes the force vector F_{c}(shown as a dashed line closing each triangle), which is obtained with the above law of cosine equation, which then becomes F_{c}={square root over (()}Fₐ²+F_{b}²−2FₐF_{b}(cos C)). However, before being able to solve this F_{c} equation, angle C (between vectors Fₐ and F_{b} in each of the seven triangles in the polygon in FIG. 33) must first be obtained as follows:
1) if the direction of Fₐ(i.e., DirFₐ) is less than or equal to 180 deg, then angle C=(180 deg+DirFₐ−DirF_{b}) and
2) if DirFₐ is greater than 180 degrees, then angle C=(DirFₐ+DirF_{b}−180 deg).

For example, triangle #1 in FIG. 33 shows that force vector Fₐ=980.5 lbs in the direction of 0 deg and force vector F_{b}=1,113.7 lbs in the direction of 45 degrees (which respectively represent force vectors 1 and 2 in FIG. 32). Now, according to (1) above, angle C=(180 deg+0 deg−45 deg)=135 degrees for triangle #1, between vectors Fₐ and F_{b}. Next, after substituting these three Fₐ, F_{b} and angle C values in the above law of cosine equation gives F_{c}=1,936.0 lbs, in the direction of 24 degrees (from 0 degree)—which is shown as a dashed line from the tail of Fₐ=980.5 lbs (at the fixed, off-center point 0) to the head of F_{b}=1,113.7 lbs, closing triangle #1. As shown in FIG. 33, this first F_{c} direction of 24.0 degrees for triangle #1 is also the value of angle B for triangle #1, which was obtained from the law of sines equation A1 (in which F_{b} and F_{c} are substituted for R1_{W} and R2) which, after being solved for angle B, gives angle B=sin⁻¹((F_{b}/F_{c})sin C). For example, substituting the above three known values for F_{b}, F_{c} and angle C obtained for triangle #1 into the above angle B equation gives angle B=sin₋₁ ((1,113.7 lbs)/(1,936.0 lbs))(0.7071)=24.0 degrees. Next, this first F_{c} value of 1,936.0 lbs of triangle #1 now becomes Fₐ=1,936 lbs in the direction of 24 degrees for triangle #2, with the second vector F_{b}=1,470.5 lbs at 90 degrees (which is force vector #3 in FIG. 32). Again, from the angle C relationship in (1) above, angle C for triangle #2 is equal to (180+24−90)=114.0 degrees and, after substituting this second set of known Fₐ, F_{b} and angle C values of triangle #2 in the law of cosine equation, gives F_{c}=2,868.1 lbs in the direction of (27.9 deg+24 deg)=51.9 degrees (again from 0 deg)—in which 27.9 degrees, which is the value of angle B for triangle #2(which was obtained with the above angle B equation), was added to the angle B value of 24 degrees of triangle #1 to get the direction of 51.9 degrees. This second F_{c}=2,868.1 lbs then becomes the Fₐ value for triangle #3 . . . and so on . . . , until, as shown in triangle #7, the last calculated F. value represents the resultant centrifugal force ResF=1,989.4 lbs, in the direction of 180 degrees, which is shown as a heavy black arrow closing the polygon, from the tail of the first Fₐ(at the fixed point 0) to the head the 8th force vector F_{b}=1,114.4 lbs, in the direction of 45 degrees (counterclockwise from 180 degrees). Again, since the above ResF of 1,989.4 lbs is for one Machine mirror-image half only, then the combined total ResF generated by the cubic TDMM craft's entire Machine doubles to 3,978.8 lbs—also in the same 180-degree direction.

FIG. 34 presents two plots of resultant centrifugal force (ResF) results for one Machine half only obtained for the 8 equally-spaced subassemblies 40 shown in FIG. 12, rotating in the maximum “active position” at 100 rad/sec about the fixed, off-center point 0. One plot represents the 10 calculated ResF results obtained at each successive 5-degree starting positions of the #1 subassembly 40 (see FIG. 12), from 0 degree to 45 degrees, and the other represents the average plot of the 10 calculated ResF results (obtained between 1,989.39 and 1,989.54 lbs)—with an average value of 1,989.46 lbs across the 45-degree range. The 0-to-45 degree range used in the 10 calculated ResF plot is all that is needed here because, as shown in FIG. 12, when the #1 subassembly 40 has moved from theta0=0 degree to theta0=45 degrees, the # 8 subassembly 40 has also moved from theta0=315 degrees to theta0=360/0 degrees (which was where the #1 subassembly 40 started from) and, after that, the same sequence of the 10 plotted ResF values repeats itself in each successive 45-degree range. The 10 plotted ResF values were also obtained with the combined use of both the triangle and the polygon methods (shown in FIG. 33), using the computer program SOUCVOL to calculate each of the 10 results.

The insignificant deviations shown between the 10 calculated ResF plot and the average ResF plot (which represents an average deviation of about 0.04 lbs from the average plot of 1989.46 lbs—which is about 0.002%) is not an indication of the presence of any unwanted rotational vibrations (impulses), which might affect the smooth flight of the cubic TDMM craft. They may only be the result of slight differences in the way SOUCVOL calculated the 10 ResF results and are not therefore an indication that they were caused by the different positions of the #1 subassembly 40 between 0 and 45 degrees.

FIG. 35 presents another plot of SOUCVOL-generated resultant centrifugal force (ResF) results as a function of angular velocity (from 0 to 350 rad/sec respectively) for one Machine mirror-image half only, using the set of 8 variable-length subassemblies 40, rotating about the fixed, off-center point 0 (see FIG. 12). A table in the upper left corner shows the equivalent rpm and ResF values for each of the indicated angular velocities, along with a couple of equations for obtaining the equivalent rpm and ResF values for any given angular velocity. For example, the table shows that when the set of 8 subassemblies 40 rotates at an angular velocity of 100 rad/sec (954.3 rpm) it generates a vectorially-combined ResF of 1,989.5 lbs. The same table also shows that when the same set of 8 subassemblies 40, rotating at 350 rad/sec (3,342.3 rpm), an impressive combined ResF of 24,370.5 lbs would be generated. As another example of the use of the two above-mentioned rpm and ResF equations, one set of 8 subassemblies 40, rotating at 700 rad/sec (6,684.5 pm), would generate an outwardly-directed, resultant centrifugal force (ResF) of 97,482.1 lbs in each Machine mirror-image half—. and, since there are two such mirror-image halves in the cubic TDMM craft, then the ResF results versus angular velocity presented in FIG. 35 would respectively double.

The plot of ResF results versus angular velocity presented in FIG. 35 really shows the truly amazing power of centrifugal force—which makes it possible for the two counter-rotating sets of 8 variable-length subassemblies 40 in the small-scale, 600-lb cubic TDMM craft's Machine to generate such spectacular motive forces. This kind of spectacular ResF performance is solely due to the innovative use of the variable-length slide 46 (see FIGS. 3, 4 and 5) which, because of its full extension capability (from 2 to 4 ft), enables the Machine to generate such powerful resultant centrifugal forces. However, any angular velocities above 50 rad/sec can only be safely achieved in the Machine by using a more technologically-advanced design of the said “telescoping full extension slide”—one that would be capable of withstanding much greater rotational centrifugal forces than is now possible with the “hardware-store-bought” slide 46 that is now used in the exemplary cubic TDMM craft's Machine.

FIG. 36 presents three plots of resultant centrifugal force (ResF) results as functions of 6, 8 and 10 identical, equally-spaced variable-length subassemblies 40, each rotating at 100 rad/sec about the fixed outer rim's center, point 0, in each Machine mirror-image half's movable inner rim. These three ResF plots show a wide spectrum of resultant centrifugal force results, obtained with three different sizes of rotating sets of subassemblies 40, labeled 1X, 2X and 3X respectively. The 1X plot represents the three 6, 8 and 10-subassembly 40 cases run with a fixed outer rim's radius R0=4 ft, a movable inner rim's radius R1_{W}=3 ft, a variable-length subassembly's radius R3_{W}(which alternatively varies its length from a minimum of 2 ft to a maximum of 4 ft) and with both the 2-wheel device 47 (W) and the bar (slide 46) in each subassembly 40 weighting 1 pound each. The other 2X and 3X plots were obtained with 2 and 3 times the subassembly's variable-length radii and weights used in the 1X plot for the 6, 8 and 10-subassembly 40 cases—representing ResF results obtained with a cubic TDMM craft two and three times the size of the one used in the 1X-plot. For example, in the 2X plot, R0=8 ft, R1_{W}−6 ft, R3_{W} varies between 4 and 8 ft and W and the bar weigh 2 lbs each.

The wide spectrum of ResF results shown in the three plots of FIG. 36, which range from a minimum of 1,493.0 lbs for the 6-subassembly 40 system in the 1X plot to a maximum of 22,381.0 lbs for the 10-subassembly 40 system in the 3X plot, suggests other possible ways for increasing the ResF output of each Machine mirror-image half, besides increasing the angular velocity, as is shown in FIG. 35. For example, the ResF value of 22,381.0 lbs obtained in the 3X plot with 10 subassemblies 40 rotating at 100 rad/sec is about equal to the ResF value obtained with 8 subassemblies 40 rotating at about 330 rad/sec in the plot of FIG. 35.

FIGS. 37 through 40 respectively present different aspects of rotational kinetic energy (KE) results. They were all obtained with the basic rotational KE equation (B10.1), namely:
KE=_{Σ}(1/2)M(Rω₀)²=_{Σ}(1/2)MR²ω₀²=(1/2)Mω₀²_{Σ}R²
in which M and (ω₀ are constant input parameters (see Table 1) and R represents the constant-length radii R1_{W} and R1_{br} for the “neutral position” case (see FIGS. 11 and 19) and the variable-length radii R3_{W} and R3_{br} for the “active position” case (see FIGS. 12 and 20) respectively. These different radii are successively used in the above KE equation to separately calculate the individual KE results for slide 46 (bar), the 2-wheel device 47 (W) and for both W and the bar combined as one assembly 40—the KE results of which are presented in FIGS. 37 and 38.

FIG. 37 presents three constant rotational KE plots, respectively labeled KE0_{br} for the bar (slide 46), KE0_{W} for the 2-wheel device 47 (W) and KE0 for both W and the bar (combined as one subassembly 40) as functions of theta0. Both the bar and the W plots were separately obtained by using the two constant-length radii, R1_{br} for the bar's radius of gyration and R1_{W} for W, both rotating as one unit at 100 rad/sec about superimposed points P, 0 and S in the “neutral position” (see FIG. 19, in which the circular locus of R1_{br} is shoed circle with radius R_{S} which is equal to radius R1_{br}) and center at point S. They each were obtained by using equations (B10.2a), (B10.2b) and (B10.2c), and remain constant at 466.2, 1,398.6 and 1,864.9 ft*lbs respectively.

FIG. 38 presents three variable rotational KE plots, respectively labeled KE1_{br} for the bar (slide 46), KE1_{W} for the 2-wheel device 47 (W) and KE1 for both W and the bar (combined as one subassembly 40) as functions of theta0. Both the bar and the W plots were separately obtained by using the two variable-length radii R3_{br} for the bar's radius of gyration and R3_{W} for W, both rotating as one unit at 100 rad/sec about the fixed, off-center point 0 in the maximum “active position” (see FIG. 20, in which the circular locus of R3_{br} is shown as a dashed circle with radius R_{S} and center at point S). They each were obtained by using equations (B10.3a), (B10.3b) and (B10.3c), and show minimum rotational KE values of 207.2, 621.6 and 628.8 ft*lbs at both theta0=0 degree and 360 degrees and maximum KE values of 828.8, 2,486.5 and 3,315.3 ft*lbs at theta0=180 degrees respectively. Their bell shapes are directly dependent on the variable-length radii R3_{br} and R3_{W} plots in FIG. 23 which, because M and ω₀ are both constant parameters in the above rotational KE equation, cause the plots in this FIG. to vary with R/2)F_{c}, as shown in the expanded rotational equation KE=(1/2)(Mω²R²)=(1/2)(MRω²)R=(R/2)F_{c}, in which F_{c} is the centrifugal force equation (1) for one rotating body.

FIG. 39 shows a graphical representation of the 8 different, equally-spaced (45 degrees apart) rotational KE1 results, obtained from the plot of FIG. 38. They were simultaneously generated by the 8 variable-length subassemblies 40 (see FIG. 12), rotating at 100 rad/sec in the maximum “active position” about the fixed, off-center point 0 (with subassembly #1 shown at 360/0 degree on the inner rim 33) in one Machine mirror-image half only.

FIG. 40 shows two different rotational KE plots as functions of the number of subassemblies 40, from 1 to 8, respectively labeled KE2 and KE3. The KE2 plot represents the 8 cumulatively-added constant KE0 values from FIG. 37 and the KE3 plot represents the 8 cumulatively-added variable KE1 values from FIG. 38 (or FIG. 39), whose values were simultaneously obtained, 45 degrees apart (starting at 0 degree), by the 8 subassemblies 40, rotating in both the “neutral position” (see FIG. 11) and in the “active position” (see FIG. 12) respectively. For example, the first 3 cumulatively-added constant KE0 values from FIG. 37 in the KE2 plot are equal to 5,594.6 ft*lbs and the first 3 cumulatively-added variable KE1 values from FIG. 38 (or FIG. 39) in the KE3 plot are equal 3,497.0 ft*lbs respectively.

However, although FIG. 40 shows that both sets of KE0 and KE1 values shown in the KE2 and KE3 plots are different between the 1 through the 7 cumulatively-added KE0 and KE1 values, they each end up with the same total cumulative KE value of 14,918.9 ft*lbs when their 8th KE0 and KE1 values are added to the KE2 and KE3 plots—and the reason for this is simply because they were both generated by the same set of 8 subassemblies 40, rotating in the “neutral position” in FIG. 11 (with constant-length subassemblies 40) and in the “active position” in FIG. 12 (with variable-length subassemblies 40).

First, before considering a very important aspect associated with the set of 8 variable rotational KE results presented in FIG. 39 and cumulatively-added in the KE3 plot, let's first look at the principle of conservation of angular momentum equation L=Iω), in which ω is the velocity of a body (such as one subassembly 40, rotating about a fixed axis, point 0) and I is its moment of inertia. In the above angular momentum equation, I=MR², in which M is the mass of the rotating body and R is its radius. Therefore, the conservation of angular momentum equation basically says that, in order for L to remain constant when I increases, ω must decrease, and vice versa. However, when returning to the 8 rotational KE1 results shown in FIG. 39 (and in the KE3 plot of FIG. 40), there seems to be quite a different situation in which:
1) although, as shown in FIG. 23, each of the 8 rotating variable-length subassembly 40 shown FIG. 12 continuously changes its radial length R3_{W} as a function of theta0, which should cause ω to change inversely with R3_{W} in order to keep L constant, yet
2) each subassemblies 40 keeps on rotating about the fixed, off-center point 0 with a constant input angular velocity ω₀=100 rad/sec while, at the same time, continually varying its radial length R3_{W}—thereby contradicting the principle of conservation of angular momentum stated above.

Therefore, since the principle of conservation of angular momentum doesn't seem to apply directly to any of the 8 rotational KE1 results, rotating at a constant 100 rad/sec in FIG. 39, one must therefore look more closely at the rotational KE increases and decreases occurring simultaneously in either:
1) the four pairs of anti-parallel KE1 interval increases and decreases shown in FIG. 39 (such as between KE numbers 1 and 2, 5 and 6, 2 and 3, 6 and 7 . . . etc . . . ), or
2) the two larger sets of anti-parallel sets of 4 combined KE1 interval increases and decreases on each side of 180 degrees of FIG. 39 (such as between KE numbers 1 and 5 on one side and KE numbers 5 and 1 on the other side).

For example, first looking at the #1 case above (with the four pairs of anti-parallel KE results), FIG. 39 shows that when subassembly #1 moves to where subassembly #2 is, there is a rotational KE increase of +181.7 ft* lbs, while its anti-parallel subassembly #5 shows a KE decrease of −596.1 ft*lbs when it moves to where subassembly #6 is—which adds up to a KE decrease of −414.4 ft*lbs. Next, when subassembly #2 moves to where subassembly #3 is, there is a KE increase of +647.2 ft*lbs, while its anti-parallel subassembly #6 shows a KE decrease of −1061.5 ft*lbs when it moves to where subassembly #7 is—which adds up to a KE decrease of −414.3 ft*lbs. Similarly, the next two counterclockwise moves of numbered pairs of anti-parallel subassemblies add up to KE increases of +414.4 ft*lbs and +414.3 ft*lbs respectively. Then, when the first two KE decreases are added to the second two KE increases, they add up to exactly 0 ft*lbs.

Next, when looking at the #2 case above, FIG. 39 shows that the two sets of 4 rotational KE1 intervals on each side of 180 degrees, FIG. 39 shows a total KE decrease of −2486.5 ft*lbs (between 180 degrees and 360 degrees) and a total KE increase of +2,486.5 ft*lbs (between 0 degree and 180 degrees), which also adds up to exactly 0 ft*lbs.

Therefore, the above discussion regarding the decreasing and increasing rotational KE results taking place on each side of 180 degrees in FIG. 39 strongly suggests that a transfer of rotational KE is automatically occurring from the decreasing KE side to the increasing KE side, in order to keep the 8 different variable-length assemblies 40 rotating at a constant 100 rad/sec and not violate the principle of conservation of angular momentum. This KE transfer occurs spontaneously through the rigid connection which the 8 variable-length subassemblies 40 make with the 16-inch-radius metal disk 31 and the high-speed hub 44, as they all rotate together as one unit about the stub axle 45 (at the fixed, off-center point 0—see FIGS. 9 and 12) inside the vertical plane of the movable inner rim 33. As a result of this spontaneous KE transfer, both the constant input angular velocity ω₀=100 rad/sec and the total rotational KE of 14,918.88 ft*lbs per revolution (shown in the cumulatively-added KE2 and KE3 plots of FIG. 40) are therefore preserved. It is also therefore logical to conclude that this KE transfer represents a case of self-adjusting conservation of angular momentum as well as of rotational KE, occurring only when the 8 variable-length subassemblies 40 rotate in the “active position” (see FIG. 12) but not in the “neutral position” (see FIG. 11).

Furthermore, as a result of the conservation of both the angular momentum and the total rotational KE mentioned above (from the decreasing KE side to the increasing KE side of FIG. 39), FIG. 40 also indicates that, because both the constant KE2 and the variable KE3 plots show the same total amount of cumulatively-added total rotational KE of 14,918.9 ft*lbs, the set of 8 constant-length subassemblies 40, rotating in the “neutral position” in FIG. 11, and the set of 8 variable-length subassemblies 40, rotating in the “active position” in FIG. 12, are really the same set. That is why, as indicated by the two KE2 and KE3 plots of FIG. 40, this same set of 8 subassemblies 40 produces and stores the same total amount of rotational KE of 14,918.9 ft*lbs per revolution when rotating at 100 rad/sec in either the “neutral position” or in the “active position”—which also means that this same rotating 8-subassemblies 40 system also acts just like a flywheel in both cases.

However, apart from the fact that the set of 8 subassemblies 40 system (in each Machine mirror-image half) generates a total amount of rotational KE of 14,918.9 ft*lbs per revolution when rotating at 100 rad/sec in both the “neutral position” (see FIG. 11) and the “active position” (see FIG. 12), there is a most important difference between the two cases. When rotating in the “active position”, in which the 8 subassemblies 40 all have different radial lengths, they all generate different amounts of centrifugal forces F_{c} which, when vectorially combined (see polygon of FIG. 33) generate a single, outwardly-directed resultant centrifugal force (ResF) of 1,989.4 lbs in any selected direction (from (inside its circular inner rim's vertical plane), but when the same 8 subassemblies 40 rotate in the “neutral position”, in which they all have the same radial lengths, they therefore all generate the same amount of centrifugal forces (F_{c}) which, when vectorially combined (see the polygon of FIG. 33), do not generate any ResF at all in any direction. In summary, since there are two Machine mirror-image halves in the exemplary cubic TDMM craft embodiment, each with a set of 8 subassemblies 40 rotating at 100 rad/sec, then the two sets of 8 subassemblies 40 in the entire Machine generate a combined, single, outwardly-directed ResF of 3,978.8 lbs in the “active position” case only, but store a total, combined rotational KE of 29,837.8 ft*lbs per revolution in both the “active position” and the “neutral position” cases.

Finally, when the selected direction of the Machine's total ResF of 3,978.8 lbs (generated in the vertical planes of both movable circular inner rims 33 and 35 by the two counter-rotating sets of 8 subassemblies 40) is combined with the chosen horizontal direction (azimuth) of the rotatable internal housing frame 13 (in which the Machine is enclosed), a steerable, variable and powerful motive force is then made available (see FIGS. 42 and 46) for propelling the small-scale, 600-lbs cubic TDMM craft of the invention with unparalleled performance and maneuverability in three dimensions, anywhere on earth and in outer space.

Discussion of the Cubic TDMM Craft Performance Results

As stated in the “Brief Description of the Drawings” section, FIGS. 41 through 48 present 8 sets of performance result plots of the 600-lb cubic TDMM craft as functions of vertical altitude (distance) from earth. In order to do the many calculations required to obtain these 8 sets of performance result plots, I wrote a computer program in QBASIC named PRFMEVL (for performance evaluation), which incorporates equations C1 through C11, into which the appropriate input parameters from Table 2 were used.

These 8 sets of cubic TDMM craft performance result plots are divided into two separate groups of 4 sets each—with the 4 sets in each group respectively representing the cubic TDMM craft's average acceleration (A_{cc}), motive force (F_{cc}), instantaneous velocity at time Tₑ from earth launch (Vₑ) and average flight time (T_{cc}) from earth launch time as functions of vertical “near-earth” altitude in the first group and “far-earth” distance from earth in the second group.

The first group of 4 sets of “near-earth” performance results are presented in FIGS. 41 through 44, in which they are plotted every 10 miles of vertical altitude from the earth's surface up to 250 miles in the direction of the moon. The second group of 4 sets of “far-earth” performance results are presented in FIGS. 45 through 48, in which they are plotted every 5,000.0 miles of vertical distance from the earth's surface all the way to the moon, 230,000.0 miles away.

FIGS. 41 through 48 each show 3 plots of cubic TDMM craft's performance results, respectively labeled 50, 75 and 100 rad/sec. As indicated in Table 2, these 3 angular velocities were first used in SOUCVOL (using the proper sequence of equations B1a through B8c) to calculate the three cubic craft's constant resultant centrifugal motive forces (ResF) of 995.0, 2,238.1 and 3,979.8 lbs (respectively generated by the Machine's two sets of 8 subassemblies 40) that were used in the PRFMEVL program to obtain all the various cubic TDMM craft's performance result plots for each of the three 50, 75 and 100 rad/sec plots as functions of both the “near-earth” altitude and “far-earth” distance from earth.

The combined effects of both the earth's negative gravitational acceleration (gₑ) and its associated force of gravity (Fₑ) and of the moon's positive gravitational acceleration (gₘ) and its associated force of gravity (Fₘ), the equations of which are given in Table 2, are included in the cubic TDMM craft A_{cc}, F_{cc}, Vₑ and T_{cc} performance plots presented in both groups of “near-earth” (see FIGS. 41 through 44) and “far-earth” (see FIGS. 45 through 48) as a function of the distance from earth. For example, the three 50, 75 and 100 rad/sec cubic TDMM craft motive force plots (F_{cc}) of FIGS. 42 and 46 show how the three input cubic TDMM craft constant ResF values of 995.0, 2,238.1 and 3,979.8 lbs given in Table 2 are each affected by the combined earth and moon gravities as functions of altitude and distance from earth—thereby causing two different stages of cubic TDMM craft motive force in the three “near-earth” angular velocity plots of FIG. 42 and three different stages of cubic TDMM craft motive force in the same three “far-earth” angular velocity plots of FIG. 46.

Although the cubic craft average flight time T_{cc} (see equation C11) is used in the three 50, 75 and 100 rad/sec plots of FIGS. 44 and 48, as a function of vertical altitude (distance) from earth, a second elapsed flight time from earth, Tₑ (see equation C7), is also derived and used in PRFMEVL to do several important initial calculations that are needed to obtain a more representative time T_{cc}. This second Tₑ equation is derived from the standard rectilinear motion equation X=0.5 AT², in which X represents the distance traveled by a body under a constant acceleration A after a given time interval T has elapsed from launch time (at T=0 sec). Then, after substituting the elapsed flight time Tₑ for T, the vertical altitude (distance) ALT1 for X and the instantaneous acceleration Aₑ for A into the above standard rectilinear motion equation and solving for Tₑ finally gives equation C7, namely: Tₑ={square root over (()}ALT1/0.5Aₑ.

The reason why T_{cc} was selected for plotting rather than Tₑ is because T_{cc} gives a more representative and accurate cubic TDMM craft flight time as a function of vertical altitude (distance) from earth than Tₑ does. First, let's look at how the equation for Tₑ was obtained and how it is used in PRFMEVL to develop the equation for T_{cc}, and then compare their flight time results. Starting with equation C5, notice that the cubic craft motive force F_{cc}=(Fₑ+ResF+Fₘ) directly depends for its value on the combined, variable effects (see FIGS. 42 and 46) of both the earth's negative force of gravity Fₑ(see equation C3) and the moon's positive force of gravity Fₘ(see equation C4) on its constant resultant centrifugal force ResF (see Table 2)—thereby causing the cubic craft motive force F_{cc} to also vary as a function of vertical altitude (distance) from earth launch time. This variable F_{cc} is next used in equation C6 to obtain the cubic craft's instantaneous acceleration Aₑ, thereby causing Aₑ to also vary—which contradicts the proposition that acceleration A in the standard rectilinear motion equation is supposed to be constant. Finally, this variable acceleration Aₑ is then used in equation C7 to obtain Tₑ, which represents the instantaneous elapsed time from earth launch time (at Tₑ=0 sec) to any given vertical altitude (distance) from earth. But, since Tₑ's value depends on the variable (non-constant) acceleration Aₑ, it does create a little problem when plotted as a function of vertical altitude (distance) from earth—because the calculated elapsed time Tₑ can end up being a little smaller than the average flight time T_{cc} at a longer distance from earth (where the variable instantaneous acceleration Aₑ is greater) and be a little larger at a shorter distance from earth, where Aₑ is smaller (which is an impossibility). Thus, in order to avoid this little problem associated with Tₑ, a more representative and more accurate flight time equation was developed for use in the plots of FIGS. 44 and 48, namely: the cubic craft average flight time T_{cc}(see equation C11).

As indicated in equation C11, this second cubic TDMM craft average flight time from earth, T_{cc}, represents the cumulative addition of all the average flight times, Tₐᵥ, that are separately calculated, at the start of each new PRFMEVL iteration, in each successively incremented range interval Rinc (see Table 2)—which, as shown in the Tₐᵥ equation C10, depend on the two variable A_{cc}(see equation C9) and Vₑ(see equation C8) for their values in each successive range increment Rinc.

The Tₐᵥ equation is derived from the second equation of motion V=V₀+AT, in which V₀ is the initial velocity of a body at an earlier time (such as at the beginning of each incremented range interval Rinc), V is its velocity at a later time (such as at the end of each incremented range interval Rinc) and A is its average acceleration in each successive range Rinc. Then, after substituting the instantaneous velocities Vₑ₀ and Vₑ for V₀ and V, the average cubic craft acceleration A_{cc}(see equation A9) for A and Tₐᵥ for T in the above second equation of motion gives equation Tₐᵥ=((Vₑ−Vₑ₀)5280)/A_{cc}(in which, because both Vₑ and Vₑ₀ are in miles/sec and A_{cc} is in ft/sec², 5280 ft/sec was added to the equation to obtain Tₐᵥ in secs). This Tₐᵥ equation can then be used to get the average flight time Tₐᵥ value required by the cubic TDMM craft to go through each successive range interval Rinc. Thus, by cumulatively adding each successive Tₐᵥ value to the previously-obtained average cubic craft flight time equation T_{cc}=(T_{cc}+Tₐᵥ) as a function of vertical altitude (distance) from earth (see the cubic craft T_{cc} plots of FIGS. 44 and 48), gives a T_{cc} value representing a more accurate cubic craft average flight time from earth than does the elapsed time Tₑ(see equation C7)—which, as explained earlier, depends for its value on the calculated instantaneous, variable acceleration Aₑ(see equation C6) as a function of altitude (distance) from earth launch time (at Tₑ=0 sec). For example, to show the above-mentioned small difference between the elapsed flight time Tₑ and the more accurate and representative cubic craft average flight time T_{cc} required to go from earth to the moon, the following Tₑ values were calculated for both the 230,000 mile and 225,000 mile “far-earth” distances from earth—and then compared with the T_{cc} values at those same distances on the 50 rad/sec plot of FIG. 48.

To begin with, using the F_{cc} value of 1,094.0 lbs at 230,000 miles (from the 50 rad/sec plot of FIG. 46) and the 600-lb cubic craft's mass, M_{cc}=18.6486 slugs (from Table 2) in equation C6, gives an instantaneous acceleration Aₑ of 58.7 ft/sec² which, when used in equation C7, gives a Tₑ value of 6,432.5 seconds to go to the 230,000 mile distance from earth to the moon, versus an average flight time T_{cc} value of 6,840.9 seconds (see the 50 rad/sec plot of FIG. 48) to go 230,000 miles from earth to the moon—which represents a small flight time difference of 408.4 seconds (6.81 minutes) between the two Tₑ and T_{cc} times. Finally, as shown in FIG. 48, the T_{cc} of 6,840.9 seconds fits better on the 50 rad/sec plot than would the Tₑ of 6,432.5 seconds (which would instead cause the 50 rad/sec plot to dip between the 250,000-to-230,000 distance from earth—indicating a shorter Tₑ elapsed flight time from earth to go to 230,000 miles than it would to go to 225,000 miles).

Furthermore, because the cubic craft's acceleration A_{cc} is shown to be fairly constant in the 10,000-to-225,000 miles of the “far-earth” middle range distance from earth (see FIG. 45), then Aₑ should also be about equal to A_{cc} in that same middle range—which also mean that, as shown in FIG. 46, because both the moon's force of gravity Fₘ and the earth's force of gravity Fₑ on the cubic craft are practically non-existent in that same “far-earth” middle range from earth, then both the constant cubic TDMM craft's acceleration A_{cc} and motive force F_{cc} can be used to determine the average flight time T_{cc} required to go anywhere into deep space—such as to the planet Mars. For example, from the 50 rad/sec plots of FIG. 45 and 46, the cubic TDMM craft's constant average acceleration A_{cc} of 53.4 ft/sec² and constant motive force F_{cc} of 994.3 ft/sec²(found at the half-way “far-earth” distance between the earth and the moon) can be used to calculate the cubic craft's flight times T_{cc} required for a one-way trip to the planet Mars, and safely land there on its surface (as is later done and shown in ¶ 0214).

FIG. 41 presents five acceleration plots as functions of “near-earth” vertical altitude up to 250 miles in the direction of the moon. The first three plots represent the cubic TDMM craft's average accelerations A_{cc}, which were obtained with equation C9 for each of the three indicated 50, 75 and 100 rad/sec plots. The other two plots represent the moon's positive acceleration of gravity gₘ(see equation C2) and that of the earth's negative acceleration of gravity gₑ(see equation C1) on the cubic craft—the combined effects of which are included in the above three cubic craft A_{cc} plots as functions of “near-earth” vertical altitude. For example, with the successive uses of equations C1 through C9, an A_{cc} value of 21.34 ft/sec² is shown on the 50 rad/sec plot at a “near-earth” vertical altitude of 10 miles.

The three cubic TDMM craft A_{cc} plots of FIG. 41 show two different stages of acceleration versus “near earth” vertical altitude. In the first stage, all three 50, 75 and 100 rad/sec plots show rapid acceleration increases between 0 and 10 miles from earth, at which point they level off and enter the second stage, in which they show gradual acceleration increases all the way up to 250 miles. The reason for these initial rapid A_{cc} increases in the first acceleration stage is because, just before the start of the cubic craft's vertical ascent, the Machine part of the TDMM was being operated in the “neutral position” (with an A_{cc} of 0 ft/sec²), during which it was just resting on the earth's surface, held down by the earth's negative force of gravity. Then, immediately after the Machine's maximum “active position” (see FIGS. 12, 13 and 14) was activated, the three cubic craft accelerations suddenly kicked in (see the 50, 75 and 100 rad/sec plots) and quickly overcame the initial effects of the negative earth's gravity (see the gₑ plot) on the cubic craft, thus causing the three A_{cc} plots to show rapid increases in the 0-to-10 mile “near-earth” vertical altitude range, at which point they level off, after having achieved their respective constant A_{cc} accelerations (obtained with the sequential uses of equation C5 through C9). In the second acceleration stage, the three A_{cc} plots only show gradual increases the rest of the way up to 250 miles, where they respectively end up with A_{cc} values of 28.16, 94.82 and 188.22 ft/sec² on their indicated angular velocity plots.

FIG. 42 presents five force plots as functions of “near-earth” vertical altitude up to 250 miles in the direction of the moon. The first three plots represent the cubic TDMM craft's motive force F_{cc}, which were obtained with equation C5 for each indicated 50, 75 and 100 rad/sec plots. The other two plots respectively represent the moon's positive force of gravity Fₘ (see equation C4) and that of the earth's negative force of gravity Fₑ(see equation C3)—the combined effects of which are included in the three F_{cc} plots as functions of “near-earth” vertical altitude. For example, FIG. 42 shows a cubic TDMM craft motive force F_{cc} of 398.0 lbs on the 50 rad/sec plot at a “near-earth” vertical altitude of 10 miles from earth.

The three F_{cc} plots were all obtained by first using equation C3 and C4 to calculate the F_{g} and Fₘ values as functions of altitude which, along with the appropriate constant ResF values from Table 2(see ¶ 0149), were then used in equation C5. Just like in the three A_{cc} plots of FIG. 41, the three F_{cc} plots show two different stages of motive force versus “near earth” vertical altitude. In the first stage, rapid motive force increases are shown between the 0 mile and the 10 mile from earth, at which point they level off and only show gradual increases as functions of vertical altitude the rest of the way up to 250 miles from earth, where they respectively end up with F_{cc} values of 464.3, 1,707.4 and 3,449.1 lbs on their indicated angular velocity plots. The three motive force F_{cc} calculations were obtained for a small-scale 600-lb cubic TDMM craft. As in FIG. 41, the reason for the three rapid F_{cc} increases in the first stage is because the cubic TDMM craft was initially in the “neutral position” (with an F_{cc} of 0 lb) and, when the Machine's maximum “active position” (see FIGS. 12, 13 and 14) was activated, the three cubic crafts' motive forces suddenly kicked in (see the 50, 75 and 100 rad/sec plots) and quickly overcame the initial effects of the earth's negative force of gravity (see the Fₑ plot) on the cubic craft, thus causing the three F_{cc} plots to show rapid increases in the 0-to-10 vertical altitude range, at which point they level off—after having achieved their respective constant F_{cc} motive forces (obtained with equation C4).

FIG. 43 presents three plots of the cubic TDMM craft velocity Vₑ as functions of “near-earth” vertical altitude from the earth, up to 250 miles in the direction of the moon. They represent the cubic craft's instantaneous velocities that were obtained with equation C8 for each of the three 50, 75 and 100 rad/sec plots indicated. They respectively show velocities of 1.54 miles/sec (5,544 miles/hr), 2.94 miles/sec (10,584.0 miles/hr) and 4.19 miles/sec (15,084.0 miles/hr) at the 250 mile vertical altitude from earth.

FIG. 44 presents three plots of the cubic TDMM craft average flight time T_{cc} as functions of “near-earth” vertical altitude from the earth, up to 250 miles in the direction of the moon. They represent the cubic craft's T_{cc} average flight times that were obtained with equation C11 for each of the three 50, 75 and 100 rad/sec plots indicated. Each T_{cc} value on the three plots represents the sum of all the flight time Tₐᵥ values (see equation C10) obtained at each successive range increment Rinc as a function of vertical altitude. The 50, 75 and 100 rad/sec respectively show that it took the cubic craft 342.9 sec (5.72 min), 172.1 sec (2.88 min) and 120.3 sec (2.01 min) to get to the 250 mile altitude from earth.

FIG. 45 presents five acceleration plots as functions of “far-earth” distance from the earth to the moon's surface, 230,000 miles away. The first three plots represent the cubic TDMM craft's average acceleration A_{cc}, which were obtained with equation C9 for each of the three indicated 50, 75 and 100 rad/sec plots. The other two plots represent the moon's positive acceleration of gravity gₘ(see equation C2) and that of the earth's negative acceleration of gravity gₑ(see equation C1) on the cubic craft—the combined effects of which are included in the above three A_{cc} plots as functions of “far-earth” distance from earth. For example, an A_{cc} of 54.5 ft/sec², which was obtained with the successive uses of equations C1 through C9, is shown on the 50 rad/sec plot at the 220,000 mile distance from earth (or 10,000 miles from the moon).

The three TDMM cubic craft A_{cc} plots in FIG. 45 show three different stages of acceleration versus “far-earth” distance from earth. In the first stage, rapid acceleration increases are shown between 0 and 5,000 miles from earth, at which point they begin to slow down and level off at about 10,000 miles from earth, with A_{cc} values of 54.5, 121.1 and 214.5 ft/sec² on their indicated 50, 75 and 100 rad/sec plots. In the second stage, between about 10,000 miles and about 220,000 miles from earth, the three 50, 75 and 100 rad/sec A_{cc} plots respectively appear to remain fairly constant at around 53.4, 120.1 and 213.4 ft/sec² until, at about 220,000 miles from earth, when the moon's gravity begins to act on the cubic craft, they begin to show gradual increases between 220,000 and 225,000 miles. Finally, in the third stage, the three A_{cc} plots again show rapid increases between 225,000 and 230,000 miles from earth (or during the last 5,000 miles to the moon's surface), where they respectively show final A_{cc} values of 290.6, 375.3 and 450.7 ft/sec² at the 50, 75 and 100 rad/sec plots.

These three distinct and different acceleration stages in the three A_{cc} plots of FIG. 45 are the results of the combined effects of:
1) the earth's negative gravity which, as indicated by the gₑ plot, rapidly decreases from −32.174 ft/sec² at 0 miles (the earth's surface) to about 0 ft/sec² at about 20,000 miles from earth and remains practically non-existent the rest of the way to the moon, and
2) the moon's gravity which, as indicated by the gₘ plot, is almost non-existent until about 225,000 miles from earth (or 5,000 miles from the moon), at which point it begins to rapidly increase until it reaches 5.32 ft/sec² at the moon's surface (which is about 6 times less than the force of gravity gₑ at the earth's surface).

FIG. 46 presents five force plots as functions of “far-earth” distance from the earth's surface to the moon's surface, 230,000 miles away. The first three plots represent the cubic TDMM craft's motive force F_{cc} which were obtained with equation C5 for each indicated 50, 75 and 100 rad/sec plot. The other two plots respectively represent the moon's positive force of gravity Fₘ(see equation C4) and that of the earth's negative force of gravity Fₑ(see equation C3), the combined effects of which are included in the three 50, 75 and 100 rad/sec F_{cc} plots as functions of “far-earth” distance from earth. For example, FIG. 46 shows a cubic craft F_{cc} of 878.1 lbs on the 50 rad/sec plot at the 5,000 mile “far-earth” distance from earth. The three F_{cc} plots were obtained by first using equations C3 and C4 to calculate the Fₑ and Fₘ as functions of distance from earth which, along with the appropriate ResF values from Table 2, were used in equation C5.

The three cubic craft motive force F_{cc} plots in FIG. 46 also show three different stages of motive force versus “far-earth” distance from earth. In the first stage, rapid force increases are shown from 0 mile to about 5,000 miles, at which point they begin to slowly decrease until about 20,000 miles from earth, where they level off. In the second stage, between about 20,000 and 225,000 miles from earth, they appear to remain fairly constant at around 994.3, 2237.4 and 3979.1 lbs on their respective 50, 75 and 100 rad/sec plots (which are all very close to the three constant ResF values of 995.0, 2,238.1 and 3,079.8 lbs presented in Table 2—indicating that the gravitational forces of both the earth and the moon are practically non-existent in that “far-earth” middle range). Finally, in the third stage, the three F_{cc} plots again show small increases from 225,000 to 230,000 miles (or from 5,000 miles from the moon's surface), which are due to the moon's force of gravity Fₘ on the 600-lb cubic craft, which increases from about 0.0084 lbs at 225,000 miles from earth to 99.21 lbs at the moon's surface. For example, the 50 rad/sec F_{cc} plot increases from 997.9 lbs at 225,000 miles from earth to 1,094.0 lbs at the moon's surface.

FIG. 47 presents three cubic TDMM craft velocity Vₑ plots as functions of “far-earth” distance from the earth's surface all the way to the moon, 230,000 miles away. They represent the cubic craft's instantaneous velocities that were obtained for the three indicated 50, 75 and 100 rad/sec plots, using equation C8. The three 50, 75 and 100 rad/sec plots also indicate that the cubic craft achieved instantaneous velocities Vₑ of 71.49, 104.49 and 138.0 miles/sec respectively at the moon's surface.

FIG. 48 presents three cubic TDMM craft average flight time T_{cc} plots as functions of “far-earth” distance from the earth's surface all the way to the moon, 230,000 miles away. The T_{cc} plots were obtained with equation C11, in which the average flight times Tₐᵥ values (see equation C10), which were separately obtained in each successive range increment Rinc, were cumulatively-added to the T_{cc} value as a function of “far earth” distance from earth. The 50, 75 and 100 rad/sec plots respectively show that it took the cubic craft 6,840.9 sec (1.9 hrs), 4,525.2 sec (1.26 hrs) and 3,384.6 sec (0.94 hr) of average flight times T_{cc} to get to the moon from earth.

The spectacular performance of the small-scale, wingless and tailless 600-lb cubic TDMM craft is most graphically illustrated in both the “near-earth” and “far-earth” velocity and flight time plots. For example, the three 50, 75 and 100 rad/sec plots of FIG. 44 respectively show that it takes the cubic craft 342.9 seconds (5.72 minutes), 172.1 seconds (2.87 minutes) and 120.3 seconds (2.01 minute) of average flight time (T_{cc}) to reach a vertical altitude of 250 miles where, according to the three 50, 75 and 100 rad/sec plots of FIG. 43, the cubic craft achieves final instantaneous velocities Vₑ of 1.54 miles/sec (5,544 miles/hr), 2.94 miles/sec (10,584 miles/hr) and 4.19 miles/sec (15,084.0 miles/hr). Similarly, the three 50, 75 and 100 rad/sec plots of FIG. 48 respectively show that it takes the said cubic craft 6,840.9 seconds (1.9 hrs), 4,525.2 seconds (1.257 hrs) and 3,384.6 seconds (0.94 hrs) of average flight time (T_{cc}) to reach the moon, 230,000 miles away where, according to the three 50, 75 and 100 rad/sec plots of FIG. 47, the cubic craft achieves final instantaneous velocities (Vₑ) of 71.49 miles/sec (257,364.0 miles/hr), 104.49 miles/sec (376,164.0 miles/hr) and 138.0 miles/sec (496,800.0 miles/hr).

However, rather than “crash” the cubic TDMM craft on the moon's surface, a more realistic and practical approach would be, as indicated by the 50 rad/sec plot in both FIGS. 48 and 47, to go to the half-way 115,000-mile-distance between the earth and the moon in 4,866.3 seconds (1.35 hours), where it would have an instantaneous velocity of 48.19 miles/sec (137,484.0 miles/hour), and then reverse the cubic craft's constant acceleration of about 53.4 ft/sec²(see FIG. 45), in order to cause the cubic craft to decelerate the rest of the way to the moon and safely land on its surface in less than 3.0 hours of total flight time from earth.

Furthermore, using only the slower angular velocity of 50 rad/sec, both FIGS. 44 and 43 respectively indicate that the cubic craft would reach the “near-earth” vertical altitude of 250 miles in 342.9 seconds (5.72 minutes) and have a velocity of 1.54 miles/sec (5,544.0 miles/hour)—at which point the cubic craft's direction would be changed to put it in an earth orbit, in which it would continue to accelerate until the proper orbital velocity has been achieved.

Finally, the ultimate space travel challenge for the cubic TDMM craft would be to go the planet Mars, when it is closest to earth (at a distance of about 35 million miles away—where the gravitational forces from both the earth and the moon are non-existent). For example, just to get an idea of how long it would take for the said cubic craft to go to Mars, let's first go to Table 2, in which the cubic craft's Machine-generated ResF of 995 lbs at 50 rad/sec and its mass M_{cc} of 18.65 slugs are listed and use them in equation C6, to obtain a deep space acceleration Aₑ of 53.36 ft/sec²(which is about equal to the cubic craft constant acceleration A_{cc} of 53.4 ft/sec² at the “far-earth” middle range distance on the 50 rad/sec plot of FIG. 45). This Aₑ value can now be used in equation C7, along with an ALT1 value of 9.2410 ft (which is the half-way above-mentioned distance of about 17.5 million miles between the earth and Mars) to obtain a cubic craft elapsed flight time Tₑ of about 58,850 seconds (or 16.35 hours) needed to get half-way to Mars. Next, using both the above Aₑ and Tₑ values in equation C8, yields a spectacular cubic craft's velocity Vₑ of about 595 miles/sec (or 2,141,070.0 miles/hour) at that half-way distance to Mars. Then, at the half-way distance to Mars, the deep space, constant acceleration Aₑ is reversed, to act in the opposite-direction, thereby causing the cubic craft to gradually decelerate at the same Aₑ of 53.36 ft/sec² during the remaining 17.5 million miles to Mars and safely land on it after about 33.0 hours of flight time from earth.

The above cubic TDMM craft spectacular “far-earth” average flight times of 3.0 hrs to go to the moon and 33 hrs to go to Mars assume the availability of a constant source of electrical power (obtainable from a combination of batteries and solar cells and/or from other sources, including nuclear), in order for the TDMM's Machine to continuously be able to propel the 600-lb small-scale cubic craft with the same constant motive force of about 995 lbs at 50 rad/sec (see FIG. 44 and Table 2) during both “far-earth” and deep space flight durations.

However, the primary purpose of the “near-earth” and “far-earth” performance plots presented in FIGS. 41 through 48 is to illustrate the spectacular and unmatched capability of the cubic TDMM craft invention—which is only made possible by the combined, innovative use of three simple, basic component parts, working together as one unit in each cubic TDMM craft's Machine mirror-image half, namely:
1) a fixed, 96-inch-diameter circular outer rim (see FIG. 10),
2) a movable circular 72-inch-diameter inner rim (see FIG. 8) and
3) a commercially-available telescoping full extension slide 46 (see FIGS. 3, 4 and 5).
   As previously mentioned, the outer rim in (1) above acts as a fixed circular boundary for the movable inner rim in (2) above, which in turn, acts as a circular track for the 2-wheel device 47, which is mounted at the telescoping end of slide 46 in (3) above, which both make up one variable-length subassembly 40 (see FIG. 9).

As a result of the combined use of the different functions of the above-mentioned three parts working together as one unit, when the inner rim in each Machine mirror-image half is moved from its “neutral position” (in which the lengths of all the 8 subassemblies 40 are all equal to the inner rim's radius—see FIG. 11) to its maximum “active position” (in which the 8 variable-length subassemblies 40 now all have different lengths—see FIG. 12) to make contact with the inside surface of the outer rim, it then causes these 8 subassemblies 40 to generate 8 different centrifugal forces F_{c} as functions of their angle of rotation theta0(see FIG. 31). Then, as they rotate about the fixed, off-center point 0 (see FIG. 32), these 8 different F_{c} forces automatically vectorially combine into one single, outwardly-directed resultant centrifugal force ResF—always pointing in the selected direction in which the inner rim is making contact with the outer rim. For example, as shown in the polygon of FIG. 33, the 8 different F_{c} forces shown in FIG. 32 vectorially combine into one single, resultant centrifugal force ResF of 1,989.4 lbs (shown as a heavy black arrow pointing from the tail of the first triangle's Fₐ force to the head of the seventh triangle's F_{b} force) in the 180-degree direction. Furthermore, since there are two such identical Machine mirror-image halves (separated by the central plate 15 inside the parallelepiped internal housing frame 13—see FIGS. 2 and 51), each with a set of 8 rotating subassemblies 40, then the entire Machine therefore generates a total maximum ResF of 3,978.8 lbs (in that same 180-degree direction).

As shown in FIGS. 1, 2, 51 and 53, the internal housing frame 13 (in which the Machine is enclosed) is freely horizontally rotatable about the vertical central axis 14 towards any selected direction (azimuth) inside the larger outer cubic frame 10. Finally, when the selected direction of the above-mentioned, Machine-generated total maximum ResF of 3,978.8 lbs is combined with the chosen direction (azimuth) of the rotatable internal housing frame 13, a single, steerable and powerful motive force is then made available for propelling the 600-lb cubic TDMM craft model of the invention with spectacular unparalleled performance and maneuverability in three dimensions, anywhere on earth and in outer space.

As noticeable, the above-mentioned steerable, total motive force of 3,978.8 lbs (generated at 100 rad/sec in the Machine) is considerably more than is required to propel the 600-lb cubic TDMM craft in three dimensions, and is also considerably more than is available from the three most-closely related inventions (presented in the “Discussion Of The Related Arts” section) which, as far as I can understand, are at best really limited to two dimensions—even though their inventors suggest the possibility of being able to develop a single resultant force along any selected directions in three dimensions by simply doing, or adding, one thing or another, to their inventions (without showing and/or explaining how to do it), which they leave to others to figure out, as is the case in the following three most-closely-related patents:
1) U.S. Pat. No. 5,488,877—in which Richard L. Lieurance claims that, when using four cells in his “centrifugal inertia drive” it can generate a unidirectional force of 120.0 lbs at 600 rpm,
2) U.S. Pat. No. 5,782,134—in which James D. Booden claims that his “electromagnetically actuated thrust generator” is capable of generating a net thrust of 82.43 lbs of force at 1200 rpm, and
3) U.S. Pat. No. 5,860,317—in which Eric Laithwaite et al do not provide any gyroscopically-generated propulsion force results.
   Description of the Cubic TDMM Craft and its Operation

The above-mentioned cubic TDMM craft of the invention basically consists of an external cubic framework 10, a parallelepiped internal housing frame 13 (see FIGS. 1, 2, 51 and 52) and a variable, steerable centrifugal force generating Machine (which, as shown in FIGS. 51 and 52, is enclosed in the internal housing frame 13). The Machine's two sets of 8 variable-length subassemblies 40, counter-rotating at 100 rad/sec, can generate a combined, outwardly-directed, maximum resultant centrifugal force (ResF) of 3,978.8 lbs in any one of the 360-degree directions inside the vertical planes of their respective circular inner rims 33 and 35 (which depends on the selected direction in which the inner rims make contact with the inside surfaces of their respective outer rims—see FIGS. 12, 13 and 14).

FIG. 1 presents a simplified three-dimensional view of the cubic TDMM craft model, showing the relationship between the external cubic frame 10 and the internal housing frame 13 (shown as a dashed parallelepiped enclosed inside the external cubic frame 10). The internal housing frame 13 is horizontally rotatable in either direction about a vertical central axis 14 (shown as a vertical dashed line, running between the centers of both the top and the bottom heavy-duty swivel assemblies 11 and 12) towards any selected direction (azimuth} inside the larger external cubic frame 10 (see FIGS. 1, 2, 51 and 53)—thereby causing the enclosed Machine to rotate with it. Also notice that, in this diagram, the external cubic frame 10 is wingless and tailless, which means that the cubic TDMM craft can propel itself in any desired direction in three dimensions (in any atmospheric environment and in the void of outer space) by simply using its internally-built variable, steerable motive force TDMM mechanism.

FIG. 2 presents another simplified, top-view cutaway diagram of the cubic TDMM craft, showing the relationship between the external 100-inch cubic frame 10, the 96×24-inch rectangular top-end of the parallelepiped internal housing frame 13 and the top swivel assembly 12 (which, as shown in FIGS. 51 and 52, is sandwiched between the top centers of both the external cubic frame 10 and of the internal housing frame 13). A top-view of the 100-inch-diameter alternate external cylindrical frame 60 is also shown in this diagram as a dashed circle inscribed inside the external cubic frame 10 (inside of which the internal housing frame 13 is also freely rotatable about the central axis 14 in either direction without any interference). The external cylindrical frame 60 is intended for use as a replacement for the external 100-inch cubic frame 10 in a future application of the basic invention presented in FIG. 54.

FIG. 2 also shows that the parallelepiped internal housing frame 13 is divided into two equal halves (numbered 16A on the left and 16B on the right), separated by the central square plate 15. The Machine (which is enclosed inside the internal housing frame 13) is also divided into two identical, mirror-image halves (with one half in each internal housing frame's half side).

Each Machine mirror-image half consists of two separate and different major functional parts, namely: 1) a two-dimension, all-way movable mechanism 49 mirror-image half (comprised of parts shown in FIGS. 6, 7 and 8) and 2) a set of 8 variable-length subassemblies 40 (see FIGS. 9, 11 and 12), rotating about the fixed point 0. These two major Machine parts are designed to work together as one integrated unit to generate a single, outwardly-directed, variable resultant centrifugal force (ResF) in any desired direction inside the vertical, two-dimensional plane of each movable, circular inner rim in each Machine mirror-image half.

For simplification of the exemplary embodiment, most of the following figures and accompanying write-ups are about the left side A of the Machine's mirror-image half only (see FIGS. 13, 50 and 51), because the other right side B half is an identical mirror-image half.

As previously described with the aid of FIGS. 1 through 15, the Machine's left side A half basically consists of three parts, working together as one unit, namely:
1) a set of 8 identical, evenly-spaced, variable-length (telescoping) subassemblies 40 (each with a 2-wheel device 47 mounted at its moving end and with its other fixed end securely mounted onto a 16-inch-radius disk 31—see FIG. 9), in which the 8 subassemblies continually vary their lengths (from a fully closed 24 inches to a fully opened 48 inches—see FIGS. 3, 4 and 23) as they rotate in the “active position” about the fixed, off-center axis at point 0 (see FIG. 12),
2) a movable 72-inch-diameter circular inner rim 33 (see FIG. 8), which acts as a movable, circular track for the 2-wheels 47 mentioned in (1) above (and which is also an integral part of the mirror-image half of the two-dimension movable mechanism 49), and
3) a 96-inch-diameter, fixed circular outer rim 34 (see FIG. 10), which acts as a fixed circular boundary for (2) above, and which is vertically-mounted on the inside surface of the internal housing frame's left side 16A half (see FIG. 2).

The two-dimension, all-way movable mechanism in (2) above basically consists of one vertically-moving square plate 25 (see FIG. 7) and of one horizontally-moving square plate 29, on which, as shown in FIG. 8, circular inner rim 33 is mounted inscribed on its opposite side (away from the central square plate 15). The purpose of the all-way movable mechanism 49 is to variably move plate 25 vertically and plate 29 horizontally (together or independently), in order to position inner rim 33 (see FIG. 8) anywhere inside the vertical plane of the fixed, circular outer rim 34 (namely, to position it at any distance and direction from its “neutral position”, at the center of the vertical plane of outer rim 34, up to its maximum “active position”, in which, as shown in FIG. 12, it is making contact with the inside surface of outer rim 34 at 180 degrees). When the inner rim is in its “active position”, the 8 evenly-spaced subassemblies 40 mentioned in (1) above continually vary their lengths as functions of their angle of rotation theta0(see FIG. 23) which, in turn, causes them to simultaneously generate 8 different resultant centrifugal forces F_{c}, also as functions of their angle of rotation theta0(see FIGS. 31 and 32). Then, as shown in the polygon example of FIG. 33, the 8 different F_{c} forces shown in FIG. 32 automatically combine into one single, outwardly-directed, variable and smooth resultant centrifugal force (ResF), which is always pointing in the same selected direction in which inner rim 33 is closest to, or is making contact with, the inside surface of outer rim 34. The direction of the vectorially combined ResF shown in FIG. 33 was arbitrarily selected to be at 180 degrees, but could also have been selected to be at 225 degrees—and still have the same ResF results. Finally, by combining the above-mentioned selected direction of the outwardly-directed, vectorially combined ResF with the chosen horizontal direction (azimuth) of the internal housing frame 13 (and its enclosed Machine), which is established by rotating the internal housing frame 13 about its vertical axis 14 (see FIGS. 1 and 2), a steerable and variably powerful motive force is then available for propelling the cubic TDMM craft in any desired direction in three dimensions with unparalleled performance (see FIGS. 41 through 48) and maneuverability anywhere on earth and in outer space.

Due to the 24-inch difference between the 72-inch-diameter of inner rim 33 and the larger 96-inch-diameter of outer rim 34 (see FIGS. 8 and 10), inner rim 33 can only be moved a maximum distance of up to 12 inches in any direction from its “neutral position”. In other words, as shown in FIG. 8, the center of inner rim 33 (point P) can only be moved up to a maximum distance of 12 inches from the fixed center point 0 of outer rim 34 in any chosen direction within the small 12-inch-radius dashed circle 32. For example, FIG. 12 shows that when point P is vertically moved the entire 12 inches up from the fixed point 0 to the horizontal “+0” dashed line, the upper inner rim's outside surface is now making contact with the outer rim's inside surface at 180 degrees, where it is stopped, 48 inches up from the fixed point 0. However, if the inner rim's point P is moved 12 inches away from the fixed point 0 in any other direction, such as 225 degrees, then the inner rim's outside surface will make contact with the outer rim's inside surface at 225 degrees and also be stopped there, at a point also 48 inches from the fixed point 0.

Therefore, the movable inner rim 33, which is shown in FIG. 11 in the “neutral position” and in FIG. 12 in the “active position”, performs two very important functions, namely:
1) it acts as a movable circular track for the 2-wheel devices 47 (at the telescoping end of the 8 subassemblies 40), which are forced to make contact with the inner rim's inside surface by the outwardly-directed centrifugal forces generated by the 8 subassemblies 40, as they rotate about the fixed off-center point 0 (see FIGS. 9, 11 and 12), and
2) when it is moved in any direction inside the vertical plane of the circular outer rim 34 (see FIG. 12, for example), it then causes the 8 variable-length subassemblies 40 in (1) above to continually vary their lengths (R3_{W}) as they rotate about the fixed, off-center point 0 (see FIGS. 12, 23 and 32) and to simultaneously generate 8 different centrifugal forces F_{c}—which then automatically vectorially combine to create a single, outwardly-directed resultant centrifugal force ResF (which, as shown in the polygon of FIG. 33, always points in the same selected direction in which inner rim 33 is making contact with outer rim 34).

Furthermore, and most importantly, if inner rim 33 is moved only part of the distance away from its “neutral position” in any direction, without making contact with the inside surface of outer rim 34, such that its center point P is less than 12 inches away from the fixed point 0 anywhere inside the 12-inch-radius dashed circle (see FIG. 8), then the single ResF in (2) above will be smaller in that direction than the maximum ResF of 1,989.4 lbs shown in FIG. 33. Finally, since there are two such Machine mirror-image halves in the internal housing frame, the maximum variable ResF generated by the entire Machine automatically doubles to 3,978.4 lbs.

The above-mentioned variable ResF capability of the Machine is very important to the operation of the cubic TDMM craft, because it allows its built-in mechanism to develop just enough outwardly-directed ResF in any selected direction (inside the vertical planes of the two circular inner rims) which, when combined with the chosen horizontal direction (azimuth) of the internal housing frame 13 (and its enclosed Machine), makes it possible for the wingless and tailless cubic craft to be propelled with any desired amount of variable motive force in three dimensions anywhere on earth and in outer space.

For example, the cubic TDMM craft's variable motive force capability would enable it:
1) to accelerate or decelerate at any desired rate in any direction in three dimensions anywhere on earth and in outer space for as long as needed,
2) to coast at any velocity in any selected flight path,
3) to make any angle turn (including a 180-degree turn) while in flight, without having to make a long arced turn (like all air/space crafts, missiles and rockets presently must do),
4) to remain motionless, either up-side down or down-side up (or in any other position), anywhere on earth and in outer space (a desirable and very useful capability when getting near any outer space bodies),
5) to take off and land at any flight angle and velocity on earth, or on any other space body (such as a space station, planet, moon, comet, asteroid, . . . etc . . . ), and, most importantly,
6) to control the cubic TDMM craft's velocity when entering any atmospheric environment on earth or any other planets, to prevent it from burning up (thereby rendering the present use of thermal tiles unnecessary and obsolete) and make a safe landing.

To briefly summarize, all the above-mentioned performance and maneuvering capabilities can be quickly and simply accomplished in the cubic TDMM craft:
1) by moving both inner rims any given distance (between their “neutral position” and their maximum “active position”) in any selected direction inside the vertical planes of their respective circular outer rims (in order to get the desired outwardly-directed single ResF output in that chosen direction) and
2) by simultaneously orienting the internal housing frame 13 (and its enclosed Machine) towards any new direction (azimuth), relative to the external cubic frame 10—the direction of which, when combined with the chosen ResF direction in (1) above, will give the cubic TDMM craft complete flight control capability in three dimensions.

FIG. 9 illustrates how each of the 8 telescoping subassemblies 40 (see FIGS. 11 and 12) has the fixed section 41 of its slide 46 (see FIGS. 3 and 4) mounted directly onto a circular 16-inch-radius metal disk 31 with a pair of bolts and nuts and how a 2-wheel device 47 is secured onto the moving end of its other section 43. The disk 31 has a 2.5-inch circular hole in its center, which allows it to slide over the right side of the 2.5-inch outside diameter of the cylindrical high-speed hub 44 (see FIG. 50) all the way to its flange, onto which it is secured with four ½×⅞-inch bolts 39 in a 4-inch-diameter circle. The 2-wheel devices 47, which consists of a set of two roller blade wheels with tapered high-speed bearings turning on axle 50, run along the inside surface of inner rim 33 (which acts as a circular track for the two-wheel devices 47), driven by the variable-length subassemblies 40 as they rotate about the fixed stub axle 45 (which is mounted on the inside surface of the left half side 16B of the internal housing frame 13, in line with the fixed point 0 (see FIGS. 50 and 51). The hub 44, the disk 31 and the set of 8 variable-length subassemblies 40 all rotate together as one unit about the fixed stub axle 45.

FIG. 10 presents diagrams of a front and side views of the fixed 96-inch-diameter circular outer rim 34. The front-view diagram shows how the outside surface of outer rim 34 is mounted in 8 equally-spaced places on the inside surfaces of the four 96×12-inch rectangular side-walls of the left half side 16A of the internal housing frame 13 (see FIG. 2). Four of these mounting places consist of four metal corners 17 and the other four mounting places are simply contact points 18 (which are all used for securing outer rim 34 to the center of the four 96×12-inch rectangular side-walls). The side-view diagram also shows how the 3-inch wide edge of the fixed outer rim 34 is mounted in the middle of the four 96×12-inch rectangular side-walls of the internal housing frame's left half side 16A (about 4.5 inches away from both the internal housing frame's 96-inch square end-wall and the central square plate 15). The 3-inch circular edge of the fixed outer rim 34 acts as a circular boundary for the smaller movable 72-inch-diameter circular inner rim 33, shown here in the “neutral position”. A second 96-inch-diameter outer rim 36 is also similarly mounted inside the other internal housing frame's right half side 16B (see FIG. 2).

FIG. 11 shows a diagram of the movable circular inner rim 33 in the “neutral position” (in the center of outer rim 34), in which the lengths of the 8 equally-spaced subassemblies 40 are all exactly equal to the inner rim's constant-length radius R1_{W}=3 feet—thereby causing the 8 subassemblies 40 to all generate equal, constant centrifugal forces (F_{c}) as they rotate about both the superimposed inner rim's center point P and the outer rim's fixed center point 0. In this “neutral position”, the 8 equal F_{c} vectors do not generate any single, outwardly-directed resultant centrifugal force (ResF) in any direction—because, when vectorially combined, they do not generate any ResF at all. FIG. 11 is a typical example of a perfectly balanced flywheel.

However, as shown in FIG. 12, when the Machine's left mirror-image half of the 2-dimension all-way movable mechanism 49 vertically moves circular inner rim 33 up 12 inches from its “neutral position” (such that its center point P is now superimposed on point +0), it is now in its maximum “active position” (in which the outside surface of inner rim 33 is now making contact with the inside surface of outer rim 34 at 180 degrees). As a result, the same 8 identical, equally-spaced, variable-length subassemblies 40 shown in FIG. 11 now all have different lengths R3_{W} which, as shown in FIGS. 12 and 23, continually vary as functions of their angle of rotation theta0, as they rotate about the fixed off-center point 0 (with respect to the inner rim's center point P). Therefore, according to equations B8a, for slide 46 (W), B8b, for the bar, and B8c for both combined into subassembly 40, these 8 equally-spaced, variable-length subassemblies 40 now generate 8 different rotational resultant centrifugal forces ResF (see FIG. 32) which, according to the basic centrifugal force equation (1) in ¶ 0113, are directly proportional to their radial lengths R3_{W}(see FIG. 12). These 8 different F_{c} vectors shown in FIG. 32, then instantaneously vectorially combine into a single resultant centrifugal force ResF =1,989.4 lbs in the outward 180-degree direction (as shown by the heavy black arrow in the polygon of FIG. 33). As already mentioned, this 180-degree outwardly-directed single ResF is arbitrary and can be quickly changed to any other chosen direction (such as 225 degrees) by simply moving inner rim 33 to make contact with the inside surface of outer rim 34 in that other chosen direction—and still get the same single ResF result.

FIG. 49 shows diagrams of an 11-inch square, all-ball-bearing, heavy-duty swivel with a 650-lb load rating and of three different sprockets 66, 53 and 52, each with 60, 40 and 20 teeth respectively. A fourth, smaller sprocket 65 with 8 teeth (not shown), which is similar to sprocket 52, is also used in the Machine with motors 64 (see FIG. 51). The swivel, which consists of two independently rotatable square parts 61 and 62 (each with a ⅓-inch mounting holes 71 near its four corners), is used in the two swivel assemblies 11 and 12 with the 60-tooth sprocket 66 (which is mounted sandwiched between two circular spacers 55, as shown in the bottom part B of FIG. 51).

FIG. 50 presents diagrams of the Machine's right mirror-image half mechanism, the high-speed hub 44 and the 8-inch stub axle. The Machine's mirror-image half mechanism, which consists of the right half of the two-dimension, all-way movable mechanism 49 and of a set of 8 rotatable, variable-length subassemblies 40 system, is mounted directly in the right 16B-side of the inner housing frame 13 (see FIG. 2). This figure illustrates the spatial side-view relationship between the various following parts found in:
A) the two-dimension, all-way movable mechanism 49, which is made up of parts found in FIGS. 6, 7 and 8 (which are all mounted directly onto the right 15B-side of the fixed, 96×96-inch central square plate 15—which, as shown in FIG. 2, evenly divides the inner housing frame 13 into two sides 16A and 16B), namely:
   1) the vertically-moving slide assemblies 22L and 22R, which are mounted on the left and the right sides of the 15B-side of the central square plate 15 (see FIG. 6, for example, and FIG. 14),
   2) the vertically-moving 72-inch square plate 26, mounted on A(1) above (see FIG. 7, for example, and FIG. 14),
   3) the horizontally-moving slide assemblies 28U and 28D, which are mounted on the up and the down sides of the opposite side of A(2) above (see FIG. 7, for example, and FIG. 14),
   4) the horizontally-moving 72-inch square plate 30, mounted directly on A(3) above (see FIG. 8, for example, and FIG. 14),
   5) the 72-inch-diameter, two-dimension movable circular inner rim 35, mounted on the opposite side of A(4) above (see FIG. 8, for example, and FIG. 14), and in
B) the set of 8 variable-length subassemblies 40 system, which is mounted on the center of the inside surface of the right 16B-side square end-wall of the internal housing frame 13 as shown and which consists of the following parts:
   1) the 16-inch radius metal disk 31 (see FIG. 9),
   2) the set of 8 identical, equally-spaced telescoping subassemblies 40, which is mounted on B(1) above (each of which, as shown in FIGS. 3 and 4, extend from a closed 24 inches to a fully opened 48 inches),
   3) the spacer 55 (between the set of 8 subassemblies 40 and the 40-tooth sprocket 53),
   4) the high-speed hub 44, onto which B(1), B(2) and B(3) above are mounted),
   5) the fixed stub axle 45 (which is secured with mounting plate 56 onto the inside center of the right 16B-side square end-wall of the internal housing frame 13), which is aligned with the fixed point 0 dashed line and about which B(1), B(2), B(3) and B(4) above all rotate as one unit,
   6) the fixed outer rim 36 (which is similarly mounted as outer rim 34 is in FIG. 10) and
   7) motor 51, which is mounted below B(5) above and provides rotation to B(1), B(2), B(3) and B(4) above via chain # 54.

The commercially-available high-speed hub 44 in B(4) above comes with two tapered high-speed bearings and a 3,000-lb load capacity and the stub axle 45 in B(5) above comes with a 2,000-lb load capacity. The fixed stub axle 45 serves as a fixed axis, about which B(1), B(2), B(3) and B(4) all rotate together as one unit. The movable inner rim 35 in A(5), which is mounted on the opposite side of the 72-inch square plate 30 in A(4), facing away from the 96×96-inch square plate 15, acts as a circular track for the 2-wheel devices 47 at the telescoping ends of the 8 subassemblies 40 (see FIG. 9) in B(2) above. Inner rim 35 is shown here in the maximum “active position”, making contact with the inside surface of outer rim 36 at 180 degrees, with its center point P shown superimposed on point +0 (also see FIGS. 12, 51 and 52).

In the exemplary embodiment of the Machine's right 16B-side mirror-image half mechanism shown in FIG. 50, the set of 8 subassemblies 40, the 16-inch-radius disk 31, the spacer 55 and the 40-tooth sprocket 53 are all secured together as one unit, which is mounted directly onto the high-speed hub's flange 44 with four bolts 39, rotating about the fixed axle 45 (which is aligned with the fixed center point 0 of outer rim 36), driven by the reversible ½ HP, 1800 rpm variable-speed electric motor 51. Motor 51 uses an rpm-reduction drive consisting of a 20-tooth sprocket 52 (mounted on its shaft), a 40-tooth sprocket 53 (mounted on the flange of the high-speed hub 44) and a #35 chain 54 (which goes around both sprockets 52 and 53), to provide the set of 8 subassemblies 40 with a 50% reduced rotation of 900 rpm (namely: 1800(20/40)). Motor 51 and its mounting plate 57 are secured directly onto the 96-inch quare end-wall of the internal housing frame's right 16B-side as shown, directly below the stub axle 45.

A similar mounting arrangement of items A(1) through A(5) and B(1) through B(7) above also makes up the Machine's left mirror-image half mechanism in the 16A-side of the internal housing frame 13. As shown in FIG. 51, both the left and the right Machine mirror-image halves make up the entire Machine's centrifugal motive force machine of the cubic TDMM craft.

FIG. 51 consists of two parts, A and B. The upper part A presents a cross-sectional side-view of the entire cubic TDMM craft, showing the Machine's two identical mirror-image halves, separated by the 96-inch square central plate 15 (which also divides the 96×96×24-inch parallelepiped internal housing frame 13 into two equal half sides, 16A on the left and 16B on the right). Part A illustrates the side-view spatial relationship between the external cubic frame 10, the internal housing frame 13, the lower and upper swivel assemblies 11 and 12 (shown sandwiched between the top and bottom parts of both the external cubic frame 10 and the internal housing frame 13), as well as the various other parts comprising the Machine's two mirror-image halves (mentioned in the FIG. 50 write-up above).

Four reversible 1800 rpm electric motors (two ½ HP motors 51 and two ¼ motors 64) are variably and independently used for propelling the cubic TDMM craft in any chosen direction in three dimensions. The two motors 51 (one on each side of the internal housing frame 13) provide the two sets of 8 variable-length subassemblies 40 in the Machine with the appropriate counter-rotations (inside the vertical planes of their respective inner rims 33 and 35) to balance out their equal and opposite torque reactions. The other two motors 64 (one at the upper end and the other at the lower end of the internal housing frame's right outside 16B square end-wall) separately provide the appropriate horizontal counter-rotations to both the internal housing frame 13 and the external cubic frame 10 respectively—in order to variably balance out their equal and opposite torque reactions and obtain the desired heading (azimuth) for the internal housing frame 13 (and its enclosed Machine), inside of and relative to the external cubic frame 10.

A power-and-control unit (P/CU), which is mounted on the lower outside of the left 96-inch square 16A-side end-wall of the internal housing frame 13, is used for routing all the various command/control signals needed to operate and propel the cubic TDMM craft in three dimensions. Different PC/U signals are used for turning the four electric motors on and off (together or independently), for making the two-dimension, all-way movable mechanism 49 move the two inner rims to their selected positions inside the vertical planes of their outer rims (in order to obtain the needed amount of ResF in that direction) and for rotating the internal housing frame 13 (in either horizontal direction) towards a desired bearing (azimuth) inside the external cubic frame 10—the combined directions of which causes the cubic TDMM craft to be propelled in any desired heading in three dimensions.

As an example of the use of the P/CU, when the cubic TDMM craft is in a quiescent state on the earth's surface, a first set of command/control signals is first sent to turn on the two motors 51, in order to start the two sets of 8 subassemblies 40 counter-rotating in the “neutral position” (see FIG. 11, for example) inside the vertical planes of their respective inner rims 33 and 35. Then, a second set of signals from the P/CU causes the two-dimension, all-way movable mechanism 49 to move both inner rims up a given distance from their “neutral position” towards 180 degrees on their respective outer rims without making contact with them. The two inner rims 33 and 35 are now in a reduced “active position”, in which the two sets of 8 counter-rotating subassemblies 40 are generating a single, combined resultant centrifugal force (ResF) just powerful enough to make the cubic craft ascend in a controlled vertical lift.

The above-mentioned cubic TDMM craft's controlled vertical lift can be achieved in either of two ways by:
1) counter-rotating the two sets of 8 subassemblies 40 at the same constant input angular velocity (such as, for example, at 100 rad/sec) inside their respective inner rims and moving both inner rims to a reduced “active position” (somewhere between their “neutral position” and their “maximum active position”) towards 180 degrees on their outer rims, in order to cause the TDMM's Machine to generate just enough outwardly-directed ResF for a controlled vertical lift of the 600-lb cubic craft against the local force of gravity, on earth or anywhere else, or
2) counter-rotating the two sets of 8 subassemblies 40 at a reduced angular velocity (such as 70 rad/sec for example) and moving both inner rims all the way to their maximum “active position” at 180 degrees on the inside surfaces of their respective outer rims, in order to cause the TDMM's Machine to also generate just enough outwardly-directed ResF for a controlled vertical lift of the 600-lb cubic craft against the local force of gravity, on earth or anywhere else.

For example, using the angular velocity of 70 rad/sec given in (2) above into the ResF equation shown in FIG. 35 gives an ResF output of 974.8 lbs—which is more than is required to lift the 600-lb cubic craft from the earth's surface. Therefore, the cubic TDMM craft can be made to ascend at any desired rate of speed (depending on both the amount of Machine-generated ResF in the cubic craft and the local force of gravity). Then, when the cubic craft is nearing the desired vertical altitude, a new set of command/control signals is sent to simultaneously move the two inner rims to a new position (inside the vertical planes of their respective circular outer rims) and to rotate the inner housing frame 13 (and its enclosed Machine) towards a given chosen horizontal direction (inside the external cubic frame 10), in order to place the cubic craft in the desired orbital altitude (around the earth or any other outer space bodies). Finally, when the cubic TDMM craft is in the desired orbit, then the amount of Machine-generated ResF that is now needed has to be such that its vertical component will be equal to the local force of gravity at that orbital altitude and that its horizontal component will provide the desired forward motive force to propel the cubic craft at that cruising altitude until its orbital velocity has been reached—and then, the TDMM's Machine mechanism can be returned to its “neutral position”.

In addition to all the above-mentioned capabilities, the proper control signals from the P/CU can cause the cubic TDMM craft to make a 180-degree turn while in flight (without having to make a long arced turn, like all air and space crafts, missiles and rockets, must presently do), accelerate, decelerate or simply coast along, either right side up or upside down (or in any other desired position) in any direction in three dimensions—or simply remain stationary at any designated place anywhere above earth or in outer space.

Part B of FIG. 51 presents two small diagrams of the left and right side-view halves of the top and bottom swivel assemblies 12 and 11. They respectively show how the two swivel assemblies are mounted, sandwiched between the centers of the top and bottom sides of the internal housing frame 13 and of the external cubic frame 10. The two swivel assemblies perform two functions, namely: to vertically support the internal housing frame 13 inside the center of the external cubic frame 10 and to horizontally counter-rotate both the internal housing frame 13 and the external cubic frame 10 about a central vertical axis 14 (see FIGS. 1 and 2). The left side-view half of the top swivel assembly 12 shows how its independently rotatable 11-inch square part 62 (see FIG. 49) is mounted directly onto the center of the top inside surface of the external cubic frame 10, using any acceptable fastening means (such as bolts and nuts through the mounting holes 71) while its other independently rotatable square part 61 is secured to a 60-tooth sprocket 66, which is shown sandwiched between two spacers 55. The rotatable square part 61, the sprocket 66 and the two spacers 55 are mounted together as one unit onto the center of the top outside surface of the internal housing frame 13—such that, when its sprocket 66 is driven by the top bi-directional electric motor 64 (see FIG. 51), it causes the internal housing frame 13 (and its enclosed Machine) to also rotate horizontally in either direction, inside and relative to the external cubic frame 10. The right side-view half of the bottom swivel assembly 11 is similarly mounted, except that its independently rotatable 11-inch square part 62 is secured directly onto the center of the bottom outside surface of the internal housing frame 13 and that its independently rotatable unit, consisting of parts 61, sprocket 66 and spacers 55, is mounted onto the center of the bottom inside surface of the external cubic frame 10—such that, when its sprocket 66 is driven by the bottom bi-directional electric motor 64 (see FIG. 51), it causes the external cubic frame 10 to also rotate horizontally in either direction, relative to the internal housing frame 13 (and its enclosed Machine). The two spacers 55, used on both sides of the top and bottom 60-tooth sprockets 66 in both subassemblies 12 and 11, keep the chains 54 from rubbing against the internal housing frame 13 and the external cubic frame 10.

Therefore, by controlling the amounts of horizontal counter-rotations of both the internal housing frame 13 and the external cubic frame 10, the internal housing frame can be oriented towards any desired horizontal direction (azimuth) which, when combined with the chosen direction of the Machine-generated total ResF, gives the cubic TDMM craft an unmatched three-dimensional, variable propulsion capability for use anywhere on earth and in outer space.

FIG. 52 presents another cross-sectional side-view diagram of the cubic TDMM craft's left Machine mirror-image half, showing the relationship between the external cubic frame 10, the internal housing frame 13, the two heavy-duty swivel-and-sprocket assemblies 11 and 12, the central plate's left side 15A, the two-dimension, movable circular inner rim 33 (shown in the maximum “active position” making contact with the inside surface of the outer rim 34 at 180 degrees) and the 8 variable-length subassemblies 40 (each consisting of one telescoping slide 46 and of one 2-wheel device 47), rotating counterclockwise about the fixed, off-center point 0.

FIG. 53 shows a top-view diagram of the cubic TDMM craft, showing the spatial relationship between the external cubic frame 10, the 96×24-inch rectangular top-view of the internal housing frame 13 (see FIG. 2) and the two-stage rpm-reducing subassembly used for providing a 32-rpm drive to the top swivel assembly 12—which is used for rotating the internal housing 13 (and its enclosed Machine) in any chosen horizontal direction (azimuth) inside the external cubic frame 10. Also shown is the 100-inch-diameter alternate cylindrical frame 60 (shown as a dashed circle), which is used in FIG. 54 as a replacement for the external cubic frame 10. The two rpm-reducing stages are:
1) First stage: A reversible ¼ HP, 1800 rpm electric motor 64, with an 8-tooth sprocket 65 (mounted on its shaft) and a motor mount 63 (for securing motor 64 onto the outside top of the 96-inch square right 16B side-wall of the internal housing frame 13—see FIG. 51), is coupled to the 60-tooth sprocket 66 of the idler subassembly 72 (on top of the internal housing frame 13—about half-way between motor 64 and the top swivel assembly 12) by means of a #35 chain 54, which provides the idler subassembly's 60-tooth sprocket 66 and its secured 8-tooth sprocket 65 with a reduced 240-rpm rotation (or, 1800(8/60)), and
2) Second stage: The idler subassembly's 8-tooth sprocket 65 which, as mentioned above, rotates at 240 rpm, is in turn coupled to the 60-tooth sprocket 66 of the top swivel assembly 12 by means of a second #35 chain 54, thereby causing the internal housing frame 13 to also rotate with a reduced 32 rpm rotation (or, 240(8/60)).

A second, identical two-stage rpm-reducing subassembly, also consisting of motor 64, sprockets and chains, is similarly mounted onto the outside bottom part of the internal housing frame 13 (see FIG. 51), where it provides the same reduced 32 rpm counter-rotation to the external cubic frame 10. The two small diagrams show how the top and bottom swivel assemblies 12 and 11 are respectively mounted sandwiched between the centers of the top and bottom sides of both the internal housing frame 13 and the external cubic frame 10.

Both the top and bottom rpm-reducing subassemblies can separately and variably be used together for counter-rotating (at the same or at different angular velocities) the internal housing frame 13 and the external cubic frame 10 (which encloses the rotatable internal housing frame 13), in order to balance out their opposite rotational torque reactions and give the internal housing frame 13 (and its enclosed Machine) the desired horizontal direction (azimuth) inside, and relative to, the external cubic frame 10. The internal housing frame 13 rotates (inside the larger external cubic frame 10) about a central vertical axis 14, which runs between the centers of both the top and bottom swivel assemblies 12 and 11 and which is aligned with the vertical center of central plate 15 (see FIGS. 1, 2, and 51). Therefore, the two rpm-reducing subassemblies' bottom and top swivel assemblies are used for both supporting the internal housing frame 13 inside the external cubic frame 10 and for variably counter-rotating the internal housing frame 13 and the external cubic frame 10 until a desired horizontal direction (azimuth) is obtained (by selectively adjusting their respective torque reactions) for the internal housing frame 13 (and its enclosed Machine), relative to the external cubic frame 10.

Finally, by combining the selected direction of the combined, single, outwardly-directed ResF, generated by the Machine's two sets of 8 subassemblies 40 (counter-rotating in the “active position” in their respective movable inner rims), with the chosen horizontal direction (azimuth) of the internal housing frame 13 (and its enclosed Machine), a steerable and variably powerful motive force is then available for propelling the small-scale, 600-lb cubic TDMM craft in three dimensions, with spectacular performance and maneuverability, on earth and in outer space.

FIG. 54 presents two diagrams of a simple reduction to practice of the basic invention (represented by FIG. 1 in its most basic cubic form), looking like a “flying saucer”. The top diagram A shows a side view of the “flying saucer” and the bottom diagram B shows a top view of the same “flying saucer”. In the A-side-view, the alternate external cylindrical frame 60 (a top-view of which is shown as a 100-inch dashed circle in FIGS. 2 and 53) is seen in this figure from the side, looking like a shaded 100-inch square, and looking like a circle in the B-top-view. The external cylindrical frame 60 is used in this embodiment (instead of the external 100-inch external cubic frame 10 of FIG. 1) because it fits better with the circular shape of this exemplary saucer-shaped TDMM craft.

Both the top A-side-view and the bottom B-top-view diagrams of the “flying saucer” show the peripheral area 38, which is used for storage of equipments and supplies and for a small crew's quarters. The cockpit area 58 includes a platform 69, supporting a pilot/navigator chair 68 and a command/control console 70 (with a control panel displaying all the various flight control switches, dials and monitoring instruments needed by the pilot/navigator to “fly” the craft in three dimensions). The various wires and cables between the command/control console 70 and the alternate cylindrical frame 60 run under platform 69. The bottom B-top-view also shows two passageways 59, between the cockpit 58 and the craft's area 38, for use by the crew. The top A-side-view diagram also shows the sharp lower circular edge of the craft, with an angle no larger than 60 degrees—in order for the saucer-shaped TDMM craft to be flown at a given inclination inside the envelope of the shock wave that is created when traveling at high velocities through any atmospheric environment. The final shape and size of the said flying saucer-shaped TDMM craft will be determined later, during the engineering design, development and building phases.

Finally, a more technologically advanced design of the telescoping full extension slide 46 (see FIGS. 3, 4 and 5), which is used in the two sets of 8 counter-rotating subassemblies 40, will be required in order to withstand angular velocities above 50 rad/sec (477.5 rpm), namely: one that would enable the Machine's mechanism to propel either the cubic TDMM craft or the much heavier exemplary “flying saucer” in three dimensions with the kind of spectacular performance (shown in the plots of FIGS. 35 and 41 through 48) and maneuverability described earlier.

### Conclusion

The cubic air/space craft with a built-in “Three Dimension Motive Machine” (TDMM), herein referred to as the cubic TDMM craft, is a unique and innovative engineering invention, capable of generating an outwardly-directed, steerable, variably powerful and smooth resultant centrifugal force (ResF) to propel the 600-lb cubic craft with unparalleled performance and maneuverability (including making a 180-degree turn while in flight without having to make a long arced turn) in three dimensions. For example, the said cubic craft can generate total ResFs of 995, 2,238.1 and 3,979.8 lbs when its Machine's two sets of 8 variable-length subassemblies 40 are counter-rotating at 50, 75 and 100 rad/sec respectively. Furthermore, while using only the 50 rad/sec flight time plots of FIGS. 44 and 48, the cubic TDMM craft can reach an orbital altitude of 250 miles in 5.72 minutes, go to the moon (230,000 miles away) in about 3 hrs and even go to Mars (when it is about 35 million miles from earth) in less than 33 hrs. Both above flight times to the moon and to Mars are based on a constant acceleration and a constant deceleration of 53.4 ft/sec²(see FIG. 45) during each “far-earth” half-way distances to the moon and to Mars. Such capabilities, built into a larger, full-scale model of the cubic TDMM craft (with sufficient space for equipments, parts, supplies and crew) would be ideal for long space voyages—especially when using a given constant acceleration to provide a substitute gravity (for the crew's benefit). More importantly, with a steady supply of electrical power, from solar panels, batteries and/or other sources (including nuclear), to operate and propel the cubic TDMM craft, there would be no need for propulsion jets and fuel for take-offs, landings and for various other maneuvers, because the motive force capability is built into the cubic craft (thereby greatly reducing its total weight as well as its manufacturing and operating costs). Moreover, because of the flywheel kinetic energy storage capacity of the two sets of 8 variable-length subassemblies 40 (see FIG. 40), less electrical power would be needed to keep them counter-rotating at their selected angular velocities in the “active position”. Finally, the cubic craft's variable motive force capability makes it possible to control its velocity when re-entering any atmosphere from outer space without burning up (thus making the use of thermal tiles obsolete). The TDMM part of the cubic craft could also be used in land wheeled-vehicles and in all types of water, air and space crafts (in which the present use of propellers, fans and/or jets would no longer be needed).

1. An apparatus for generating an outwardly-directed force steerable in three dimensions for propelling a vehicle, comprising:
a circular outer rim;
a hub located at the center of said circular outer rim and axially aligned therewith;
means for rotating said hub:
a mass rotated by said hub;
means for guiding said mass in a circular path in a plane at a right angle to the axis of said hub and said circular outer rim;
said circular path defining an orbit wholly contained within said circular outer rim;
means for moving said means for guiding said mass in a plane at a right angle to the axis of said hub and said circular outer rim and within the confines of said circular outer rim; and
means for rotating said circular outer rim about an axis at a right angle to the axis of said circular outer rim.

2. An apparatus as defined by claim 1, wherein said means for moving said means for guiding said mass comprises means for controlling the direction of the vector sum of the centrifugal force created by said mass.

3. An apparatus as defined by claim 1, wherein the center of said mass varies as a function of the displacement of the center of said circular path relative to the axis of said hub and the instantaneous angular orientation thereto of said mass.

4. An apparatus as defined by claim 1, comprising:
an assembly including said circular outer rim, said hub, said mass, said means for guiding said mass in a circular path and said means for moving said means for guiding said mass; and
said means for rotating said circular outer rim comprises means for rotating said assembly about an axis at a right angle to the axis of said circular outer rim contained therein.

5. An apparatus as defined by claim 4, comprising a plurality of said assemblies.

6. An apparatus as defined by claim 5, comprising a vehicle.

7. An apparatus as defined by claim 1, wherein said mass comprises a variable length elongated body having a maximum length defined by the diameter of said circular path.

8. An apparatus as defined by claim 7, wherein said variable length elongated body comprises first and second variable length radius arms affixed to said hub and extending therefrom in opposite directions and in a plane common with the plane of said circular path.

9. An apparatus as defined by claim 8, comprising:
a plurality of pairs of said first and second variable length radius arms affixed to said hub and extending therefrom in a common plane;
said variable length radius arms of each of said pairs extending in opposite directions from said hub forming a plurality of said variable length elongated bodies sharing said hub;
said first and second variable length radius arms being of equal instantaneous length when the center of said fixed circular path coincides with the axis of said hub; and
said first and second variable length radius arms being of unequal instantaneous length when said center of said circular path is not coincident with said axis of said hub.

10. An apparatus for generating an outwardly-directed force steerable in three dimensions for propelling a vehicle, comprising:
a framework of cubic dimensions;
a circular outer rim centered within said framework and defined by the confines of said framework;
a hub located at the center of said circular outer rim and axially aligned therewith;
means for rotating said hub:
a mass rotated by said hub;
means for guiding said mass in a circular path;
said circular path defining an orbit wholly contained within said circular outer rim;
means for moving said means for guiding said mass in a plane at a right angle to the axis of said hub and within the confines of said circular outer rim; and
means for rotating said circular outer rim about an axis passing through the center of said framework and perpendicular to the axis of said circular outer rim.

11. An apparatus as defined by claim 10, wherein said means for moving said means for guiding said mass comprises means for controlling the direction of the vector sum of the centrifugal forces created by said mass.

12. An apparatus as defined by claim 10, wherein the center of said mass varies as a function of the displacement of the center of said circular path relative to the axis of said hub and the instantaneous angular orientation thereto of said mass.

13. An apparatus as defined by claim 10, comprising:
an assembly including said circular outer rim, said hub, said mass, said means for guiding said mass in a circular path and said means for moving said means for guiding said mass; and
means for rotating said assembly about an axis at a right angle to the axis of said circular outer rim contained therein and passing through the center of said framework.

14. An apparatus as defined by claim 13, comprising a plurality of said assemblies.

15. An apparatus as defined by claim 14, comprising a vehicle.

16. An apparatus as defined by claim 10, wherein said mass comprises a variable length elongated body having a maximum length defined by the diameter of said circular path.

17. An apparatus as defined by claim 16, wherein said variable length elongated body comprises first and second variable length radius arms affixed to said hub and extending therefrom in opposite directions and in a plane common with the plane of said fixed circular path.

18. An apparatus as defined by claim 17, comprising:
a plurality of pairs of said first and second variable length radius arms affixed to said hub and extending therefrom in a common plane;
said variable length radius arms of each of said pairs extending in opposite directions from said hub forming a plurality of said variable length elongated bodies sharing said hub;
said first and second variable length radius arms being of equal instantaneous length when the center of said circular path coincides with the axis of said hub; and
said first and second variable length radius anns being of unequal instantaneous length when said center of said fixed circular path is not coincident with said axis of said hub.

19. A vehicle, comprising:
means for propelling said vehicle in three dimensions comprising a square framework secured within said vehicle;
a circular outer rim centered within said square framework and defined by the confines of said square framework;
a hub located at the center of said circular outer rim and axially aligned therewith;
means for rotating said hub;
means for generating a variable vector centrifugal force comprising a mass rotated by said hub;
means for guiding said mass in a circular path;
said circular path defining an orbit wholly contained within said circular outer rim;
means for moving said means for guiding said mass in a plane at a right angle to the axis of said hub and within the confines of said circular outer rim for controlling the direction and magnitude of the vector sum of said variable vector centrifugal forces created by said rotation of said mass;
an assembly including said circular outer rim, said hub, said mass, said means for guiding said mass in a fixed circular path and said means for moving said means for guiding said mass; and
means for rotating said assembly about an axis at a right angle to the axis of said circular outer rim contained therein and passing through the center of said square framework.

20. A vehicle as defined by claim 19, comprising:
a plurality of said assemblies contained within said square framework; and
means for applying the combined force of said vector sum of the centrifugal forces created by the rotation of said mass in each of said assemblies comprising said plurality of assemblies outward from said square framework to said vehicle as said propulsive force.
